(19) United States
(12) Patent Application Publication
(10) Pub. No.: US 2004/0006606 A1
(43) Pub. Date: Jan. 8, 2004

(54) System and method for cataloging advertising stored online

(76) Inventors: Len Marotta, San Francisco, CA (US); Mahesh Kueny, San Francisco, CA (US); Bob Howard, Irving, TX (US)

Correspondence Address: NATH & ASSOCIATES, 1030 15th STREET, 6TH FLOOR, WASHINGTON, DC, 20005, US

(21) Appl. No.: 10/402,243

(22) Filed: Mar. 31, 2003

Related U.S. Application Data
(60) Provisional application No. 60/368,143, filed on Mar. 29, 2002.
(60) Provisional application No. 60/369,577, filed on Apr. 4, 2002.

(51) Int. Cl. G06F 15/16; G06F 17/00; G06F 17/60

(52) U.S. Cl. 709/219; 705/14; 700/94

(57) ABSTRACT

The present invention generally relates to computers and software, and more particularly, to web-based cataloging of audio, video, and print media in a single server-side data store that can be accessed from any machine with an internet connection and the required OS and browser versions. Specifically, the present invention can provide for the creation of a custom web site, accessible through an internet connection, portal, or server, such as for example, DG Online, that allows everyone involved in a project, such as for example, an advertising effort, to view, catalog, and archive the media, i.e. the ads, including audio, video, and print media. The invention also provides the option of an Archive as electronic storage, integrated with web-based search capabilities, to ensure that ads can be located easily. The invention also may optionally provide on-line order forms to allow media, such as broadcast ads, to be easily and quickly pulled from archive and processed for delivery. Additionally, the present optionally includes a search function which locates particular media, i.e. ads, based on pre-defined search criteria.

### BACKGROUND OF THE INVENTION

1. Field of the Invention

The present invention generally relates to computers and software, and more particularly, to web-based cataloging of audio, video, and print media in a single server-side data store that can be accessed from any machine with an internet connection and the required OS and browser versions.

2. Description of the Related Art

In the past few years, the worlds of information and technology have made important evolutions. We have progressed from a universal analogical support, usually on paper, towards a theoretically universal electronic support based on the multimedia as well as Internet Protocol (IP) based technology such as the World Wide Web (WWW), JAVA and ICQ (I Seek You). The transmission of information has also made tremendous progress and is already, or will be soon, practically instantaneous no matter the form of information: text, data, sound, fixed or animated image.

As known in the art, the Internet is a world-wide collection of networks and gateways that use the Transmission Control Protocol/Internet Protocol suite of protocols to communicate with one another. At the heart of the Internet is a backbone of high speed data communication lines between major nodes or host computers consisting of thousands of commercial, government, educational, and other computer systems that route data and messages.

World Wide Web (WWW) refers to the total set of interlinked hypertext documents residing on hypertext transfer protocol (HTTP) servers all around the world. Documents on the WWW, called pages or web pages, are written in hypertext mark-up language (HTML) identified by uniform resource locators (URL) that specify the particular machine and pathname by which a file can be accessed and transmitted from node to node to the end user under HTTP. A web site is a related group of these documents and associated files, scripts, subprocedures, and databases that are served up by an HTTP server on the WWW.

Users need a browser program and an Internet connection to access a web site. Browser programs, also called “web browsers,” are consumer applications that enable a user to navigate the Internet and view HTML documents on the WWW, another network, or the user's computer. Web browsers also allow users to follow codes called “tags” embedded in an HTML document, which associate particular words and images in the document with URLs so that a user can access another file that may be half way around the world, at the press of a key or the click of a mouse.

As the internet and the web have become usable and accessible to a wider range of business applications, the possibilities of new products and services has emerged. In the advertising industry, television and radio ads have historically been created on analog magnetic media and distributed by mail or courier. As analog media has given way to digital media and operating systems have become more robust, ads could be created, manipulated, and stored digitally on a computer. However, numerous software and hardware compatibility problems continue to prevent the access, maintenance, management, and control of advertising media.

### SUMMARY OF THE INVENTION

Accordingly, the present invention has identified the problems in the area of Web-based cataloging, and has provided one or more solutions involving Web-based cataloging of audio, video, and print media in a single server-side data store that can be accessed from any machine with an internet connection and the required OS and browser versions.

The present invention generally relates to computers and software, and more particularly, to web-based cataloging of audio, video, and print media in a single server-side data store that can be accessed from any machine with an internet connection and the required OS and browser versions. Specifically, the present invention can provide for the creation of a custom web site, accessible through an internet connection, portal, or server, such as for example, DG Online, that allows everyone involved in a project, such as for example, an advertising effort, to view, catalog, and archive the media, i.e. the ads, including audio, video, and print media.

The invention also provides the option of an Archive as electronic storage, integrated with web-based search capabilities, to ensure that ads can be located easily. The invention also may optionally provide on-line order forms to allow media, such as broadcast ads, to be easily and quickly pulled from archive and processed for delivery. Additionally, the present optionally includes a search function which locates particular media, i.e. ads, based on pre-defined search criteria.

AdCatalog is one of the ASP (Application Service Provider) applications in DG System's Media Asset Management suite of applications. AdCatalog provides web-based cataloging of audio, video and print media in a single server-side data store that can be accessed from any machine with an internet connection and the required OS browser versions.

### BRIEF DESCRIPTION OF THE DRAWINGS

FIG. 1 is a computer screen snapshot view of the Media Asset Management (MAM) Login Page.

FIG. 2 is a computer screen snapshot view of the AdCatalog Tool.

FIG. 3 is a computer screen snapshot view of the Select Organization Function.

FIG. 4 is a computer screen snapshot view of the selected organization's Catalog page.

FIG. 5 is a computer screen snapshot view of the Add Organization page.

FIG. 6 is a computer screen snapshot view of the New Organization page.

FIG. 7 is a computer screen snapshot view of the Settings section (Billable Organization) of the New Organization page.

FIG. 8 is a computer screen snapshot view of the Settings section (Simple Organization) of the New Organization page.

FIG. 9 is a computer screen snapshot view of the General Information Section (Billable Organization) of the New Organization page.

FIG. 10 is a computer screen snapshot view of the General Information Section (Simple Organization) of the New Organization page.

FIG. 11 is a computer screen snapshot view of the Shipping Information section of the New Organization page.

FIG. 12 is a computer screen snapshot view of the Spot Track function of AdCatalog.

FIG. 13 is a computer screen snapshot view of the Spot Details table in the Spot Track function of AdCatalog.

FIG. 14 is a computer screen snapshot view of the bottom five lines of the Spot Details table in the Spot Track function of AdCatalog. In particular, FIG. 14 shows the extra button at the bottom of the table that is available to those users logged on as DG administrator.

FIG. 15 is a computer screen snapshot view of the confirmation message that appears upon activation of the Cancel Spot button in the Spot Details table in the Spot Track function of AdCatalog.

FIG. 16 is a computer screen snapshot view of the bottom five lines of the Spot Details table in the Spot Track function of AdCatalog. In particular, FIG. 16 shows the message that will be displayed if a spot has the status “Problem Flipping”.

FIG. 17 is a computer screen snapshot view of the confirmation message upon activation of the Purge Spot button on the Spot Details table in the Spot Track function of AdCatalog.

FIG. 18 is a computer screen snapshot view of the Unmatched function of AdCatalog.

FIG. 19 is a computer screen snapshot view of the Rename Unmatched File page.

FIG. 20 is a computer screen snapshot view of the Transfers function of AdCatalog.

FIG. 21 is a computer screen snapshot view of the Metadata function of AdCatalog.

FIG. 22 is a computer screen snapshot view of the Hardcoded metadata field.

FIG. 23 is a computer screen snapshot view of a created metadata field.

FIG. 24 is a computer screen snapshot view of the Select List Values page.

FIG. 25 is a computer screen snapshot view of the Select List Values page while in Edit mode.

FIG. 26 is a computer screen snapshot view of the Add New Metadata Wizard.

FIG. 27 is a computer screen snapshot view of the New Metadata Field page where the metadata is Text.

FIG. 28 is a computer screen snapshot view of the New Metadata Field page where the metadata is Long Text.

FIG. 29 is a computer screen snapshot view of the New Metadata Field page where the metadata is Number.

FIG. 30 is a computer screen snapshot view of the New Metadata Field page where the metadata is Boolean.

FIG. 31 is a computer screen snapshot view of the New Metadata Field page where the metadata is Date.

FIG. 32 is a computer screen snapshot view of the New Metadata Field page where the metadata is Select List.

FIG. 33 is a computer screen snapshot view of the prompt which enables the user to edit or delete values in the select list.

FIG. 34 is a computer screen snapshot view of the (fieldname) Select List Values page where the user can enter values for the list.

FIG. 35 is a computer screen snapshot view of the New List Option for (fieldname) page.

FIG. 36 is a computer screen snapshot view of the Select List Values page with data entered (i.e. Name data).

FIG. 37 is a computer screen snapshot view of the Select List Values page upon activation of the Edit button.

FIG. 38 is a computer screen snapshot view of the Metadata Dictionary List for DG System.

FIG. 39 is a computer screen snapshot view of the Metadata Dictionary List for DG System undergoing a Sequence edit.

FIG. 40 is a computer screen snapshot view of the Metadata Dictionary List for DG System after Sequence editing.

FIG. 41 is a computer screen snapshot view of the File Manager function.

FIG. 42 is a computer screen snapshot view of the File Search page.

FIG. 43 is a computer screen snapshot view of the File Search Results page.

FIG. 44 is a computer screen snapshot view of the Admin tab of AdCatalog.

FIG. 45 is a computer screen snapshot view of the Select Production function.

FIG. 46 is a computer screen snapshot view of the Inbox in NetClear.

FIG. 47 is a computer screen snapshot view of the Organization Detail function of AdCatalog.

FIG. 48 is a computer screen snapshot view of the Settings section of the Organization Detail function for a Billable Organization.

FIG. 49 is a computer screen snapshot view of the Settings section of the Organization Detail function for a Simple Organization.

FIG. 50 is a computer screen snapshot view of the General Information section of the Organization Detail function for Host and Billable Organizations.

FIG. 51 is a computer screen snapshot view of the Shipping Information section of the Organization Detail function for Host and Billable Organizations.

FIG. 52 is a computer screen snapshot view of the Settings section of the Organization Detail function for a Billable Organization.

FIG. 53 is a computer screen snapshot view of the General Information section of the Organization Detail function for a Billable Organization.

FIG. 54 is a computer screen snapshot view of the Shipping Information section of the Organization Detail function for a Billable Organization.

FIG. 55 is a computer screen snapshot view of the Settings section of the Organization Detail function for a Billable Organization.

FIG. 56 is a computer screen snapshot view of the General Information section of the Organization Detail function for a Billable Organization.

FIG. 57 is a computer screen snapshot view of the Shipping Information section of the Organization Detail function for a Billable Organization.

FIG. 58 is a computer screen snapshot view of the User function of AdCatalog.

FIG. 59 is a computer screen snapshot view of the User Information pop-up window.

FIG. 60 is a computer screen snapshot view of the User page

FIG. 61 is a computer screen snapshot view of the New User page.

FIG. 62 is a computer screen snapshot view of the Import User(s) page.

FIG. 63 is a computer screen snapshot view of the User Information pop-up window.

FIG. 64 is a computer screen snapshot view of the User (view only) page.

FIG. 65 is a computer screen snapshot view of the User (Edit) page.

FIG. 66 is a computer screen snapshot view of the Group function of AdCatalog.

FIG. 67 is a computer screen snapshot view showing the addition of a user to the Admin Group of the Security Groups.

FIG. 68 is a computer screen snapshot view of the New Group page.

FIG. 69 is a computer screen snapshot view showing the addition of a user to the Admin Group of the Security Groups.

FIG. 70 is a computer screen snapshot view of the New Group page.

FIG. 71 is a computer screen snapshot view of the Biz Partner function of AdCatalog.

FIG. 72 is a computer screen snapshot view of the Brands window.

FIG. 73 is a computer screen snapshot view of the Rename Brands window.

FIG. 74 is a computer screen snapshot view of the Business Partner page of the Biz Partner function.

FIG. 75 is a computer screen snapshot view of the Brands window.

FIG. 76 is a computer screen snapshot view of the Rename Brands window.

FIG. 77 is a computer screen snapshot view of the Metadata function of AdCatalog.

FIG. 78 is a computer screen snapshot view of the Metadata Field: Metadata Type page.

FIG. 79 is a computer screen snapshot view of a created metadata field.

FIG. 80 is a computer screen snapshot view of the Select List Values page.

FIG. 81 is a computer screen snapshot view of the Select List Values page while in Edit mode.

FIG. 82 is a computer screen snapshot view of the Add New Metadata Wizard.

FIG. 83 is a computer screen snapshot view of the New Metadata Field page where the metadata is Text.

FIG. 84 is a computer screen snapshot view of the of the New Metadata Field page where the metadata is Long Text.

FIG. 85 is a computer screen snapshot view of the New Metadata Field page where the metadata is Number.

FIG. 86 is a computer screen snapshot view of the New Metadata Field page where the metadata is Boolean.

FIG. 87 is a computer screen snapshot view of the New Metadata Field page where the metadata is Date.

FIG. 88 is a computer screen snapshot view of the New Metadata Field page where the metadata is Select List.

FIG. 89 is a computer screen snapshot view of the (fieldname) Select List Values page.

FIG. 90 is a computer screen snapshot view of the New List Option for (fieldname) page.

FIG. 91 is a computer screen snapshot view of the Select List Values page with data entered (i.e. Name data).

FIG. 92 is a computer screen snapshot view of the Select List Values page upon activation of the Edit button.

FIG. 93 is a computer screen snapshot view of the Metadata Dictionary List.

FIG. 94 is a computer screen snapshot view of the Metadata Dictionary List undergoing a Sequence edit.

FIG. 95 is a computer screen snapshot view of the Metadata Dictionary List after Sequence editing.

FIG. 96 is a computer screen snapshot view of the Catalog function of AdCatalog.

FIG. 97 is a computer screen snapshot view of the New Catalog Directory window.

FIG. 98 is a computer screen snapshot view of the New Catalog window.

FIG. 99 is a computer screen snapshot view of the AdCatalog message window upon the creation of a new catalog.

FIG. 100 is a computer screen snapshot view of the window that appears if the user activates the “continue with the remaining catalog setup” function in the AdCatalog message window upon the creation of a new catalog, as shown in FIG. 99.

FIG. 101 is a computer screen snapshot view of the File System function of AdCatalog.

FIG. 102 is a computer screen snapshot view of the File System page.

FIG. 103 is a computer screen snapshot view of the window which opens upon clicking on a catalog listed on the File System page, as shown in FIG. 102.

FIG. 104 is a computer screen snapshot view of the Upload File page.

FIG. 105 is a computer screen snapshot view of the Notify Event function of AdCatalog.

FIG. 106 is a computer screen snapshot view of the message window which opens if the user attempts to create a Notify event but has yet to create a notify list.

FIG. 107 is a computer screen snapshot view of the Notification Email Lists page.

FIG. 108 is a computer screen snapshot view of the New Notification List page.

FIG. 109 is a computer screen snapshot view of the Group Information window.

FIG. 110 is a computer screen snapshot view of the Additional Email Addresses window.

FIG. 111 is a computer screen snapshot view of the Notification Email Lists page.

FIG. 112 is a computer screen snapshot view of the Notification Events page.

FIG. 113 is a computer screen snapshot view of the New Event: New Catalog page.

FIG. 114 is a computer screen snapshot view of the New Event: New Record in catalog page.

FIG. 115 is a computer screen snapshot view of the New Event: Importing records into catalog page.

FIG. 116 is a computer screen snapshot view of the New Event: Exporting records into catalog page.

FIG. 117 is a computer screen snapshot view of the New Event: Importing users page.

FIG. 118 is a computer screen snapshot view of the New Event: New news for catalog path page.

FIG. 119 is a computer screen snapshot view of the New Event: Document activity in catalog path.

FIG. 120 is a computer screen snapshot view of the Notify List function page in AdCatalog.

FIG. 121 is a computer screen snapshot view of the New Notification List Choices page.

FIG. 122 is a computer screen snapshot view of the New Notification List page.

FIG. 123 is a computer screen snapshot view of the Group Information Window.

FIG. 124 is a computer screen snapshot view of the Additional Email Addresses window.

FIG. 125 is a computer screen snapshot view of the Edit Notification List page.

FIG. 126 is a computer screen snapshot view of the Catalog tab of AdCatalog.

FIG. 127 is a computer screen snapshot view of the Navigation function in the Catalog tab of AdCatalog.

FIG. 128 is a computer screen snapshot view of an Organization's directory system, including subdirectories and catalogs.

FIG. 129 is a computer screen snapshot view of the File System page.

FIG. 130 is a computer screen snapshot view of the Upload Files page.

FIG. 131 is a computer screen snapshot view of the File System page.

FIG. 132 is a computer screen snapshot view of the News window.

FIG. 133 is a computer screen snapshot view of the News List page.

FIG. 134 is a computer screen snapshot view of the Add News page.

FIG. 135 is a computer screen snapshot view of the News List page.

FIG. 136 is a computer screen snapshot view of the Media function of AdCatalog.

FIG. 137 is a computer screen snapshot view of a sample media record located as a result of a search function.

FIG. 138 is a computer screen snapshot view of a sample media record for a Video spot that has been encoded by the creating agency and studio and received by DG Systems.

FIG. 139 is a computer screen snapshot view of a sample video spot that has been cancelled or has not been received.

FIG. 140 is a computer screen snapshot view of the Metadata section of the Edit Records Page.

FIG. 141 is a computer screen snapshot view of the Miscellaneous section.

FIG. 142 is a computer screen snapshot view of the Assets section.

FIG. 143 is a computer screen snapshot view of an attachment file window.

FIG. 144 is a computer screen snapshot view of the Add Attachment page.

FIG. 145 is a computer screen snapshot view of the system message that is displayed upon attachment of a file.

FIG. 146 is a computer screen snapshot view of the Media Search page after the file attachment is complete.

FIG. 147 is a computer screen snapshot view of the Thumbnail Selection page.

FIG. 148 is a computer screen snapshot view of a sample media record for an Audio spot that has been encoded by the creating agency and studio and received by DG Systems.

FIG. 149 is a computer screen snapshot view of a sample media record for an Audio spot that has been cancelled or has not been received by DG Systems.

FIG. 150 is a computer screen snapshot view of the Metadata section of the Edit Records page.

FIG. 151 is a computer screen snapshot view of the Miscellaneous section of the Edit Records page.

FIG. 152 is a computer screen snapshot view of the Assets section of the Edit Records page.

FIG. 153 is a computer screen snapshot view of the browser window that will appear when the user clicks on an attachment's graphic.

FIG. 154 is a computer screen snapshot view of the Add Attachment page.

FIG. 155 is a computer screen snapshot view of the system message that lists the file name and length in bytes upon uploading.

FIG. 156 is a computer screen snapshot view of the Media Search page after the file attachment is complete.

FIG. 157 is a computer screen snapshot view of a sample media record for a print spot that has been received by DG Systems.

FIG. 158 is a computer screen snapshot view of the Metadata section of the Edit Records Page.

FIG. 159 is a computer screen snapshot view of the Miscellaneous section of the Edit Records page.

FIG. 160 is a computer screen snapshot view of the Assets section of the Edit Records page.

FIG. 161 is a computer screen snapshot view of the system message that lists the file name and the length of the file in bytes.

FIG. 162 is a computer screen snapshot view of the Add Attachment page.

FIG. 163 is a computer screen snapshot view of a sample system message that is displayed after a script attachment file is uploaded to AdCatalog.

FIG. 164 is a computer screen snapshot view of the Media Search page after the file attachment is complete.

FIG. 165 is a computer screen snapshot view of the New Record function of AdCatalog.

FIG. 166 is a computer screen snapshot view of the Spot Metadata section of the New Record function.

FIG. 167 is a computer screen snapshot view of the Media Search page with a sample media record and thumbnail of a spot.

FIG. 168 is a computer screen snapshot view of the Media Search page with a sample media record that has not yet been received and the thumbnail of the spot is replaced with a “Video Spot” graphic.

FIG. 169 is a computer screen snapshot view of the window that is displayed once a spot has been received and attached to a record and must be “Ok'd for distribution”.

FIG. 170 is a computer screen snapshot view of the system message that is displayed once a spot has been approved for distribution.

FIG. 171 is a computer screen snapshot view of the Spot Metadata function of the New Record page.

FIG. 172 is a computer screen snapshot view of the system message that confirms that the new record was saved.

FIG. 173 is a computer screen snapshot view of the window that is displayed once a spot has been received and attached to a record and must be “Ok'd for distribution”.

FIG. 174 is a computer screen snapshot view of the system message that is displayed once a spot has been approved for distribution.

FIG. 175 is a computer screen snapshot view of the Spot Metadata section of the New Record page.

FIG. 176 is a computer screen snapshot view of a system message that will confirm that the new record was saved.

FIG. 177 is a computer screen snapshot view of the Metadata function

FIG. 178 is a computer screen snapshot view of the Metadata field page.

FIG. 179 is a computer screen snapshot view of a created metadata field.

FIG. 180 is a computer screen snapshot view of the prompt which enables the user to edit or delete values in the select list.

FIG. 181 is a computer screen snapshot view of the Select List Values page.

FIG. 182 is a computer screen snapshot view of the Select List Values page upon activation of the Edit function.

FIG. 183 is a computer screen snapshot view of the Add New Metadata Wizard page.

FIG. 184 is a computer screen snapshot view of the New Metadata Field where the metadata is Text.

FIG. 185 is a computer screen snapshot view of the New Metadata Field where the metadata is Long Text.

FIG. 186 is a computer screen snapshot view of the New Metadata Field where the metadata is Number.

FIG. 187 is a computer screen snapshot view of the New Metadata Field where the metadata is Boolean.

FIG. 188 is a computer screen snapshot view of the New Metadata Field where the metadata is Date.

FIG. 189 is a computer screen snapshot view of the New Metadata Field where the metadata is Select List.

FIG. 190 is a computer screen snapshot view of the (fieldname) Select List Values page.

FIG. 191 is a computer screen snapshot view of the New List Option for (fieldname) page.

FIG. 192 is a computer screen snapshot view of the Select List Values page with data entered in the name field.

FIG. 193 is a computer screen snapshot view of the Select List Values page upon activation of the Edit feature.

FIG. 194 is a computer screen snapshot view of the Metadata Dictionary List.

FIG. 195 is a computer screen snapshot view of the Metadata Dictionary List undergoing a sequence edit.

FIG. 196 is a computer screen snapshot view of the Metadata Dictionary List after the sequence edit.

FIG. 197 is a computer screen snapshot view of the Settings function of AdCatalog.

FIG. 198 is a computer screen snapshot view of the Project group page.

FIG. 199 is a computer screen snapshot view of the Security function of AdCatalog.

FIG. 200 is a computer screen snapshot view of the Shopping Cart function of AdCatalog.

FIG. 201 is a computer screen snapshot view of a sample video spot in the Shopping Cart.

FIG. 202 is a computer screen snapshot view of an Order Summary for a spot.

FIG. 203 is a computer screen snapshot view of the Import/Export function of AdCatalog.

FIG. 204 is a computer screen snapshot view of the Import Catalog Record page.

FIG. 205 is a computer screen snapshot view of the Export Catalog Record page.

FIG. 206 is a computer screen snapshot view of the Import/Export Status Report.

FIG. 207 is a computer screen snapshot view of the Import/Export Status Report with an ERROR message.

FIG. 208 is a computer screen snapshot view of the Reports tab.

FIG. 209 is a computer screen snapshot view of the Spots for Distribution function.

FIG. 210 is a computer screen snapshot view of the Billing function.

FIG. 211 is a computer screen snapshot view of the User Imports function.

FIG. 212 is a computer screen snapshot view of the Contact tab.

### DETAILED DESCRIPTION OF THE INVENTION

### I. Glossary

1. Internet: a multimedia computer communications network built on worldwide telephone and data networks that use the Transmission Control Protocol/Internet Protocol suite of protocols to communicate with one another.

2. Intranet: An intranet is any internal network (LAN or WAN) that supports Internet applications—primarily web (hypertext transfer protocol), but also other applications such as FTP (file transfer protocol). Intranets are used by many companies to deliver private corporate information to internal users.

3. Local Area Network (LAN): A local area network (LAN) is a private internal communication network that is confined to a small area, such as a single building or a small cluster of buildings. It is a general-purpose local network that can serve a variety of devices, and is generally owned, used, and operated by a single organization. Using a LAN to inter-connect computers provides a more efficient and faster means for data transfer than traditional file transfer methods. All users on a LAN can share resources such as printers, storage devices, and telecommunication links to limit costs associated with duplication of data and equipment. A LAN can also improve business functions with interconnected workstations accessing electronic mail and various shared applications such as customer service inquiry.

4. Memory: The part of a computer or server that is used to store data. The main types of memory are classified as Random Access Memory (RAM) and Read-Only Memory (ROM); see below.

5. RAM: Specific types of RAM include, for example, dynamic RAM (DRAM), static RAM (SRAM), video RAM (VRAM), and synchronous DRAM (SDRAM). These and other types of RAM storage devices share some common attributes. For example, data can be read from or written to locations in a RAM array relatively quickly in comparison to other types of memory devices. In addition, manufacturing process technology has evolved to enable RAM devices, such as DRAM, to be formed in high densities using specialized techniques. Unfortunately, RAM devices belong to a class of memory devices called volatile memory, meaning that the data stored in a RAM array is erased as soon as the power supply to the array is removed. Therefore, to maintain the integrity of data stored in a RAM array, power to the array must be maintained at all times. Unfortunately, this condition cannot be readily satisfied in mobile electronic devices, making volatile memory components such as RAM devices ill-suited for mobile applications in which data is required to be stored for extended periods of time.

6. ROM: This type of memory belongs to a class of memory devices called non-volatile memory because data stored in a ROM array is permanently fixed in the array until the array is intentionally erased. Even if the power supplied to the memory array of a ROM device is entirely removed, the data stored within the array is still maintained. Some common types of ROM memory devices include programmable ROM (PROM), erasable programmable ROM (EPROM), electrically erasable programmable ROM (EEPROM), and flash memory.

7. WAN: A wide area network. A WAN is similar to a LAN in that it is also a communication network, but a WAN extends over a much broader area, interconnecting communication facilities in different parts of a country. A WAN may also be used as a public utility.

8. WWW: the World Wide Web, i.e. the total set of interlinked hypertext documents residing on hypertext transfer protocol (HTTP) servers all around the world.

Referring generally to key advantages and preferred embodiments of the present invention, one preferred embodiment of the present invention allows a user to keep all their latest ads in one place and make the ads immediately accessible to their dealers, franchisees and customers anywhere in the world.

In a preferred embodiment of the present invention, an advertisement data file (10) is downloaded to a Central Server (12). The Central Server (12) is accessed by a network server (14) that processes orders for the advertisements from a customer using a PC workstation with an internet connection (18) using an Internet Service Provider Server (16).

Additionally, in another preferred embodiment of the present invention, a user can easily create a custom Web site that allows everyone involved in the advertising effort to view and even order the video and print ads.

A further preferred embodiment of the present invention provides a user the ability to keep all their ads in one place. Thus, a user no longer has to rely on various locations and databases for their ads. In one aspect, all ads are easily consolidated into a single, secure Web site and the systems is scalable and flexible depending on the size of the ads, e.g. there is no limit to how much material can be maintained on the Web site. Preferably, a user customizes their online catalog by implementing client or brand specific catalog designs by simply downloading and viewing it.

In a further embodiment of the present invention, it provides an immediate sharing of ads through the organization. In one aspect, the immediate sharing is performed domestically and/or internationally. In a preferred embodiment, users only require a Web browser and an internet connection.

Yet another preferred embodiment provides for the integration of any other All-Digital Lifecycle Products and services, incorporated by reference herein in its entirety, to assist management of the ads. In a preferred embodiment, the invention integrates with NetClear digital clearance systems to manage network and legal clearance of audio or video spots. In yet another preferred embodiment, the invention integrates with DG Online, an order entry Internet system, to provide a user the ability to select a specific spot for immediate distribution to radio and television broadcasters.

Another preferred embodiment of the invention provides for support of all media types, including video, audio, print, attachments, and news postings.

Of course, other embodiments are considered encompassed within the inventive subject matter described broadly herein and any description, including the claims, is intended to be illustrative and not intended to be limiting. While the detailed description has shown, described, and pointed out the fundamental novel features of the invention as applied to various embodiments, it will be understood that various omissions and substitutions and changes in the form and details of the system illustrated may be made by those skilled in the art, without departing from the concepts of the invention. Additionally, any changes, modifications, alterations, or omissions which are insubstantial or which merely perform the same function the same way with the same result are considered within the scope of the present inventive subject matter.

As will be appreciated by one of ordinary skill in the art, the various steps, tasks, or functions illustrated are not necessarily sequential in nature. As such, the present invention is generally independent of the particular sequence or order in which the tasks or steps are completed. Various steps, tasks, or functions may be completed simultaneously, virtually simultaneously, or may be separated by minutes, hours, or days without departing from the spirit or scope of the present invention. Preferably, the present invention performs automatic electronic ordering of telecommunications using computer-to-computer communications exclusively, meaning that no human intervention is required to reduce or eliminate keying errors, mishandled or lost forms, and the like. However, the present invention incorporates exception processing which may include some level of human intervention to process unique or as yet undefined transactions

The System Requirements are as follows:

Personal Computer (PC) or Macintosh

Connection to the Internet via a Local Area Network (LAN), or modem with an ISP account.

Recommended web browsers:

Microsoft Explorer 5.0 or higher

Netscape Navigator 4.7 or higher

Recommended modem speed: minimum 56.6 K bits per second (KbPS).

Accessing AdCatalog

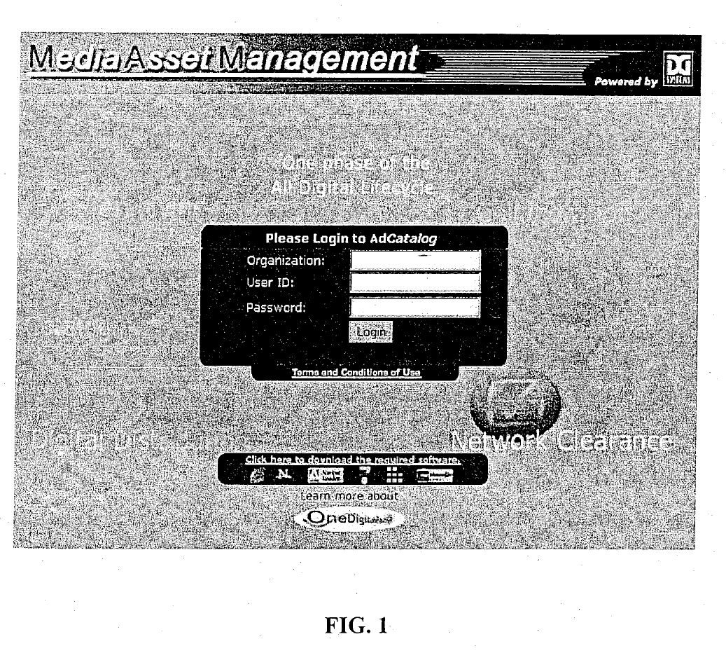

In order to access AdCatalog for the first time, go to http:/ac.dgsystems.com/ (for ease of use, we recommend that you bookmark this URL in your browser). This will open the Media Asset Management Login page, as shown in FIG. 1.

On the Media Asset Management (MAM) Login page, you will be asked to enter your organization number, username and password in the Username and Password fields. Once you have done this, click Log On to enter AdCatalog.

The Media Asset Management suite currently contains two tools, AdCatalog and NetClear. The first time you access the MAM Login page, the text on the Login box will read “Please Login to Media Asset Management”. When you log in, AdCatalog will be opened automatically and a cookie will be set in your browser. The next time you log into MAM, the cookie will open the tool you most recently used—thus, if you log out of AdCatalog, then log back in again, the test on the Login box will read “Please Login to AdCatalog.”

This is important to remember because it is possible to access NetClear from AdCatalog, and visa versa (more on this later). If you open AdCatalog, the switch to NetClear, the cookie in your browser will record this fact, and the next time you log into MAM, you will open NetClear instead of AdCatalog. You will then need to switch back to AdCatalog to use the tool. Once you have logged onto AdCatalog, you will be taken directly to the Catalog tab, where you can work with the directories, catalogs and news for your organization.

Tool Architecture

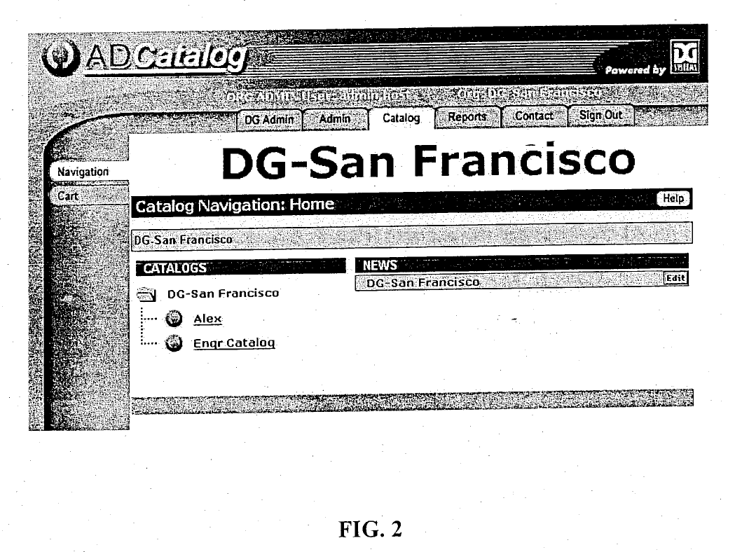

The tool architecture for AdCatalog follows the DG Systems standard for web-based tools—the user's name and organization appear at the top of the page, the six main tool tabs are listed across the top of the tool screen, and tab-specific functions are listed along the left side of the screen, as shown in FIG. 2.

DGAdmin

In the DGAdmin tab (only available to DG Administrators), an administrator can:

1) Select an organization for editing or order submission purposes

2) Create a new organization in AdCatalog

3) Track spot transfers between organizations

4) Work with unmatched ISCIs or print files.

5) Review requested or failed spot transfers.

6) Add, edit or disable spot metadata in the DG Systems metadata dictionary list.

7) Review file transfer information and tape drive reports.

8) Check the version information for AdCatalog.

Admin

In the Admin tab, administrators and users can:

1) Choose a tool to work with (AdCatalog or NetClear).

2) Review and edit organizational information.

3) Add users and edit user data.

4) Create user groups, and assign users to security, user and catalog groups.

5) Assign (DG Admin) or request (Org Admin) business partners for an organization, grant organizational administrative capabilities to a business partner (DG Admin), and add or edit brands associated with an advertiser.

6) Add, edit or disable spot metadata in the organization's metadata dictionary list.

7) Create new catalog and catalog directories, and assign catalog administrators.

8) Monitor, upload or delete files in the organization's file system structure (including the organization's corporate page and logo on the Catalog's navigation screen).

9) Create notification events (i.e. when spots are added to a specific catalog.)

10) Create notification email lists.

Catalog

In the Catalog tab, a user can:

1) Navigate between catalogs and catalog directories, and add news blurbs to an individual directory or catalog.

2) Search for spots, review spots and collateral materials in a record, and add spots to the Shopping Cart function for transfer to DG Online's order system.

3) Create a new record.

4) Add spots, print files and collateral files to a record.

5) Add, edit or disable spot metadata in the catalog's metadata dictionary list.

6) Add or remove users for a catalog.

7) Review or remove spots in the Shopping Cart, and print an order summary

8) Import and export catalog records, and create a status report of all import/export efforts.

Reports

In the Reports tab, a user can:

1) Search and create reports on various areas of billing information.

2) View a report on spots marked for distribution.

3) View an import user status report (user files can be imported in the Admin/User function).

Contact

In the Contact tab, a user can find the regional DG Systems contact information for an organization (AdCatalog Administrator(s), Sales, Video Technician, Billing Department and General Product Feedback). The regional DG Administrator will be responsible for updating the list.

Sign Out

Click on the Sign Out tab to log out of AdCatalog.

### II. AdCatalog Tabs and Functions

DG Admin

The DGAdmin tab is only accessible to a DG systems administrator—all other users (Organization Administrator, Catalog Administrator, Read/Write User and Read Only User) will see the Admin, Catalog, Reports, Contact and Sign Out tabs.

In the DGAdmin tab, you can select and work with an existing organization, create a new organization in AdCatalog, track spot activity, work with unmatched ISCIs or print files, review requested or failed spot transfers, add, edit or disable spot metadata in the DG Systems metadata dictionary lists, review file transfer information and tape drive reports, and check the version information for AdCatalog.

Description

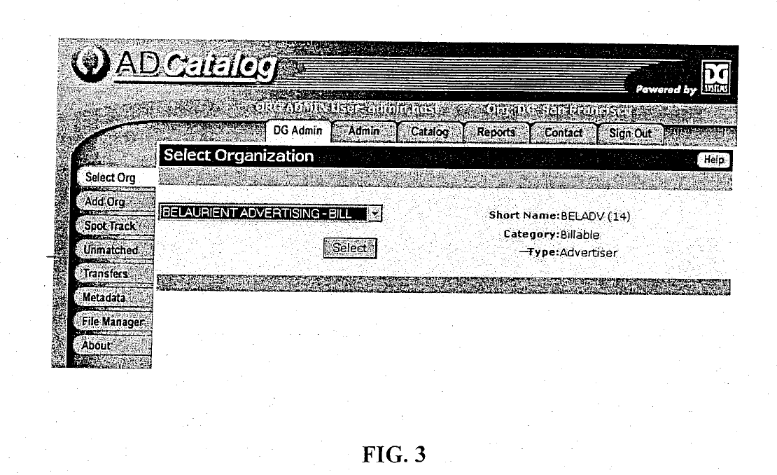

In the Select Organization function, as shown in FIG. 3, you can select an existing organization in AdCatalog and work with it as a DG Administrator (set DG Systems metadata, add business partners, etc.) Doing this also gives you organization administrator privileges for the organization, and you can do things such as set up new directories and catalogs, add users, create notification lists, etc.

Step-by-Step

Click on the DG Admin tab, then the Select Org tab. The Select Organization page will appear. In the drop-down box on the left, choose a DG Systems organization by clicking on it. When you do this, the organization will be highlighted and the organization's short name, organization number, category and type will appear on the right side of the page for easy reference. Be careful to review this information when making a selection, as organizations can be listed more than once.

After you have chosen an organization, click Select. This opens the organization's Catalog page. The name of the selected organization will now appear to the right of your userID and administrative organization in the page header.

In addition to DG Administrator's privileges, you can also act as an organization administrator and perform various tasks in the Admin, Catalog and Report tabs as well as the DG Admin tab, as shown in FIG. 4.

Add Organization

Description

In the Add Organization page, you can choose from three organization categories—Host, Billable and Simple.

1) A Host organization is used by DG Administrators for test and monitoring purposes within AdCatalog. Note: this type of organization should never by created for a customer.

2) A Billable organization is the most common organization type, and is used for agencies or any organization that needs to actively work with a catalog (creating directories, uploading files, creating records and assigning spots to them, etc.)

3) A Simple organization is used for organizations that only need to view catalog data.

Step-by-Step

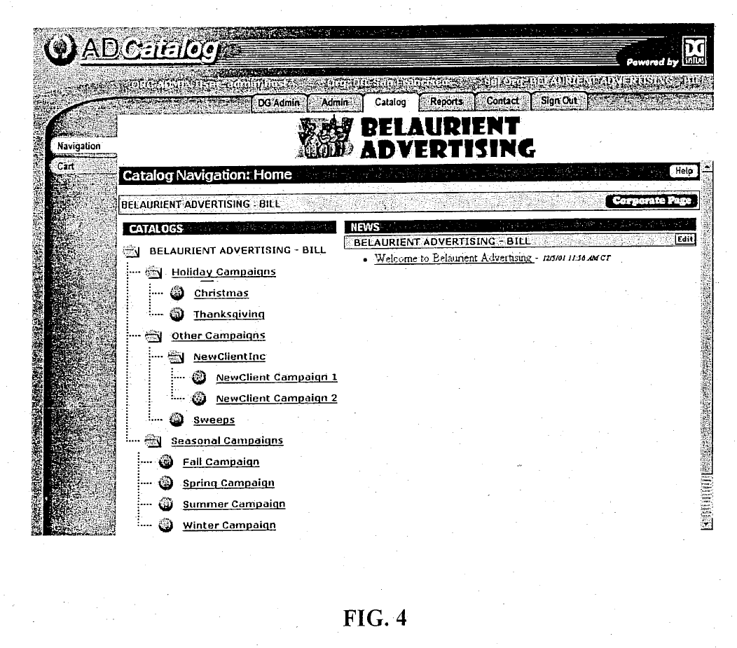

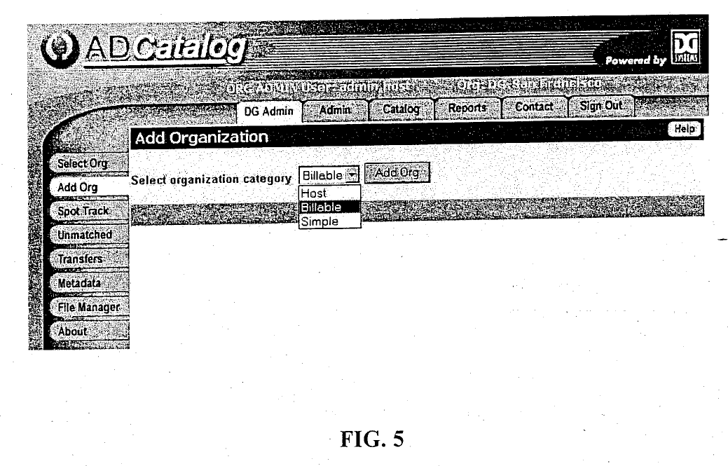

Click on the DG Admin tab, then the Add Org tab. The Add Organization page will appear, as shown in FIG. 5. In the drop-down box, choose an organization category—Host, Billable or Simple. Use Host if you are creating a DG Administration organization, Billable if you are creating an organization that needs to work with the catalog (agencies, law firms, etc.), or Simple if you are creating an organization that only needs to view catalog data (advertisers, studios).

After you have chosen an organization category, click Add Org. This opens the New Organization page, where you can enter settings, general and shipping information for the new organization.

New Organization

Description

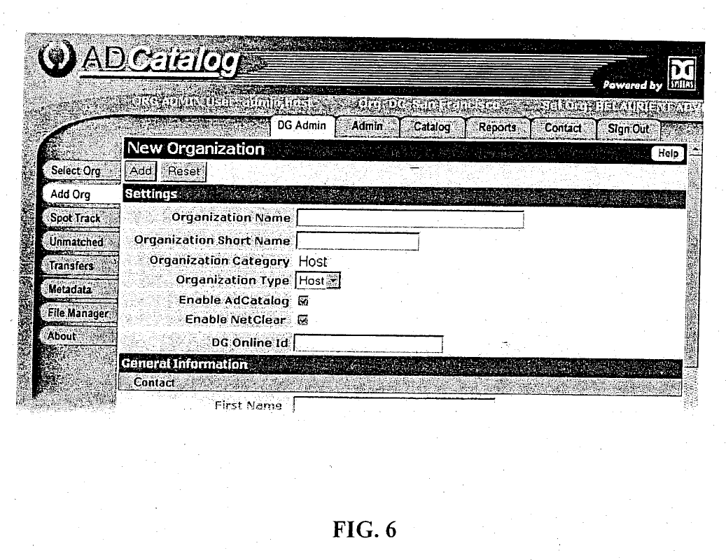

The New Organization page, as shown in FIG. 6, consists of three main sections—Settings, General Information and Shipping Information.

1) In Settings, you can enter basic information about the organization. The fields in this section will depend on what organization category you chose in the Add Organization page—Host, Billable or Simple.

2) In General Information, you can enter contact and address information for the organization's main contact person (usually an Organization Administrator).

3) In Shipping Information, you can enter contact and address information for a person at the organization who will receive shipped material. The shipping contact can be the same person as the organization contact (in General Information).

A Simple Organization does not receive spots or other material, so the Shipping Information section will not be visible when creating a Simple organization.

Step-by-Step

Settings—Billable Organization

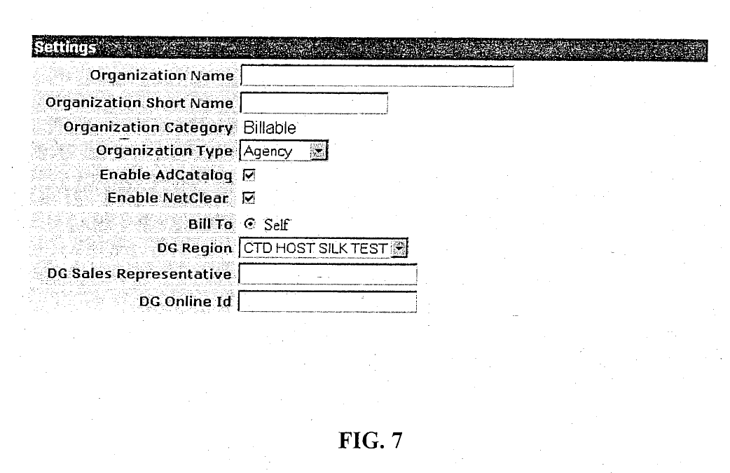

The Settings section, as shown in FIG. 7, is where you can enter basic data about the organization (name, type, applications to be used, etc.)

Enter the following information:

1) Organization Name the name of the organization.

2) Organization Short Name—an abbreviated name for the organization. This will appear on the Select Organization page when an organization is chosen.

3) Organization Category—the organization category you selected in the Add Organization page.

4) Organization Type—select an organization type:

a) Agency—an advertising agency

b) Advertiser—an advertiser

c) Law Firm—a law firm or legal entity

5) Enable AdCatalog—check this box to enable the organization to use AdCatalog (default is checked).

6) Enable NetClear—check this box to enable the organization to use NetClear (default is checked).

7) Bill to—click Self if the organization should be billed by DG Systems for account activity (spot posting, spot encoding, storage, etc.)

8) DG Region—in the drop-down box, select a DG Region (Chicago, Los Angeles, New York or San Francisco) in the same geographic area as the organization. This region will provide administrative assistance to the organization.

9) DG Sales Representative—the DG Sales Representative working with the organization.

10) DG Online ID—if available, the DG Online ID of the organization. This will let AdCatalog identify the correct owner organization when transferring spots to DG Online. If you do fill in this field, the transfer feature will not work.

Settings—Simple Organization

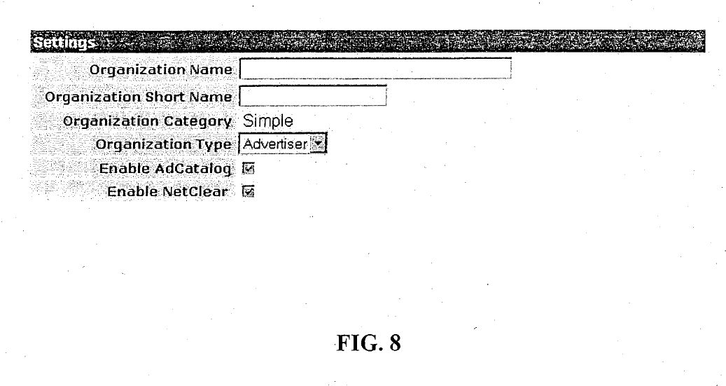

The Settings section is where you can enter basic data about the organization (name, type, applications to be used, etc.), as shown in FIG. 8.

Enter the following information:

1) Organization Name—the name of the organization.

2) Organization Short Name—an abbreviated name for the organization. This will appear on the Select Organization page when an organization is chosen.

3) Organization Category—the organization category you selected in the Add Organization page.

4) Organization Type—select an organization type:

a. Advertiser—an advertiser

b. Studio—a studio or other producer of spots.

5) Enable AdCatalogdefault checked

6) Enable NetClear—default checked.

General Information

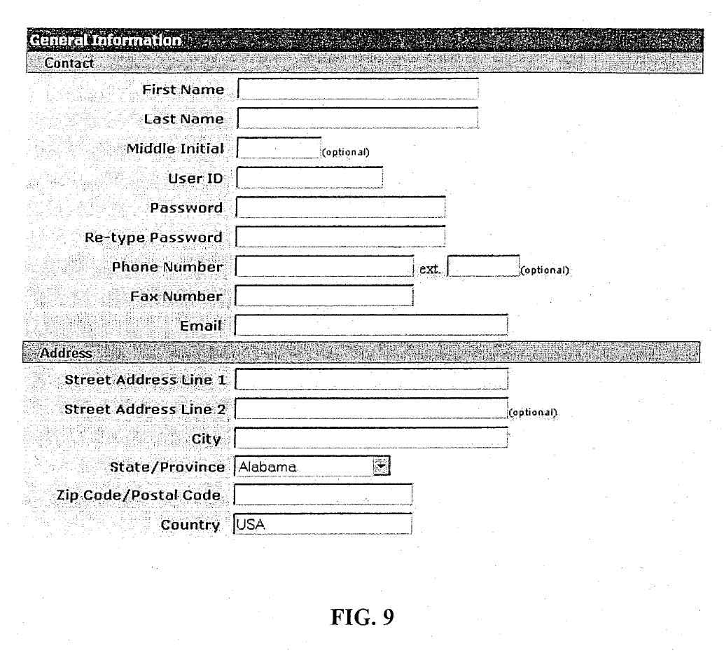

The General Information section is where you can enter personal and address information for a contact person in the organization (usually an Organization Administrator), as shown in FIG. 9.

Enter the following information:

1) First Name—the first name of the organization contact.

2) Last Name—the last name of the organization contact.

3) Middle Initial (optional)—the middle initial of the organization contact.

4) User ID—a user ID for the organization contact. This should be a combination of the user's first and last names, and should be in all lower case letters. (e.g. bobdavis, mfletcher).

5) Password—the organization contact's password (length is 8 to 30 characters).

6) Re-type password—re-enter the password to confirm it.

7) Phone Number—the organization contact's phone number.

8) Fax Number—the organization contact's fax number.

9) Email—the organization contact's email address.

10) Street Address—the organization contact's street address. Use both lines if necessary.

11) City—the city where the organization contact works (e.g. San Francisco).

12) State/Province—the state or province in which the organization contact works (e.g. California, Alberta)

13) Zip Code/Postal Code—the organization contact's zip or postal code.

14) Country—the country in which the organization contact works.

General Information—Simple Organization

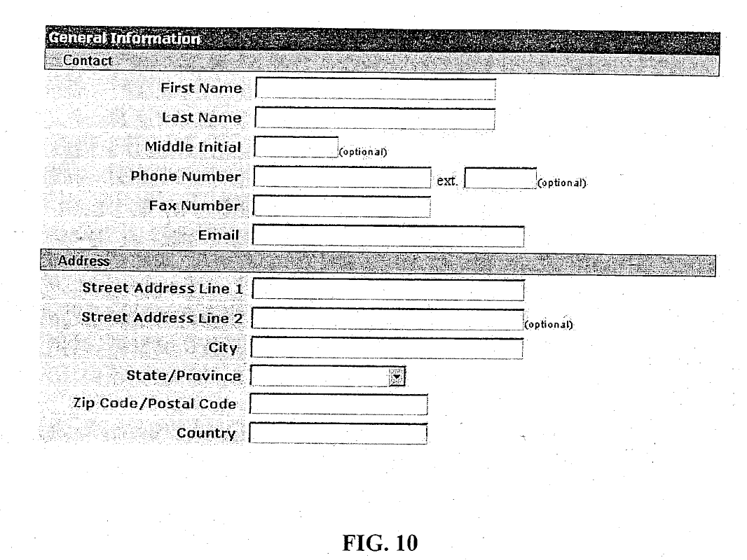

The General Information section is where you can enter personal and address information for a contact person in the organization (usually an Organization Administrator), as shown in FIG. 10.

Enter the following information:

1) First Name—the first name of the organization contact.

2) Last Name—the last name of the organization contact.

3) Middle Initial (optional)—the middle initial of the organization contact.

4) Street Address—the organization contact's street address. Use both lines if necessary.

5) City—the city where the organization contact works (e.g. San Francisco).

6) State/Province—the state or province in which the organization contact works (e.g. California, Alberta)

7) Zip Code/Postal Code—the organization contact's zip or postal code.

8) Country—the country in which the organization contact works.

Shipping Information—Billable Organization

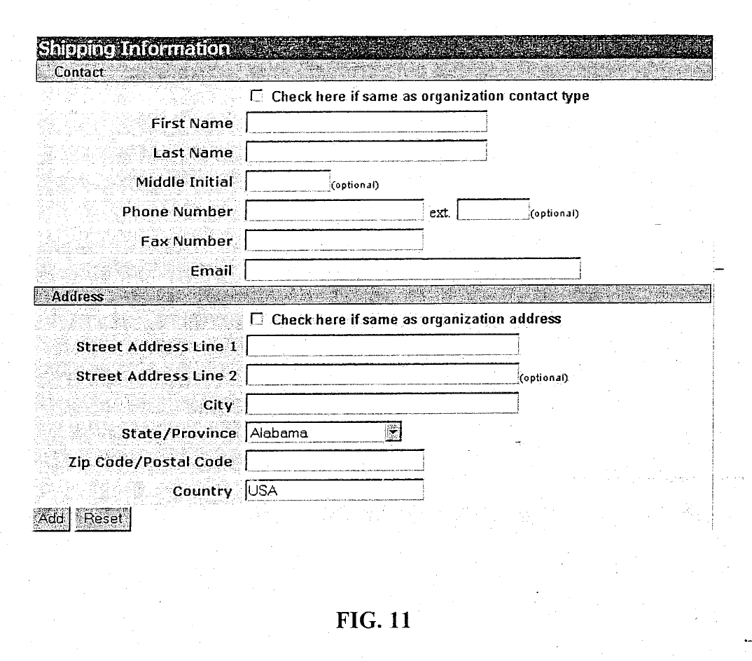

The Shipping Information section is where you can enter contact and address information for a person at the organization who will receive shipped material, as shown in FIG. 11. The shipping contact can be the same person as the organization contact listed in the General Information section—if this is the case, check the box marked “Check here if same as orgaization contact type” to copy the organization contact information, and “Check here is same as organization address” to copy the organization address information.

If you uncheck the box after your information has been copied, you can edit that information to make small changes (instead of having to enter all the information again.) If someone other than the organization contact will be receiving shipped materials, enter the following information:

1) First Name—the first name of the shipping contact.

2) Last Name—the last name of the shipping contact.

3) Middle Initial (optional)—the middle initial of the shipping contact.

4) User ID—a user ID for the shipping contact. This should be a combination of the user's first and last names, and should be in all lower case letters. (e.g. bobdavis, mfletcher).

5) Password—the shipping contact's password (length is 8 to 30 characters).

6) Re-type password—re-enter the password to confirm it.

7) Phone Number—the shipping contact's phone number.

8) Fax Number—the shipping contact's fax number.

9) Email—the shipping contact's email address.

10) Street Address—the shipping contact's street address. Use both lines if necessary.

11) City—the city where the shipping contact works (e.g. San Francisco).

12) State/Province—the state or province in which the shipping contact works (e.g. California, Alberta)

13) Zip Code/Postal Code—the shipping contact's zip or postal code.

14) Country—the country in which the shipping contact works.

If you wish to clear the fields at any point and re-enter data, click Reset.

Once you have completed the New Organization page, click Add at the top or bottom of the page. If you have entered all the information correctly, you will see a system message that says “Org Created Successfully”. Below this will be the following fields with data about the new organization:

1) Organization ID—MAM ID number of the organization.

2) Name—name of the organization.

3) Short name—short name of the organization

4) Category—category of the organization. (Host, Billable or Simple)

5) Type—type of the organization (Host, Agency, Advertiser, Law Firm, Studio)

If you want to create another new organization, click OK. This will return you to the Add Organization page.

Spot Track

Description

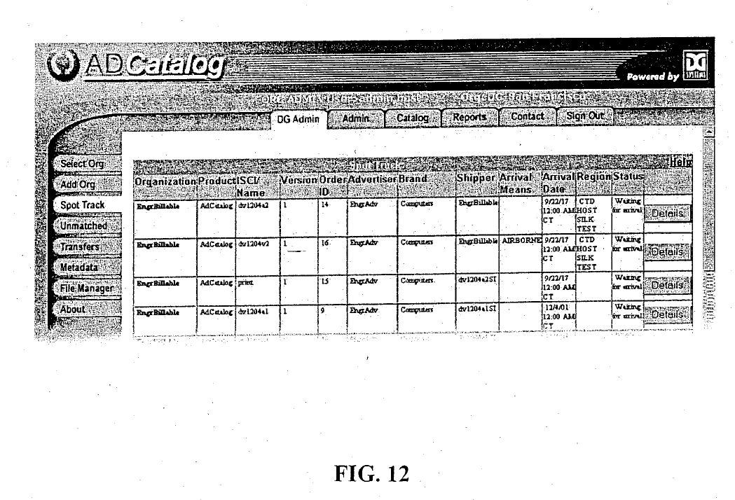

In the Spot Track function, you can view a list of spots that are expected to arrive at the DG NOC for entry into AdCatalog or NetClear, as shown in FIG. 12. You can also view details about each spot, cancel incoming spots, attempt to reflip spots, or purge unflipped spots. Spots are listed in reverse chronological order. A table marked Spot Track will contain the following information:

1) Organization—the organization that ordered the spot.

2) Product—the tool (AdCatalog or NetClear) that is processing the spot.

3) ISCI/Name—the ISCI code or name that has been assigned to the spot.

4) Version—the version of the spot.

5) Order ID—order ID number of the spot.

6) Advertiser—advertiser of the material in the spot.

7) Brand—brand advertised in the spot.

8) Shipper—organization that is shipping the spot to DG Systems

9) Arrival Means—how the spot is arriving at DG Systems.

10) Arrival Date—time and date the spot is scheduled to arrive at DG Systems

11) Region—the DG Region that is responsible for a particular spot.

12) Status—current status of the spot.

To the right of every spot is a button labeled “Details”. You can click this to open the Spot Details page and review detailed information about the spot, as well as cancel incoming spots before they are matched to an ISCI, attempt to reflip a spot that hasn't been transcoded, or purge an unflipped spot from DG Systems.

Step-by-Step

Use the Spot Track table to locate the spot you want to review. Information about a spot is listed in the following manner.

1) Organization—the organization that ordered the spot.

2) Product—the MAM tool (AdCatalog or NetClear) that is processing the spot.

3) ISCI/Name—the ISCI code or name that has been assigned to the spot.

4) Version—the version of the spot (e.g. 1,2,3, etc.). This refers to whether a spot has been modified due to requests from Network Clearance, the advertiser, etc.

5) Order ID—MAM order ID number of the spot.

6) Advertiser—advertiser of the material in the spot.

7) Brand—brand advertised in the spot.

8) Shipper—organization that is shipping the spot to DG Systems

9) Arrival Means—how the spot is arriving at DG Systems.

a) Airborne—delivered by Airborne.

b) Courier—delivered by courier service.

c) Encoder—delivered by encoder.

d) FedEx—delivered by FedEx.

e) Fiber Feed—delivered by land-based fiber (Vyvx).

f) Onhand—already at DG Systems.

g) Unknown—unknown method of delivery

h) UPS—delivered by UPS.

10) Arrival Date—time and date the spot is scheduled to arrive at DG Systems

11) Region—the DG Region that is responsible for a particular spot.

12) Status—current status of spot activity:

a) Waiting for arrival—the spot hasn't arrived at DG Systems yet.

b) Problem Flipping—this status is highlighted in red, and means that Flip Factory was unable to add the spot to a media record.

c) Available—the spot is at DG Systems.

d) Unmatched—the spot has not yet been matched to a record.

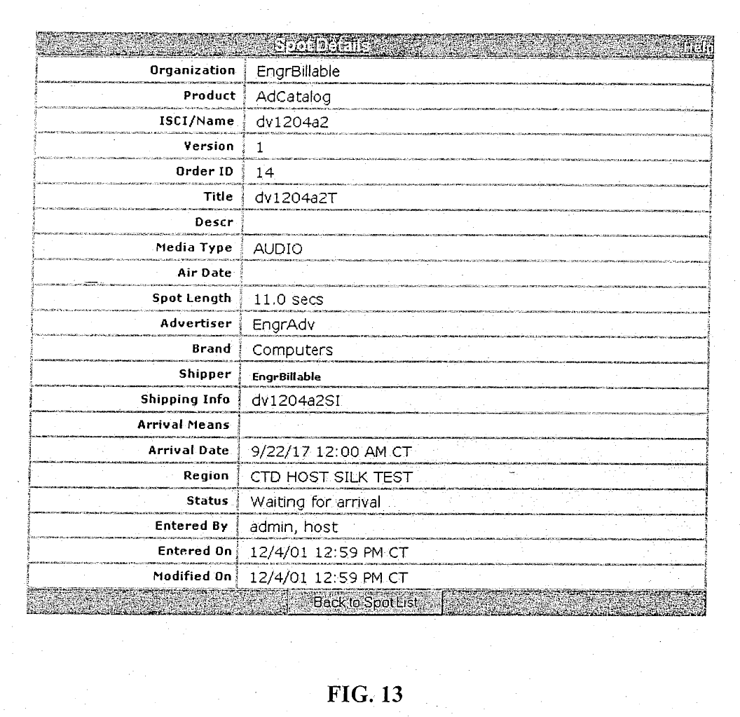

To view detailed information about a spot, click the Details button at the end of the spot's row. This will open a table called Spot Details, as shown in FIG. 13.

Detailed information about a spot includes the information shown in the Spot Track table, as well as the following fields:

1) Title—title of the spot.

2) Descr—short description of the spot.

3) Media type—type of spot media:

a) Video

b) Audio

c) Print

4) Air date—scheduled date on when the spot will first air.

5) Spot length—length of the spot in seconds.

6) Shipping info—brief shipping information about the spot

7) Entered by—the user who created the spot record.

8) Entered on—the date and time the spot record was created.

9) Modified on—the date and time the spot record was last modified.

At the bottom of the table is a button marked “Return to Spot List”. Click this to return to the Spot Track table.

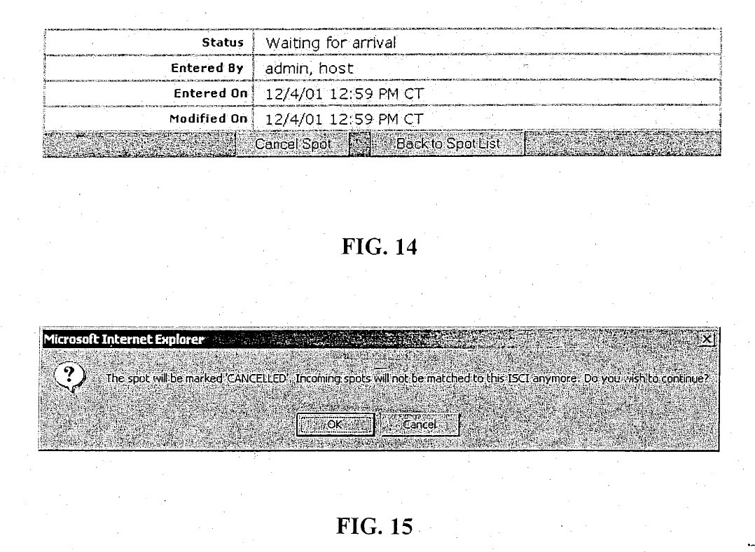

If you are logged on as a DG Administrator, you will see another button at the bottom of the table marked Cancel Spot, as shown in FIG. 14. Click Cancel Spot to prevent the spot from being attached to the ISCI listed in the spot's media record. The user will see a message as shown in FIG. 15. Click OK. The spot will be removed from the Spot Track table.

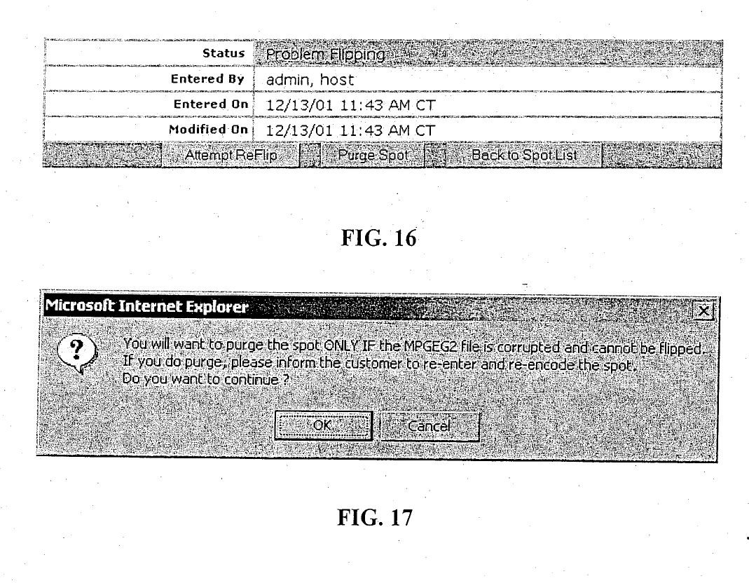

If a spot has the status “Problem Flipping”, it means that NetClear's FlipFactory facility wasn't able to transcode the spot within 30 minutes after matching it to an ISCI. If this happens, click the spot's “Details” button. You will see two other buttons at the bottom of the Spot Details table, as shown in FIG. 16—Attempt ReFlip and Purge Spot. Click Attempt ReFlip to try and transcode the spot again. If a spot will not flip properly and you want to purge it from AdCatalog, click Purge Spot. (The user should purge a spot only if the MPGEG2 file has been corrupted and cannot be flipped.) The user will see a message as shown in FIG. 17. Click OK. The spot will be purged from AdCatalog. You will then need to get in contact with the encoding facility and ask them to re-encode the spot.

Unmatched

Description

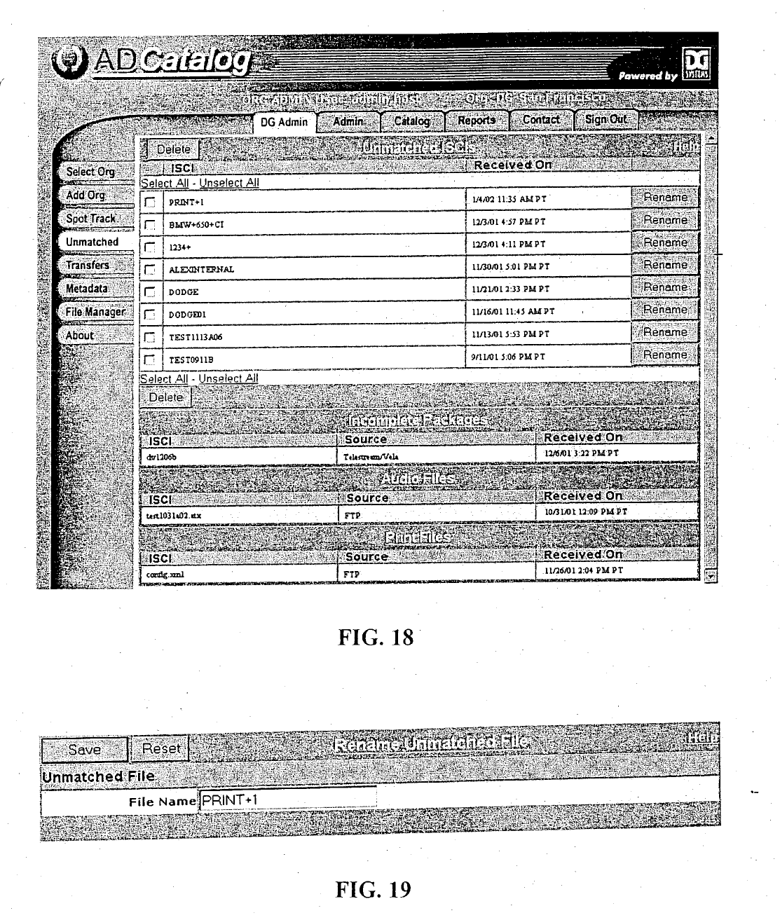

In the Unmatched function, as shown in FIG. 18, the user can view a list of spot files that have been received for input into AdCatalog, but haven't been matched to ISCIs in pending media records. This will sometimes happen when an ISCI is incorrectly entered into a media record, or incorrectly coded into a spot file. The function also shows incomplete packages and unmatched audio files and print files.

Step-by-Step

If a spot file is unmatched because it has a different name than the one listed in its media record, you can rename the spot by clicking its Rename button. This will open the Rename Unmatched File page, as shown in FIG. 19.

Enter the correct name as listed in the file's media record, and click “Save.” Within an hour, AdCatalog should match the spot file to its corresponding media record, and the file will be removed from the Unmatched page.

To delete an unmatched file that you no longer expect will be matched, check its selection box at the left, and click “Delete”. The file will be deleted from AdCatalog. To select all files for deletion, click the “Select All” Link, then click “Delete”. To unselect all files, click “Unselect All” link.

Transfers

Desciption

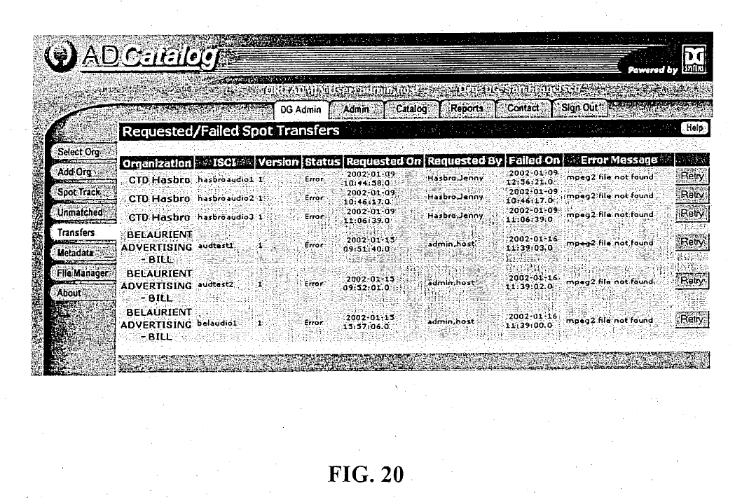

In the Transfers function, as shown in FIG. 20, the user can check spots that have been added to the Cart function for transfer to DG Online, as well as failed spot transfers.

Step-by-Step

Information about each spot is presented in the following table:

1) Organization—the organization that owns the spot.

2) ISCI—the ISCI code of the spot.

3) Version—the version of the spot.

4) Status—the status of the transfer.

5) Requested on—the date and time the request for the transfer was made.

6) Requested by—the user who requested the transfer.

7) Failed on—if the transfer did not work, the date and time it failed.

8) Error message—the reason why the transfer failed.

If a transfer has failed, use the information in the Error Message field to correct the problem, then click “Retry” to try and transfer the spot to DG Online again. If it does not work, contact your DG Administrator for assistance. If there are no requested or failed spot transfers, you will see the word “None” in red.

Metadata

Description

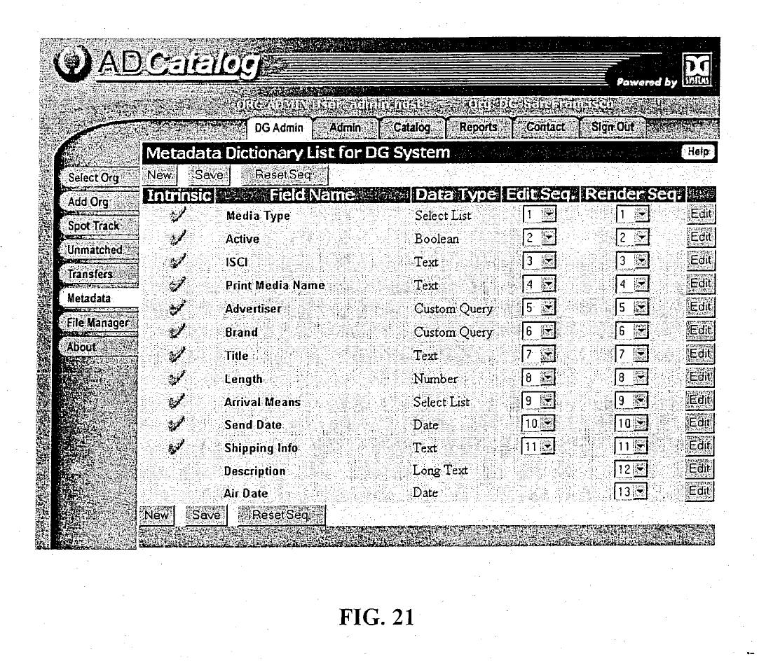

In the Metadata function, as shown in FIG. 21, you can modify current metadata settings and create new settings throughout AdCatalog.

Metadata is specific information about a spot that is included in the spot's media record, and is listed in the “Metadata Dictionary List for DG Systems”. The Metadata Dictionary List is organized in the following columns:

1) Intrinsic—the metadata filed is active and will appear in all media records in AdCatalog.

2) Field Name—name of the field.

3) Data Type—Data type of the field. (Text, Long Text, Number, Boolean, Date, Select List).

4) Edit Seq.—how the fields are listed in the Metadata Dictionary List.

5) Render Seq.—how the fields are listed in a media record. The first eight fields will appear in the main section of a record—to see all the fields, a user will need to click “Details”.

There are eleven metadata fields that will be included in every AdCatalog media record:

1) Media Type—the media type of the spot (Video, Audio, Print).

2) Active—whether or not a spot is active and should show up in a catalog.

3) ISCI—the ISCI code of the audio or video spot.

4) Print Media Name—the filename of a print/image file.

5) Advertiser—the advertiser represented by the spot.

6) Brand—the brand advertised in the spot.

7) Title—the title of the spot.

8) Length—the length of the spot in seconds.

9) Arrival Means—how the spot is arriving at DG Systems

10) Send Date—the date and time the spot was sent to DG Systems

11) Shipping Info—shipping information about the spot.

You can also create additional metadata fields for all media records in DG Systems by clicking “New”—this will start the “Add New Metadata Wizard”, where you can select what data type you wish to use for your metadata and create the metadata field itself. To edit information about a metadata field, click “Edit”—this will open the metadata field and allow you to edit it.

You can use the “Edit Seq.” and “Render Seq.” columns to determine the sequence in which the fields will be listed in the Metadata Dictionary List and a media record, respectively. Clicking on a field's position number and selecting a new position will exchange that field with the one previously in the selected position. To save these sequence changes, click Save.

In addition to the Metadata Dictionary List for DG Systems, you can create individual Metadata Dictionary Lists for organization and catalogs, allowing you to add organization or catalog-specific metadata to media records. These Dictionary Lists are discussed in the Admin and Catalog tabs.

Any changes made to a metadata field will not show up in AdCatalog until you log out and start a new session. Also, existing records created prior to the addition or change of a metadata field will not contain the change.

Step-by-Step

Editing an Existing Metadata Field

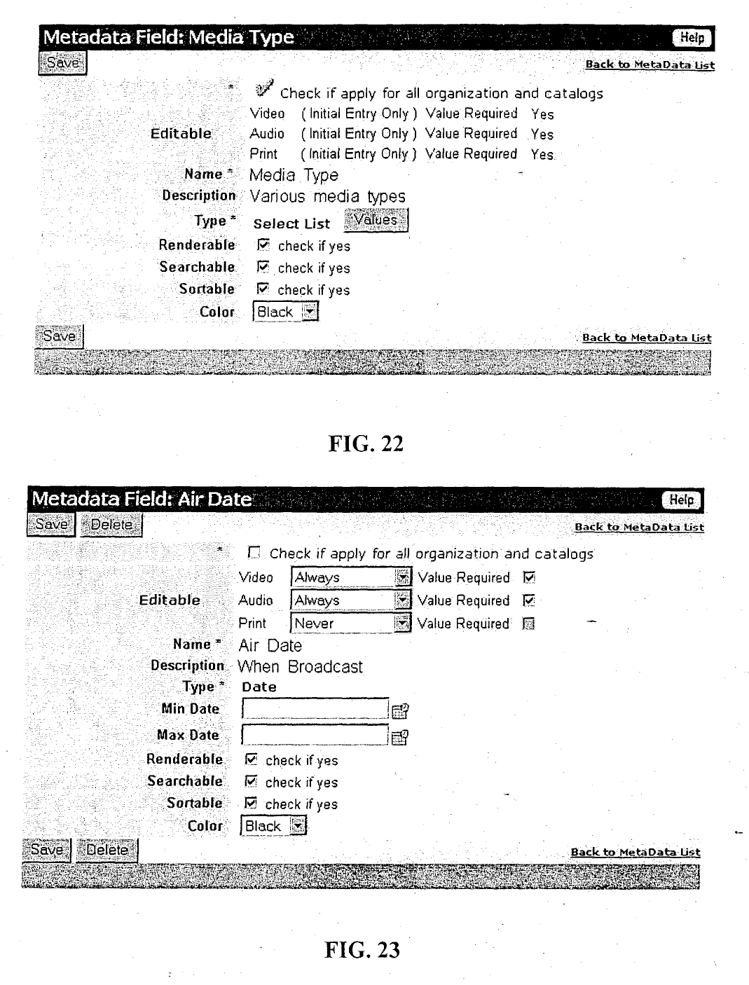

Click “Edit” in the row of the metadata field that you want to edit. This will open the “Metadata Field: Media Type” page, as shown in FIG. 22.

If you are editing one of the nine metadata fields that must appear in all AdCatalog media records (e.g. Media Type), you will only be able to edit the following options:

1) Renderable—check this if the field should appear in new media records. (unchecking this box will disable the metadata field, and it won't be used in any new media records).

2) Searchable—check this if the field can act as a search parameter.

3) Sortable—check this if the field can act as a sorting parameter.

4) Color—select the color of the metadata text as it will appear in a media record. (default is black).

Once you have made your changes, click Save. Your changes will be saved and you will be returned to the Metadata List, as shown in FIG. 23.

If you are editing a metadata field that has been created by a DG Administrator, you can make changes to all the following options (the terms in parentheses refers to the data type of the metadata field—Text, Long Text, Number, Boolean, Date or Select List):

1) Editable (all data types)—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name (all data types)—enter the name of the field (e.g. File Name).

3) Description (all data types)—enter a short description of the metadata field (e.g. filename).

4) Min. Length (Text, Long Text)—enter the minimum character length of text.

5) Max. Length (Text, Long Text)—enter the maximum character length of text.

6) Min Value (number)—enter the minimum number of characters in field.

7) Max Value (number)—enter the maximum number of characters in field.

8) Min Date (date)—enter a start date for the metadata activity. Click on the Calendar icon, if needed, to find and select a date.

9) Max Date (date)—enter an end date for the metadata activity. Click on the Calendar icon, if needed, to find and select a date.

10) Renderable (all data types)—check this if the field should appear in new media records (unchecking this box will disable the metadata field, and it won't be used in any new media records.)

11) Searchable (all data types)—check this if the field can act as a search parameter.

12) Sortable (all data types)—check this if the field can act as a sorting parameter.

13) Color—select the color of the metadata text as it will appear in a media record (default is black).

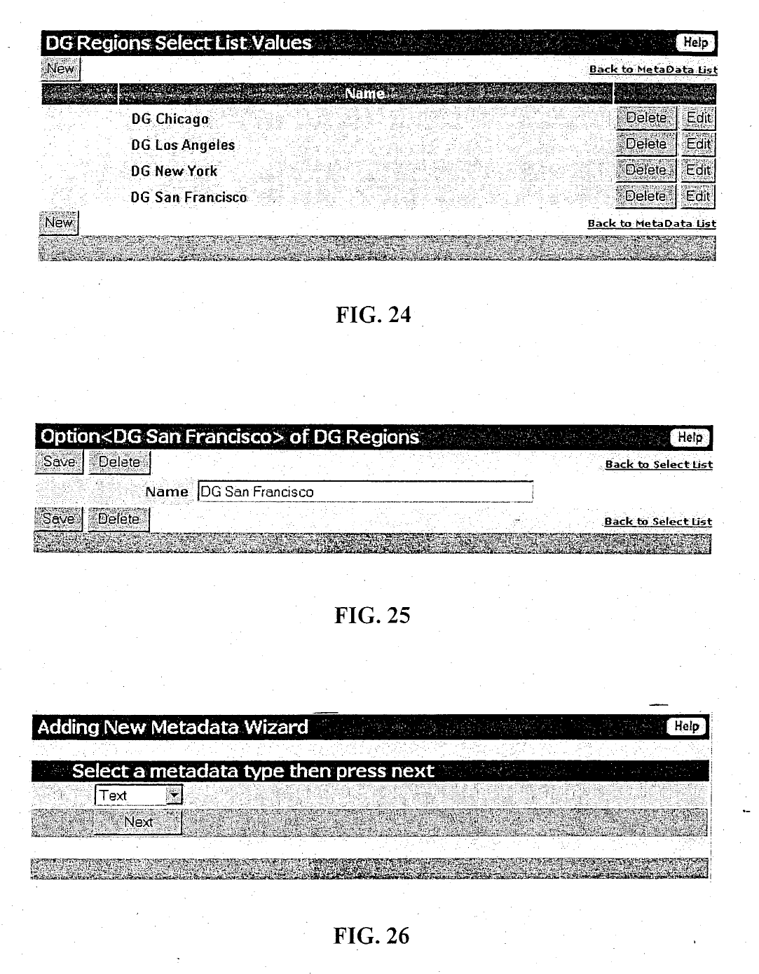

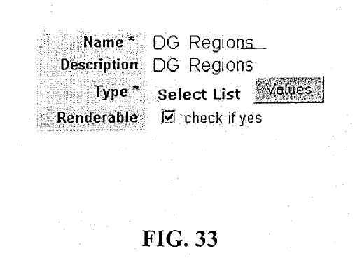

When editing a Select List metadata field, you may want to edit or delete list values in the select list. To do this, click “Values” on the screen as shown in FIG. 33—this will open the “Select List Values” page, as shown in FIG. 24. To delete a list value from the select list, click “Delete”. To edit a list value, click “Edit”—this will open the value and you can edit the name of the list value in the “Name” field, as shown in FIG. 25. To save your changes, click Save. To delete this list from the select list, click Delete.

Creating a New Metadata Field

Click New on the Metadata Dictionary List. This will start the Add New Metadata Wizard, as shown in FIG. 26. From the drop-down box, select a metadata type:

1) Text—a field that contains short text (e.g. filename).

2) Long Text—a field that contains longer text (e.g. instructions, comments).

3) Number—a field that contains numbers (e.g. phone numbers, fax number).

4) Boolean—a drop-down box with Yes/No choices (e.g. Active—yes or no.)

5) Date—a field where you can set minimum and maximum dates for an activity (e.g. flight dates).

6) Select List—a drop-down box with multiple choices (e.g. business partners, campaigns).

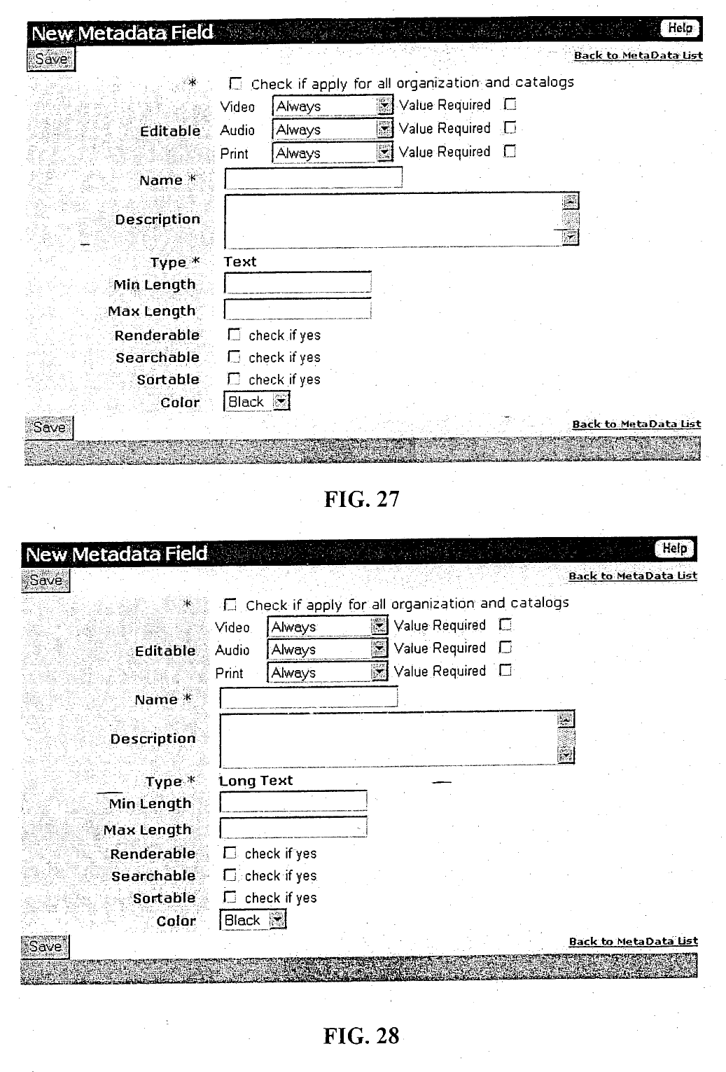

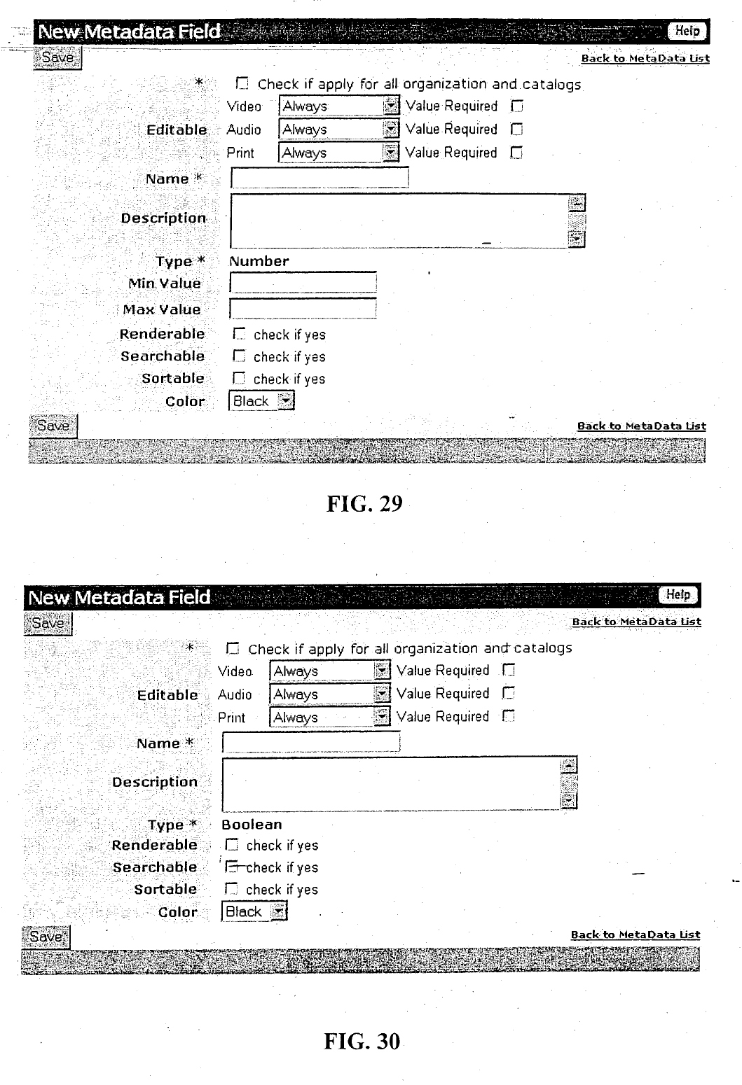

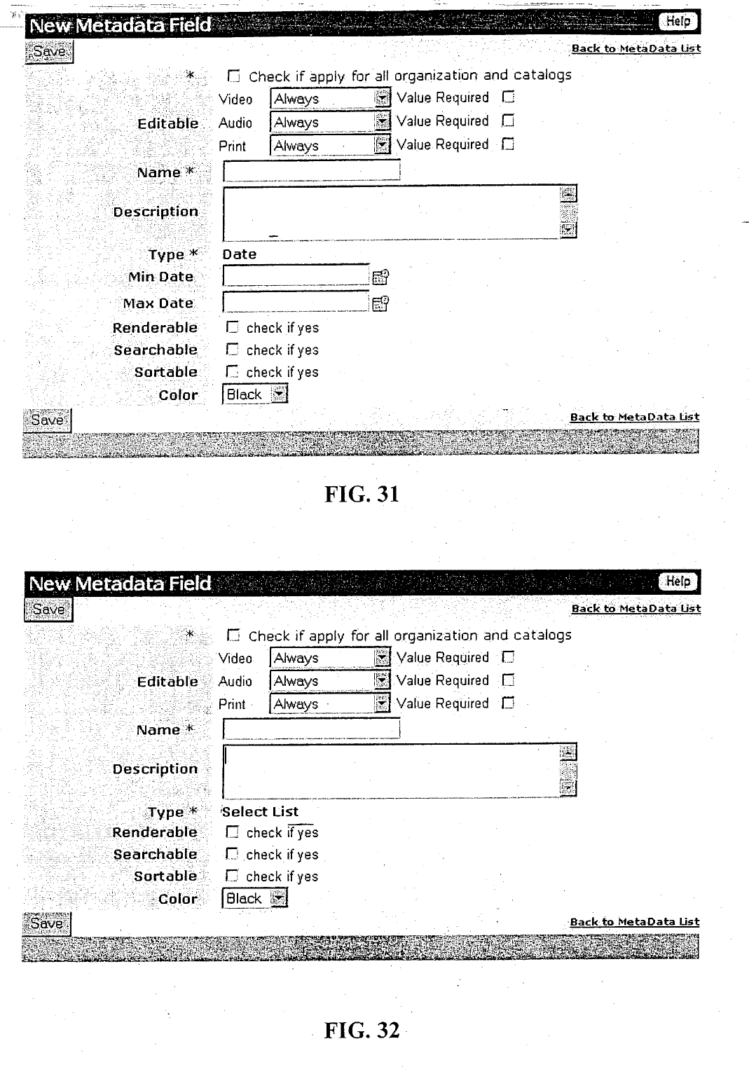

Click Next. This will open the New Metadata Field page, as shown in FIGS. 27-32, where you can complete the new metadata field, depending on what type of metadata is desired.

New Metadata Field—Text

If this field should be used throughout AdCatalog, check the “Check if apply for all organizations and catalogs” box.

1) Editable (all data types)—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. File Name).

3) Description—enter a short description of the metadata field (e.g. filename).

4) Type—Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Long Text

If this field should be used throughout AdCatalog, check the Check if applyfor all organizations and catalogs box.

1) Editable (all data types)—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Air Information).

3) Description—enter a short description of the metadata field (e.g. instructions for airing the spot).

4) Type—Long Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Number

If this field should be used throughout AdCatalog, check the Check if apply for all organizations and catalogs box.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Order ID).

3) Description—enter a short description of the metadata field (e.g. AdCatalog order ID number).

4) Type—Number.

5) Min. Value—minimum number of characters in field

6) Max. Value—maximum number of characters in field.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Boolean

If this field should be used throughout AdCatalog, check the Check if apply for all organizations and catalogs box.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Active).

3) Description—enter a short description of the metadata field (e.g.yes—available; no—unavailable).

4) Type—Boolean.

5) Renderable—check this if the field should appear in new media records (unchecking this box will disable the metadata field, and it won't be used in any new media records.)

6) Searchable—check this if the field can act as a search parameter.

7) Sortable check this if the field can act as a sorting parameter.

8) Color—select the color of the metadata text as it will appear in a media record (default is black).

Click Save to save all changes and return to the Metadata List. Click Back to Metadata List if you do not want to make or save any changes.

New Metadata Field—Date

If this field should be used throughout AdCatalog, check the Check if apply for all organizations and catalogs box.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Flight Date).

3) Description—enter a short description of the metadata field (e.g. flight date for spot).

4) Type—Date.

5) Min. Date—enter a start date for the metadata activity. Click on the Calendar icon, if needed, to find and select a date.

6) Max. Date—enter an end date for the metadata activity.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Select List

If this field should be used throughout AdCatalog, check the Check if apply for all organizations and catalogs box.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. DG Regions).

3) Description—enter a short description of the metadata field (e.g. DG Regions to administrate spot).

4) Type—Select List.

5) Renderable—check this if the field should appear in new media records (unchecking this box will disable the metadata field, and it won't be used in any new media records.)

6) Searchable—check this if the field can act as a search parameter.

7) Sortable—check this if the field can act as a sorting parameter.

8) Color—select the color of the metadata text as it will appear in a media record (default is black).

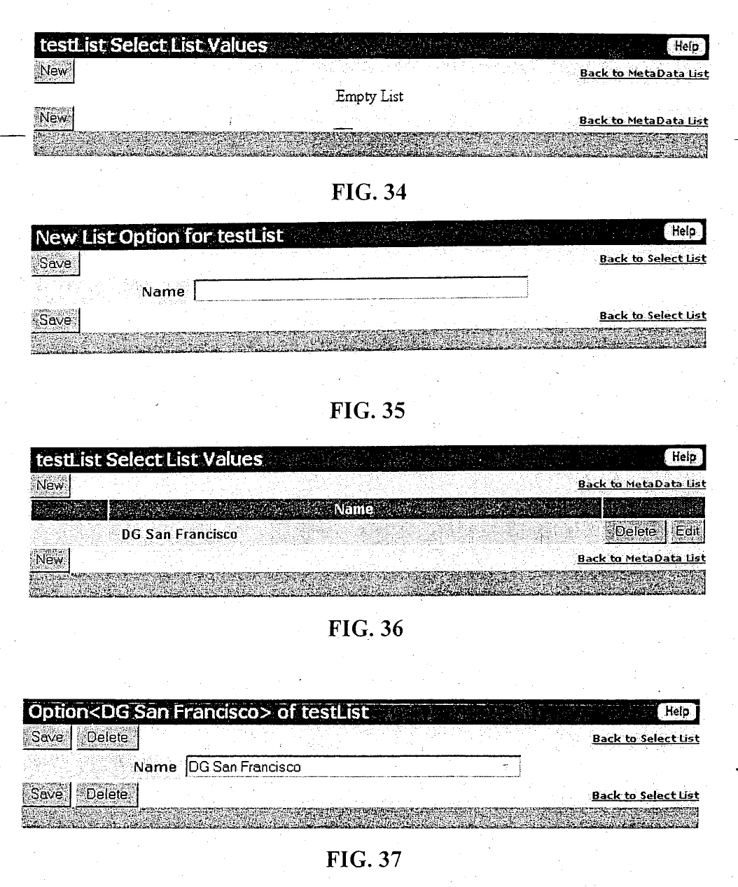

Click Save. This will open a page called (fieldname) Select List Values, as shown in FIG. 34, where you can enter values for your list.

Click New. This will open the New List Option for (fieldname) page, as shown in FIG. 35.

Enter the name of the list value (e.g. San Francisco) in the Name field, then click Save, as shown in FIG. 36. This will return you to the Select List Values page, where the new list value will appear. Continue the process until you have added all the list values to the select list, as shown in FIG. 37. To delete a list value, click Delete. To edit the name of a list value, click Edit—this will open the value, and you can edit the name of the list value. To save your changes, click Save. To delete the list value, click Delete.

Once you have added all the list values to the select list, click Back to Metadata List to return to the Metadata List.

Change the Editing Sequence

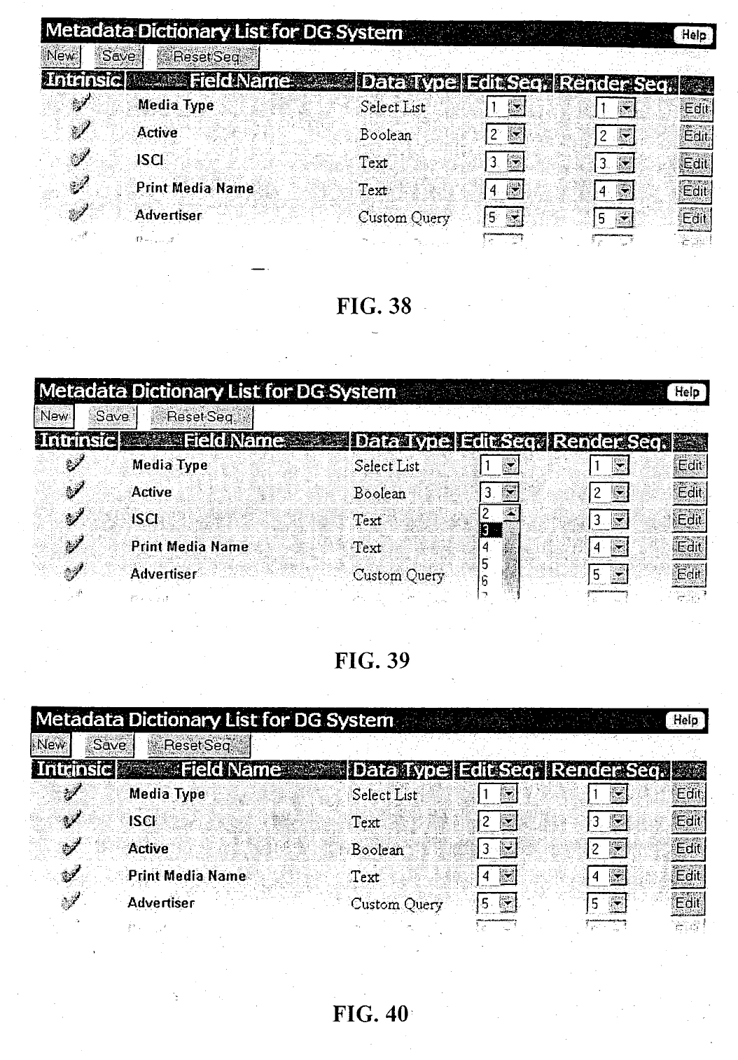

In the Edit Seq. columns, as shown in FIG. 38, you can determine the sequence in which the fields will be listed in the Metadata Dictionary List. Click on a field's position number and select a new position, as shown in FIG. 39. Click Save. This will exchange the field with the one previously in the selected position, as shown in FIG. 40.

Change the Rendering Sequence

As with the Edit Seq. column, in the Render Seq. columns, you can determine the sequence in which the fields will be listed in a media record. Click on a field's position number and select a new position. Click Save. This will exchange the field with the one previously in the selected position. If you have not clicked Save and want to undo a sequence change, click Reset Seq. This will restore the original sequence in both columns.

File Manager

Description

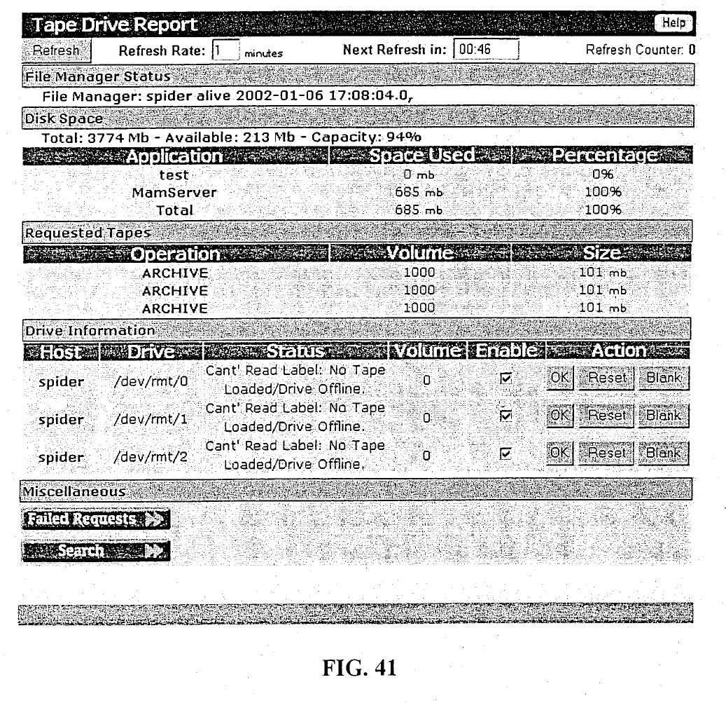

In the File Manager function, as shown in FIG. 41, a DG Administrator can use the File Manager application to review tape drive reports, failed requests and search for files. File Manager is divided into five sections:

1) File Manager Status—shows the current status of the AdCatalog server.

2) Disk Space—shows the total number of megabytes on the server, available number of megabytes and the capacity in percentage. Below this is a table that shows how the disk space is shared between File Manager applications; for each application using File Manager, the percentage of disk space used is displayed.

3) Requested Tapes—shows a list of media requested by File Manager, including the type of operation (Archive or Restore) for each media, the volume number and the expected megabytes. This list tells the DG Administrator what kind of tape he or she has to insert in a tape drive; if the operation is Archive, a blank tape is requested and a volume number is associated with it. The DG Administrator will have to then label the tape with the number provided by File Manager. If the operation is Restore, the DG Administrator will have to get the tape labeled with the associated number.

4) Drive information—shows a list of tape drives configured for File Manager. This is in fact all the filemanager.device.list found in the properties files on different hosts. The first column shows the host name where the device is connected, the second the device name, the third status messages from File Manager, the fourth the volume number recognized by File Manager. The next column is a check box that allows the DG Administrator to enable or disable the device. If the device is enabled, three buttons—OK, Reset, and Blank—are available to perform actions on the device. Note that when a device is disabled the three buttons are not available.

5) Miscellaneous—shows two buttons, Failed Requests and Search. Use the Failed Requests button to review failed retry requests and Search to search for files.

Step-by-Step

Tape Drive Reports

Any type of tapes (blank, archived or OLTP2) can be inserted in any device. When the OK button is clicked, the File Manager running on the appropriate host will identify the tape inserted, the status message will be “Checking Label . . . ” When finished, the column for volume number is updated with the label found on the tape.

If the tape is blank, File Manager will look for an Archive tape requested in the list of media. If no Archive tape is found, the message “Blank Tape” is displayed and no action will be performed. If an Archive tape exists, it is retrieved from the list and File Manager starts to write the volume on the tape “Archive Started . . . ” then “Starting Tape Validation . . . ” When finished, the tape is ejected and “Archive Tape #x Done” is displayed with x equal to the number of tapes already archived for this volume.

If the tape is not blank, File Manager will extract the label on the tape and try to find a Restore tape requested with the same volume number in the list of media. If no Restore tape is found the message “Wrong Tape” is displayed and the tape is ejected. If a Restore tape for the volume number is found, File Manager starts to extract the files from the tape “Restore Started . . . ” then “Checking Extracted Files . . . ” When finished, the tape is ejected and “Restore Done” is displayed.

If the tape is not blank, but the label extracted from the tape match the label normally written by the OLTP2 Media Manager, FM starts to extract all files found on the tape “Restore OLTP2 Tape #n . . . ” to a special directory configured in the properties file (filemanager.oltp2path). When finished, the tape is ejected and “OLTP2 Tape Restore Done” is displayed.

When the Reset button is clicked the corresponding device is reset and the message “N/A” is displayed. Note that if a tape is inserted, no action is performed.

As FM tries to recognize automatically the label on the tape, sometimes, it is useful to recycle tapes by erasing the label. When the BLANK button is clicked, the message “Formatting tape . . . ” is displayed and information on the tape inserted is destroyed. When finished, “Blank Tape Ready” is displayed.

Error Messages on Main screen

1) “Can't make blank tape: no tape loaded/drive offline”. Operations like rewind, forward, eject or opening the device can't be performed. Make sure the tape drive is on and connected to the host or that a tape is loaded.

2) “Can't make blank tape: tape write error”. The tape is certainly damaged and a new tape is required.

3) “Can't make blank tape: unexpected error”. FM has not been configured to handle this type of write error, please contact engineering.

4) “Can't create temp directory for blank tape validation”. FM has no permission for creating a temporary directory under the directory configured with filemanager.tmppath. Check for permissions.

5) “Can't validate blank tape: no tape loaded/drive offline”. The tape has been ejected or the tape drive disconnected or turned off during validation.

6) “Can't validate blank tape: Tape read error/checksum error”. After formatting FM is not able to read the tape. The tape is certainly damaged.

7) “Can't validate blank tape: destination file error”. After formatting FM is not able to write the format file under the temporary directory created before. Check for permissions, disk full . . .

8) “Can't validate blank tape: Unexpected error”. FM has not been configured to handle this type of read error, please contact engineering.

When checking for the label on a tape the following messages may be displayed:

1) “Can't create temp directory for label” FM has no permission for creating temporary directory under the directory configured with filemanager.tmppath. Check for permissions . . .

2) “Can't read label: no tape loaded/drive offline”. Operation like rewind, forward, eject, or opening the device cannot be performed. Make sure the tape drive is on and connected to the host or that a tape is loaded.

3) “Can't read label: tape read error/checksum error.” FM is not able to read the label on tape. The tape is certainly damaged.

4) “Can't read label: Label destination file error.” FM is not able to write label file under the temporary directory created before. Check for permissions, disk full . . .

5) “Can't read label: Unrecognized label.” FM does not recognize the label as a valid one. The corresponding volume in the database has been deleted.

6) “Can't read label: Unexpected error” FM has not been configured to handle this type of read error, please contact engineering.

When restoring an OLTP2 tape, the following messages may be displayed:

1) “Can't create OLTP2 target directory”. FM has no permission for creating the directory configured with filemanager.oltp2path. Check for permissions . . .

2) “Can't read OLTP2 tape: no tape loaded/drive offline”. Operation like rewind, forward, eject, or opening the device cannot be performed. Make sure the tape drive is on and connected to the host or that a tape is loaded.

3) “Can't read OLTP2 tape: tape read error/checksum error.” FM is not able to read the OLTP2 tape. The tape is certainly damaged.

4) “Can't read OLTP2 tape: destination file error.” FM is not able to write label file under the OLTP2 directory created before. Check for permissions, disk full . . .

5) “Can't read OLTP2 tape: Unexpected error” FM has not been configured to handle this type of read error, please contact engineering.

When restoring an FM tape the following messages may be displayed:

1) “Can't create Restore directory”. FM has no permission for creating the directory configured with filemanager.restorepath. Check for permissions . . .

2) “Can't Extract file field: no tape loaded/drive offline”. Operation like rewind, forward, eject, or opening the device cannot be performed. Make sure the tape drive is on and connected to the host or that a tape is loaded.

3) “Can't Extract file field: tape read error/checksum error.” FM is not able to read the tape. The tape is certainly damaged.

4) “Can't Extract file field: destination file error.” FM is not able to write files under the restore directory created before. Check for permissions, disk full . . .

5) “Can't Extract file field: Unexpected error” FM has not been configured to handle this type of read error, please contact engineering.

6) “Can't Extract file field: File not found”. FM can't find the requested file on the tape. The database is corrupted or the file has been archived on the wrong tape, need investigation, please contact engineering.

7) “Extracted file field: Not found”. FM cannot find the file that it just extracted on the file system. Please retry.

8) “Extracted file field: Bad Size”. The size of the file extracted does not match the size stored in the database. Please retry.

9) “Extracted file field: Bad CRC”. The CRC of the file extracted does not match the CRC stored in the database. Please retry.

Restoring a tape is limited to a number of retry configured in the properties file (filemanager.maxretries). Only errors #7, #8, #9 above count against the number of retry.

If the maximum retries is reached, the error messages above will be embedded in the message “Restore failed—error message—Aborted, Max Retries=max” and the user using the “Failed Requests Screen” must acknowledge error(s). If the maximum number of retry is not reached, then “Restore failed—error message—Retry #n/max” will be displayed and retry is allowed.

When archiving a tape, the following messages may be displayed:

1) “Can't write archive label: No tape loaded/drive offline”. Operation like rewind, forward, eject, or opening the device cannot be performed. Make sure the tape drive is on and connected to the host or that a tape is loaded.

2) “Can't write archive label: tape write error”. The tape is certainly damaged and a new tape is required.

3) “Can't write archive label: unexpected error” FM has not been configured to handle this type of write error, please contact engineering.

4) “Can't archive file field: no tape loaded/drive offline”. The tape has been ejected or the tape drive disconnected or turned off during archiving.

5) “Can't Archive file field: tape write error”. The tape is certainly damaged and a new tape is required.

6) “Can't archive file field: source file error”. FM is not able to access the file to archive under the directory configured with filemanager.rootpath. Check for permissions . . .

7) “Can't archive file field: unexpected error”. FM has not been configured to handle this type of write error, please contact engineering.

8) “Can't create temp directory for tape validation”. FM has no permission for creating a temporary directory under the directory configured with filemanager.tmppath. Check for permissions . . .

9) “Can't validate tape: no tape loaded/drive offline”. The tape has been ejected or the tape drive disconnected or turned off during validation.

10) “Can't validate tape: tape read error/checksum error”. After archiving FM is not able to read the tape. The tape is certainly damaged.

11) “Can't validate tape: destination file error”. After archiving FM is not able to write files under the temporary directory created before. Check for permissions, disk full . . .

12) “Can't validate tape: unexpected error”. FM has not been configured to handle this type of read error. Please contact engineering.

13) “Archived file fileID: Not found”. FM cannot find the file that it just extracted for validation. Please retry.

14) “Archived file fileID: bad size”. The size of the file archived does not match the size stored in the database. Please retry.

15) “Archived file fileID: Bad CRC”. The CRC of the file archived does not match the CRC stored in the database. Please retry.

Archiving a tape is limited to a number of retry configured in the properties file (filemanager.maxretries). Only errors #13, #14, #15 above countagainst the number of retry.

If the maximum retries is reached, the error messages above will be embedded in the message “Restore failed—error message—Aborted, Max Retries=max” and the user using the “Failed Requests Screen” must acknowledge error(s). If the maximum number of retry is not reached, then “Restore failed—error message—Retry #n/max” will be displayed and retry is allowed.

Failed Requests

When the maximum number of retries is reached during archive or restore, the corresponding requests are put in the “Failed Requests” page.

Failed requests are listed in the following table:

1) Request ID—the request ID number

2) Request Operation—the requested operation.

3) File ID—the file ID number.

4) Error Message—an explanation of the failure:

a) “Bad request: the file is too large to be archived”. FM cannot archive the file on a tape because its size is greater than the maximum size for a volume configured in the properties file (filemanager.maxspace).

b) “Bad request: illegal file state”. FM cannot archive or restore the file because the file state does not match the operation requested.

c) “Bad request: illegal volume state (xxxx not archived)”. FM cannot restore the file because the file is not yet archived.

d) “Can't find extracted file from tape xxxx”. FM cannot find the file that it just extracted on the File System.

e) “Bad size, file extracted from tape xxxx”. The size of the file extracted does not match the size stored in the database.

f) “Bad CRC, file extracted from tape xxxx” The CRC of the file extracted does not match the CRC stored in the database.

g) “Can't find archived file on tape xxxx” FM cannot find the file that it just extracted for validation.

h) “Bad size, archived file on tape xxxx”. The size of the file archived does not match the sized stored in the database.

i) “Bad CRC, archived file on tape xxxx” The CRC of the file archived does not match the CRC stored in the database.

5) Application Name—the name of the application.

6) Creation date—

7) Finish date—the date the attempt was halted.

If the error can be solved, the user may try to fix the file involved and retry by checking the retry box corresponding to the request on the left side of the screen. Note that retrying an archive request makes sense only if all the failed requests concerning this volume have been marked as retry.

If the problem can't be solved, the failed request may simply be canceled by checking the cancel box corresponding to the request on the left side of the screen. Canceling an archive request removes from the volume the associated file id, so canceling all the requests for a volume can yield a volume of 0 size.

Search

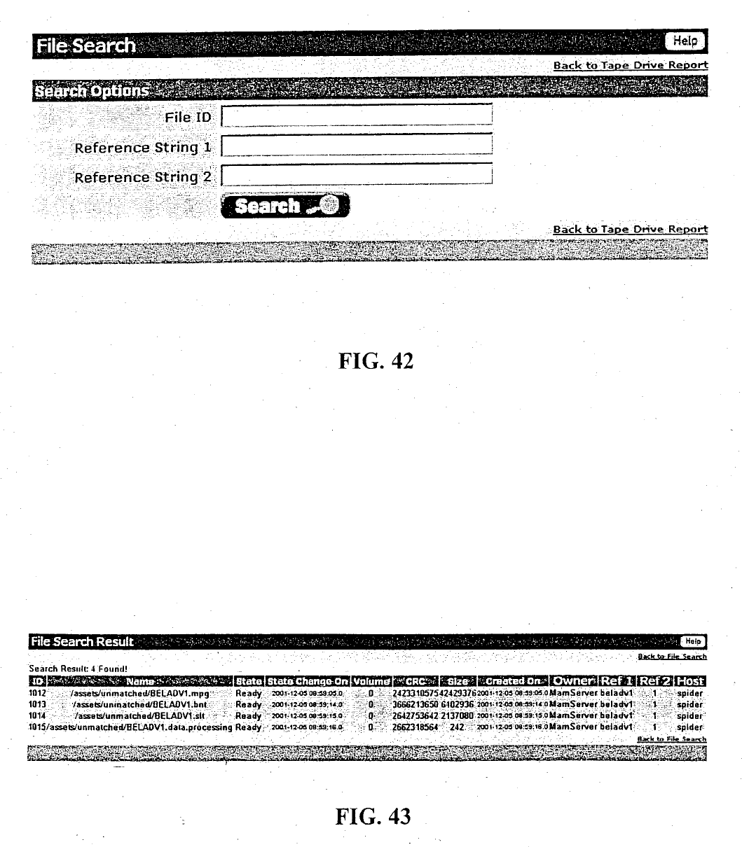

In the Search page, you can search for spot files in AdCatalog. Click on Search to open the File Search page, as shown in FIG. 42. If you do not want to conduct a search, click Back to Tape Drive Report to return to the Tape Drive Report.

You can search on FileID, Reference String 1, Reference String 2 or a combination of all the fields. Enter the parameters you want to search for, and click Search. The results will be shown in the File Search Results page, as shown in FIG. 43.

The results are presented in the following table:

1) ID—the MAM ID number of the file.

2) Name—the name of the file.

3) State—the state of the file.

4) State change on—the date and time of the last state change.

5) Volume-

6) CRC-

7) Size—the size of the file in bytes.

8) Created on—the date and time on which the file was created.

9) Owner—the owner of the file.

10) Ref 1—the Reference 1 search string.

11) Ref 2—the Reference 2 search string.

12) Host—the host server where the file was located.

To return to the File Search page, click Return to File Search.

About

The About function shows version information for AdCatalog.

Admin

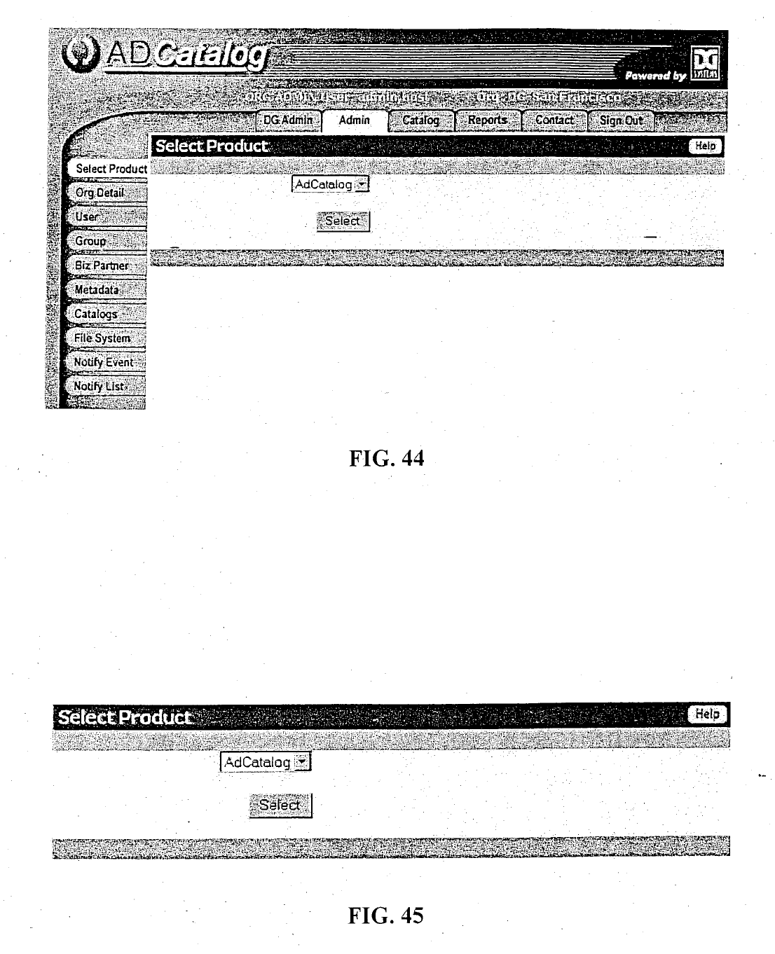

The Admin tab, as shown in FIG. 44, is where administrators can:

1) Choose a tool to work with (AdCatalog or NetClear).

2) Review and edit organizational information.

3) Add users and edit user data.

4) Create user groups, and assign users to security, user and catalog groups.

5) Request business partners for an organization, request organizational administrative capabilities for a business partner, and add or edit brands associated with an advertiser.

6) Add, edit or disable spot metadata in the organization's metadata dictionary list.

7) Create new catalog and catalog directories, and assign catalog administrators.

8) Monitor, upload or delete files in the organization's file system structure (including the organization's corporate page and logo on the Catalogs navigation screen).

9) Create notification events (i.e. when spots are added to a specific catalog.)

10) Create notification email lists.

Select Product

Description

In the Select Product function, as shown in FIG. 45, you can switch back and forth between AdCatalog and NetClear.

Step-by-Step

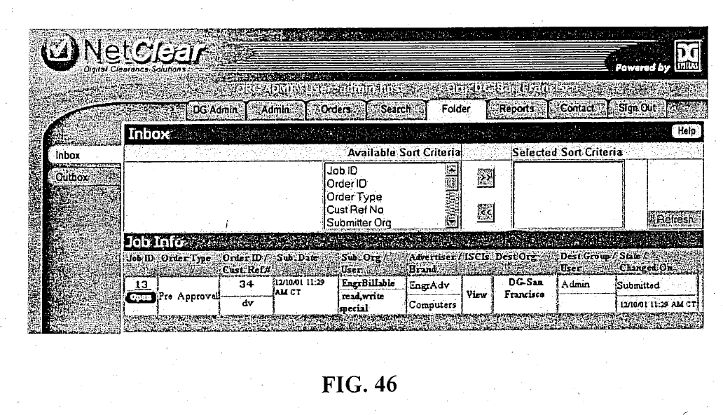

In the drop-down box, choose NetClear and click Select. You will be transferred to your organization's Inbox in NetClear, as shown in FIG. 46. To return to AdCatalog, click on the Admin tab, then on Select Product. Choose AdCatalog in the dropdown box, then click Select. You will be returned to your organization's Catalog page in AdCatalog.

Org Detail

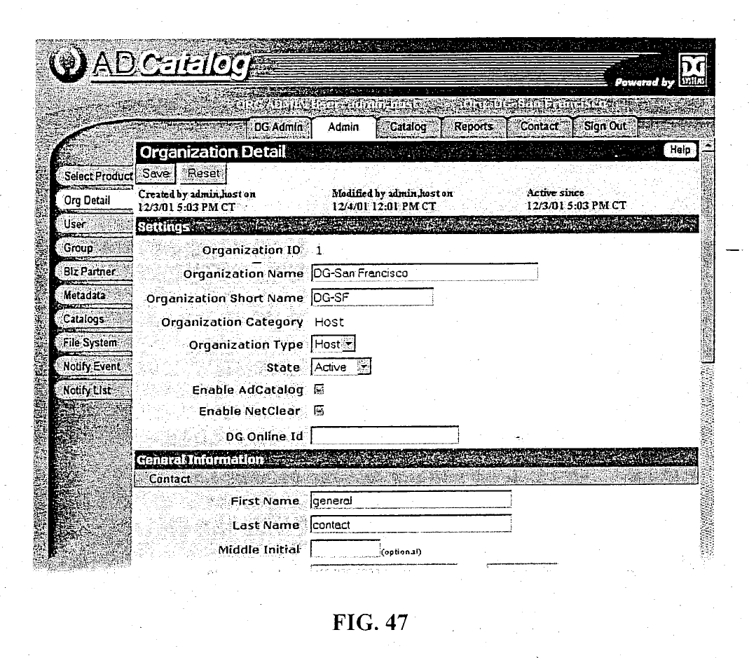

In the Organization Detail function, as shown in FIG. 47, you can view and/or modify settings and contact information about your organization.

(DG Administrator)

Description

The Org Detail page consist of three main sections—Settings, General Information and Shipping Information.

1) In Settings, you can view and modify basic information about the organization.

The fields in this section will depend on the organization's category—Host, Billable or Simple.

2) In General Information, you can view and modify contact and address information for the organization's main contact person (usually an Organization Administrator.)

3) In Shipping Information, you can view and modify contact and address information for a person at the organization who will receive shipped material.

(A simple organization does not receive spots or other material, so the Shipping Information section will not exist for a Simple organization).

Step-by-Step

Settings—Billable Organization

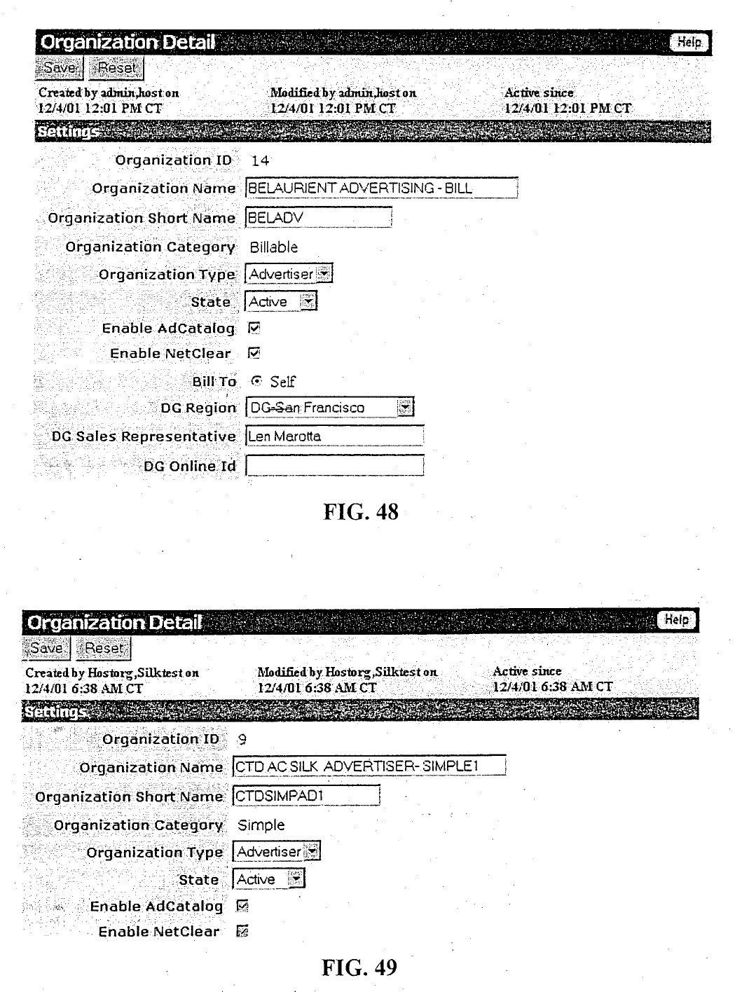

The Settings section contains basic data about the Billable organization (name, type, tools to be used, etc.) Active fields and drop-down boxes contain information that can be modified, as shown in FIG. 48.

1) Organization ID—the MAM Organization ID number.

2) Organization Name—the name of the organization.

3) Organization short name—an abbreviated name for the organization.

4) Organization category—billable.

5) Organization Type—

a. Agency—and advertising agency

b. Advertiser—an advertiser

c. Law Firm—a law firm or legal entity

6) State—select Active if the organization is using AdCatalog, or Inactive if the organization is not currently using AdCatalog.

7) Enable AdCatalog—check this box to enable the organization to use AdCatalog.

8) Enable NetClear—check this box to enable the organization to use NetClear.

9) Bill to—Self is active when the organization should be billed by DG Systems for account activity (spot posting, spot encoding, storage, etc.).

10) DG Region—DG Region (Chicago, Los Angeles, New York, San Francisco) that will provide administrative assistance to the organization. It is very important to select the correct DG region for your organization.

11) DG Sales Representative—the DG Sales Representative working with the organization.

12) DG Online ID—if available, the DG Online ID of the organization. This will let AdCatalog identify the correct owner organization when transferring spots to DG Online. If you do not fill in this field, the transfer feature will not work.

Settings—Simple Organization

The Settings section contains basic data about the Simple organization (name, type tools to be used, etc.) Active fields and drop-down boxes contain information that can be modified, as shown in FIG. 49.

1) Organization ID—the MAM Organization ID number.

2) Organization Name—the name of the organization.

3) Organization short name—an abbreviated name for the organization.

4) Organization category—simple.

5) Organization Type—select an organization type:

i. Advertiser—an advertiser

ii. Studio—a studio or other producer of spots

6) State—select Active if the organization is using AdCatalog, or Inactive if the organization is not currently using AdCatalog.

7) Enable AdCatalog—default checked

8) Enable NetClear—default checked.

General Information—Host, Billable and Simple Organizations

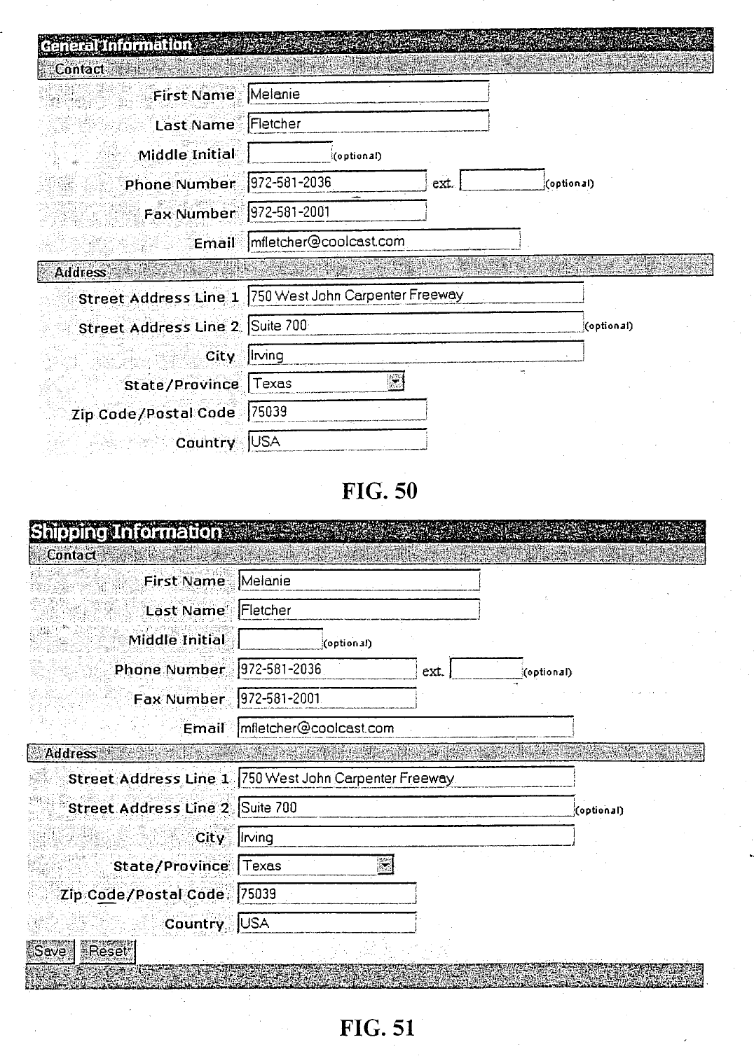

The General Information section contains personal and address information for a contact person in a Host, Billable or Simple Organization (usually an Organization Administrator), as shown in FIG. 50.

1) First Name—the first name of the organization contact.

2) Last Name—the last name of the organization contact.

3) Middle Initial (optional)—the middle initial of the organization contact.

4) Phone number—the organization contact's phone number (and extension, if applicable).

5) Fax number—the organization contact's fax number.

6) Email—the organization contact's email address.

7) Street Address—the organization contact's street address.

8) City—the city where the organization contact works (e.g. San Francisco).

9) State/Province—the state or province in which the organization contact works (e.g. California, Alberta)

10) Zip Code/Postal Code—the organization contact's zip or postal code.

11) Country—the country in which the organization contact works.

Shipping information—Host and Billable Organizations

The Shipping Information section contains contact and address information for a person at a Host or Billable Organization who will receive shipped material, as shown in FIG. 51.

1) First Name—the first name of the shipping contact.

2) Last Name—the last name of the shipping contact.

3) Middle Initial (optional)—the middle initial of the shipping contact.

4) Phone Number—the shipping contact's phone number.

5) Fax Number—the shipping contact's fax number.

6) Email—the shipping contact's email address.

7) Street Address—the shipping contact's street address. Use both lines if necessary.

8) City—the city where the shipping contact works (e.g. San Francisco).

9) State/Province—the state or province in which the shipping contact works (e.g. California, Alberta)

10) Zip Code/Postal Code—the shipping contact's zip or postal code.

11) Country—the country in which the shipping contact works.

Once you have made your changes, click Save. You will see a System Message with the text “Organization updated successfully”. Click OK to return to the Org Detail function. If you do not want to save your changes, click Reset. The original settings will be restored.

(Organization/Catalog Administrator)

Desciption

The Org Detail page consists of three main sections-Settings, General Information, and Shipping Information.

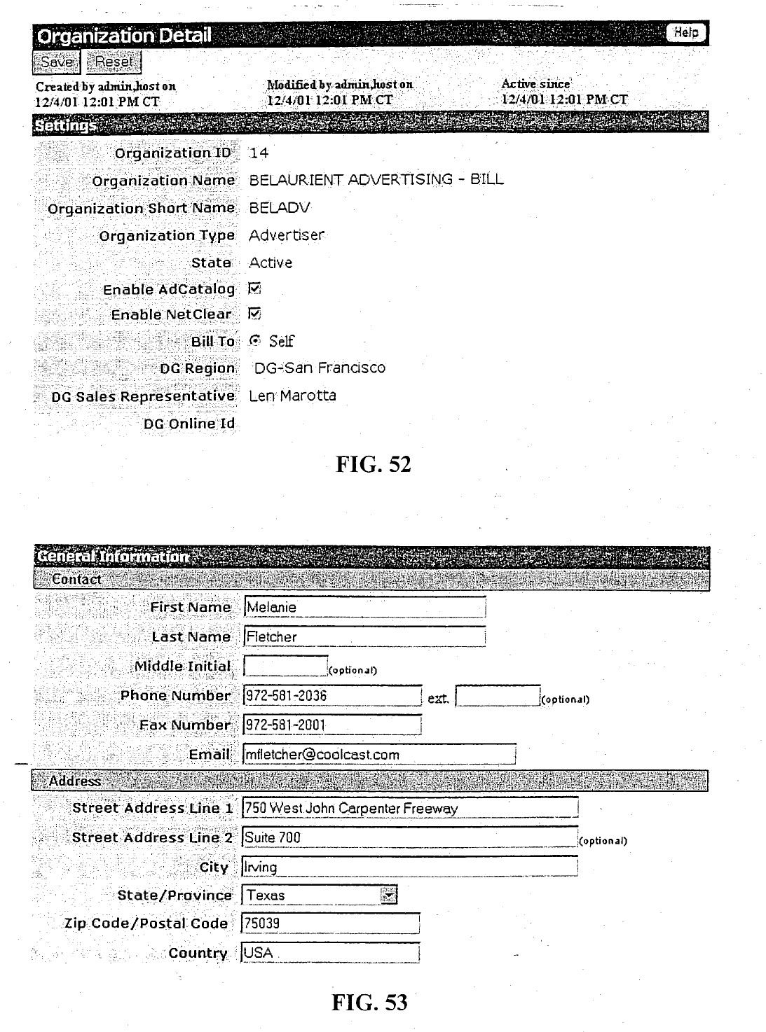

1) In Settings, you can view basic information about the organization and enable your organization to use AdCatalog and NetClear, as shown in FIG. 52.

2) In General Information, you can view and modify contact and address information for the organization's main contact person (usually an Organization Administrator), as shown in FIG. 53.

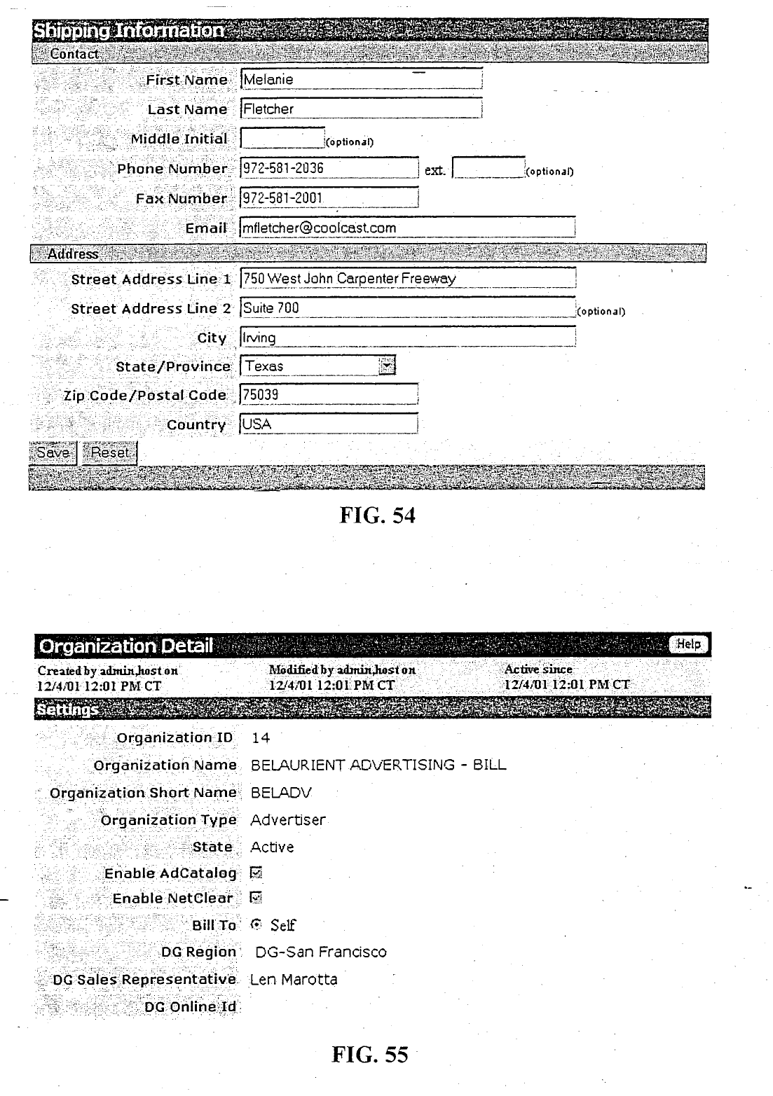

3) In Shipping Information, you can view and modify contact and address information for a person at the organization who will receive shipped material, as shown in FIG. 54.

Step-by-Step

Settings

The Settings section, as shown in FIG. 55, contains basic data about the Billable organization (name, type, tools to be used, etc.) Active fields and drop-down boxes contain information that can be modified.

1) Organization ID—the MAM Organization ID number.

2) Organization Name—the name of the organization.

3) Organization short name—an abbreviated name for the organization.

4) Organization category—billable.

5) Organization Type—

a. Agency—and advertising agency

b. Advertiser—an advertiser

c. Law Firm—a law firm or legal entity

6) State—select Active if the organization is using AdCatalog, or Inactive if the organization is not currently using AdCatalog.

7) Enable AdCatalog—check this box to enable the organization to use AdCatalog.

8) Enable NetClear—check this box to enable the organization to use NetClear.

9) Bill to—Self is active when the organization should be billed by DG Systems for account activity (spot posting, spot encoding, storage, etc.).

10) DG Region—DG Region (Chicago, Los Angeles, New York, San Francisco) that will provide administrative assistance to the organization.

11) DG Sales Representative—the DG Sales Representative working with the organization.

12) DG Online ID—if available, the DG Online ID of the organization. This will let AdCatalog identify the correct owner organization when transferring spots to DG Online.

General Information

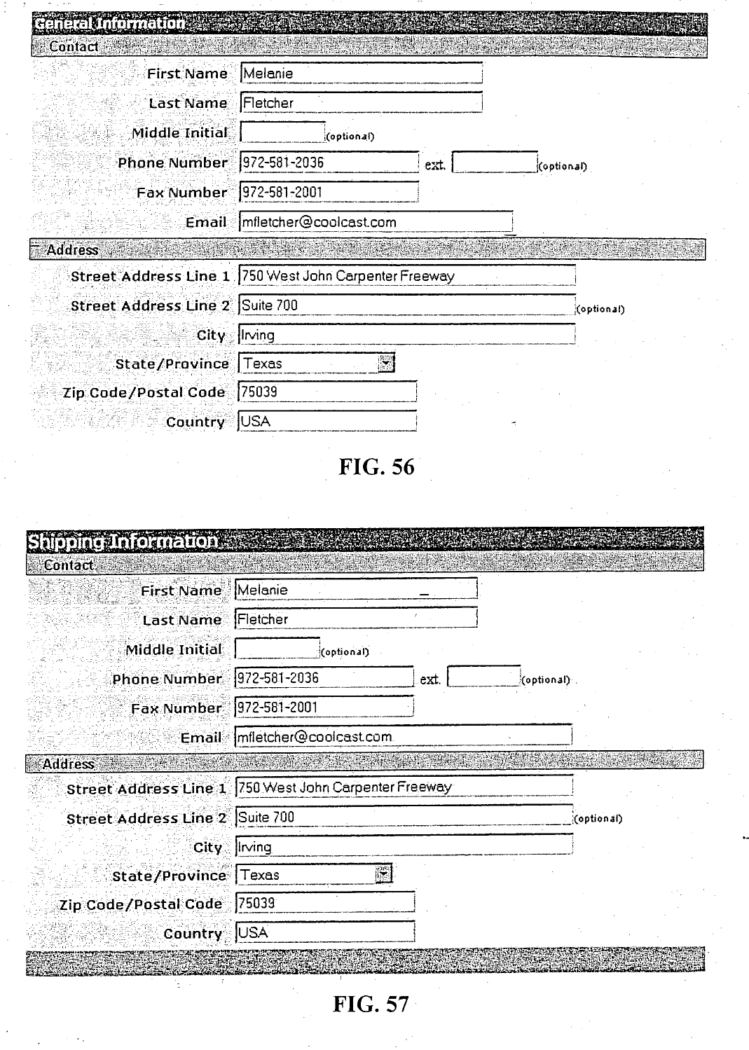

The General Information section, as shown in FIG. 56, contains personal and address information for a contact person in an organization (usually an Organization Administrator).

1) First Name—the first name of the organization contact.

2) Last Name—the last name of the organization contact.

3) Middle Initial (optional)—the middle initial of the organization contact.

4) Phone number—the organization contact's phone number (and extension, if applicable).

5) Fax number—the organization contact's fax number.

6) Email—the organization contact's email address.

7) Street Address—the organization contact's street address.

8) City—the city where the organization contact works (e.g. San Francisco).

9) State/Province—the state or province in which the organization contact works (e.g. California, Alberta)

10) Zip Code/Postal Code—the organization contact's zip or postal code.

11) Country—the country in which the organization contact works.

Shipping Information

The Shipping Information section, as shown in FIG. 57, contains contact and address information for a person at a Host or Billable Organization who will receive shipped material.

1) First Name—the first name of the shipping contact.

2) Last Name—the last name of the shipping contact.

3) Middle Initial (optional)—the middle initial of the shipping contact.

4) Phone Number—the shipping contact's phone number.

5) Fax Number—the shipping contact's fax number.

6) Email—the shipping contact's email address.

7) Street Address—the shipping contact's street address. Use both lines if necessary.

8) City—the city where the shipping contact works (e.g. San Francisco).

9) State/Province—the state or province in which the shipping contact works (e.g. California, Alberta)

10) Zip Code/Postal Code—the shipping contact's zip or postal code.

11) Country—the country in which the shipping contact works.

Once you have made your changes, click Save. You will see a System Message with the text “Organization updated successfully”. Click OK to return to the Org Detail function. If you do not want to save your changes, click Reset. The original settings will be restored.

(Read-Write/Read-Only User)

Desciption

The Org Detail page consists of three main sections—Settings, General Information, and Shipping Information.

1) In Settings, you can view basic information about the organization and enable your organization to use AdCatalog and NetClear.

2) In General Information, you can view contact and address information for the organization's main contact person (usually an Organization Administrator.)

3) In Shipping Information, you can view contact and address information for a person at the organization who will receive shipped material.

Step-by-Step

Settings

The Settings section contains basic data about the Billable organization (name, type, tools to be used, etc.)

1) Organization ID—the MAM Organization ID number.

2) Organization Name—the name of the organization.

3) Organization short name—an abbreviated name for the organization.

4) Organization category—billable.

5) Organization Type—

i. Agency—and advertising agency

ii. Advertiser—an advertiser

iii. Law Firm—a law firm or legal entity

6) State—Active if the organization is using AdCatalog, or Inactive if the organization is not currently using AdCatalog.

7) Enable AdCatalog—default checked.

8) Enable NetClear—efault checked.

9) Bill to—Self is active when the organization should be billed by DG Systems for account activity (spot posting, spot encoding, storage, etc.).

10) DG Region—DG Region (Chicago, Los Angeles, New York, San Francisco) that will provide administrative assistance to the organization.

11) DG Sales Representative—the DG Sales Representative working with the organization.

12) DG Online ID—if available, the DG Online ID of the organization. This will let AdCatalog identify the correct owner organization when transferring spots to DG Online.

General Information

The General Information section contains personal and address information for a contact person in an organization (usually an Organization Administrator).

1) First Name—the first name of the organization contact.

2) Last Name—the last name of the organization contact.

3) Middle Initial (optional)—the middle initial of the organization contact.

4) Phone number—the organization contact's phone number (and extension, if applicable).

5) Fax number—the organization contact's fax number.

6) Email—the organization contact's email address.

7) Street Address—the organization contact's street address.

8) City—the city where the organization contact works (e.g. San Francisco).

9) State/Province—the state or province in which the organization contact works (e.g. California, Alberta)

10) Zip Code/Postal Code—the organization contact's zip or postal code.

11) Country—the country in which the organization contact works.

Shipping information

The Shipping Information section contains contact and address information for a person at a Host or Billable.Organization who will receive shipped material.

1) First Name—the first name of the shipping contact.

2) Last Name—the last name of the shipping contact.

3) Middle Initial (optional)—the middle initial of the shipping contact.

4) Phone Number—the shipping contact's phone number.

5) Fax Number—the shipping contact's fax number.

6) Email—the shipping contact's email address.

7) Street Address—the shipping contact's street address. Use both lines if necessary.

8) City—the city where the shipping contact works (e.g. San Francisco).

9) State/Province—the state or province in which the shipping contact works (e.g. California, Alberta)

10) Zip Code/Postal Code—the shipping contact's zip or postal code.

11) Country—the country in which the shipping contact works.

### User

(DG/Organization/Catalog Administrator/Read-write User)

Desciption

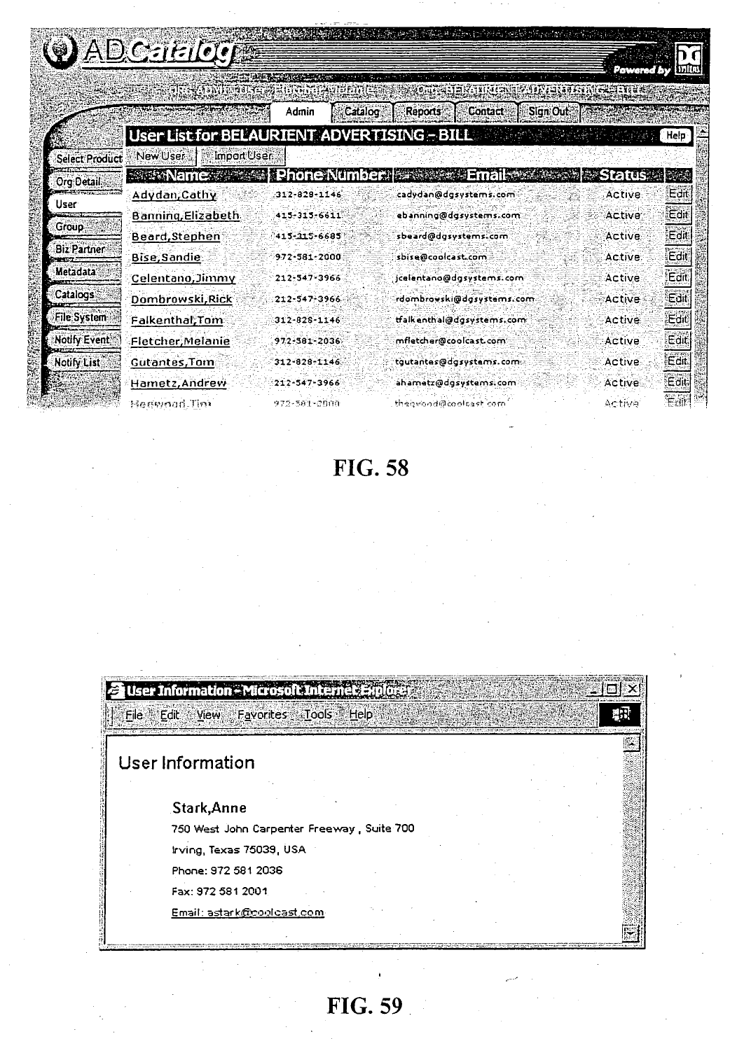

In the User function, as shown in FIG. 58, the user can view, add, import, and edit users in your organization. You can also check a user's assigned Organization and Catalog groups and their status in each group. User information is show in the following table:

1) Name—name of the user.

2) Phone number—phone number of the user.

3) Email—email address of the user.

4) Status—status of the user in the organization.

At the end of each row is a button marked Edit—click this to edit a user's information.

Step-by-Step

To view basic information on a user (name, address, phone, fax, email) click on their name. This will open a pop-up window called User Information, as shown in FIG. 59. Click on the email link to send email to the user. To add or edit user information, click Edit in the user's row. This will open the User page, as shown in FIG. 60.

The User page contains personal, password and group membership for a user, as well as a toggle for making a user inactive within an organization. Click a field to add or modify its information.

1) Active—check this to make the user active within the organization (default is checked).

2) First name—the first name of the user.

3) Last name—the last name of the user.

4) Middle Initial (optional)—the middle initial of the user.

5) Phone Number—the user's phone number (and extension, if possible)

6) Fax Number (optional)—the user's fax number.

7) Email—the user's email address.

8) Turn off Email Notification—if the user does not want to receive email notification of events associated with AdCatalog functions, check this box.

9) User.ID—the user's user ID.

10) Password—the user's password (length is 8 to 30 characters)

11) Re-type password—re-enter the password to confirm it.

12) Work Hours (optional)—the user's standard work hours (e.g. 8:00 am. to 5 p.m.) This can be used as a way of determining when the user will be in the office and available.

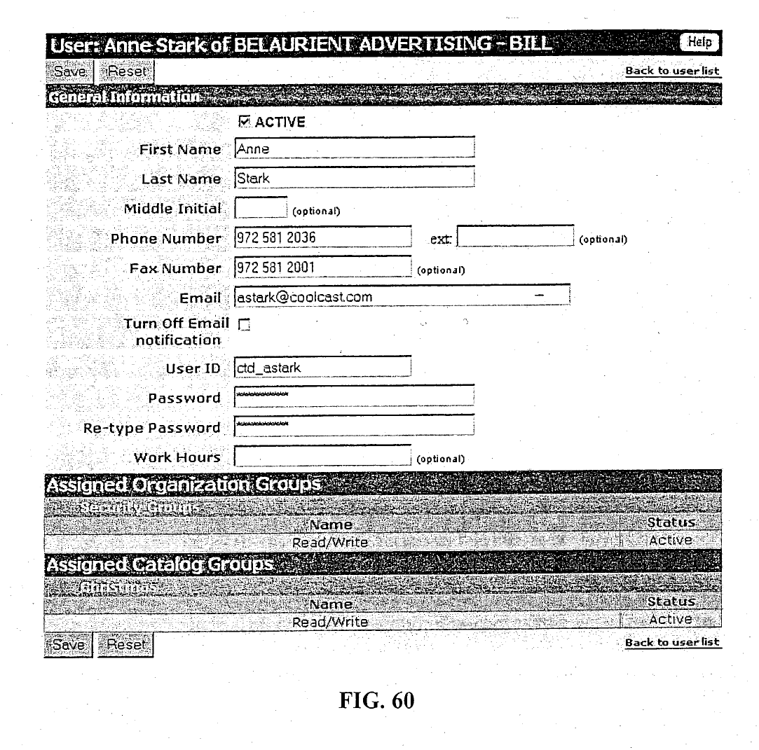

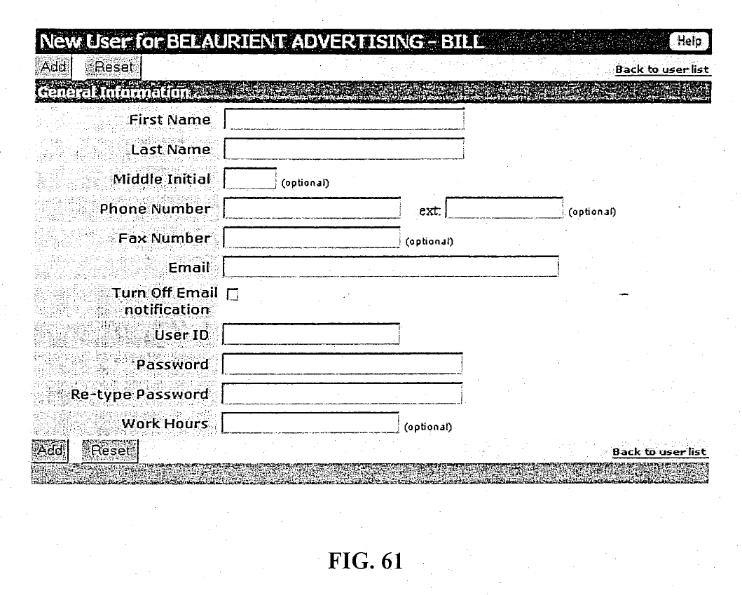

At the bottom of the page are tables that list the user's Assigned Organization and catalog groups. Organization groups include Security and User Groups, while Catalog groups include all the catalogs the user can currently access. The Name field indicates the user's security level (Admin, Read/Write or Read only) in each group and the Status field indicates the user's status in each group (Active or Inactive). To save changes, click Save. To reset the original settings without saving them, click Reset. To return to the User List, click Back to User List. To add a new user to an organization, click New User. This will open the New User page, as shown in FIG. 61.

The New User page is where you can enter personal, password and group membership for a new user.

1) First name—the first name of the user.

2) Last name—the last name of the user.

3) Middle Initial (optional)—the middle initial of the user.

4) Phone Number—the user's phone number (and extension, if possible)

5) Fax Number (optional)—the user's fax number.

6) Email—the user's email address.

7) Turn off Email Notification—if the user does not want to receive email notification of events associated with AdCatalog functions, check this box.

8) User ID—the user's user ID.

9) Password—the user's password (length is 8 to 30 characters)

10) Re—type password—re-enter the password to confirm it.

11) Work Hours (optional)—the user's standard work hours (e.g. 8:00 am. to 5 p.m.) This can be used as a way of determining when the user will be in the office and available

Click “Add” to add the user to the organization. If you want to clear the fields without adding the user, click Reset.

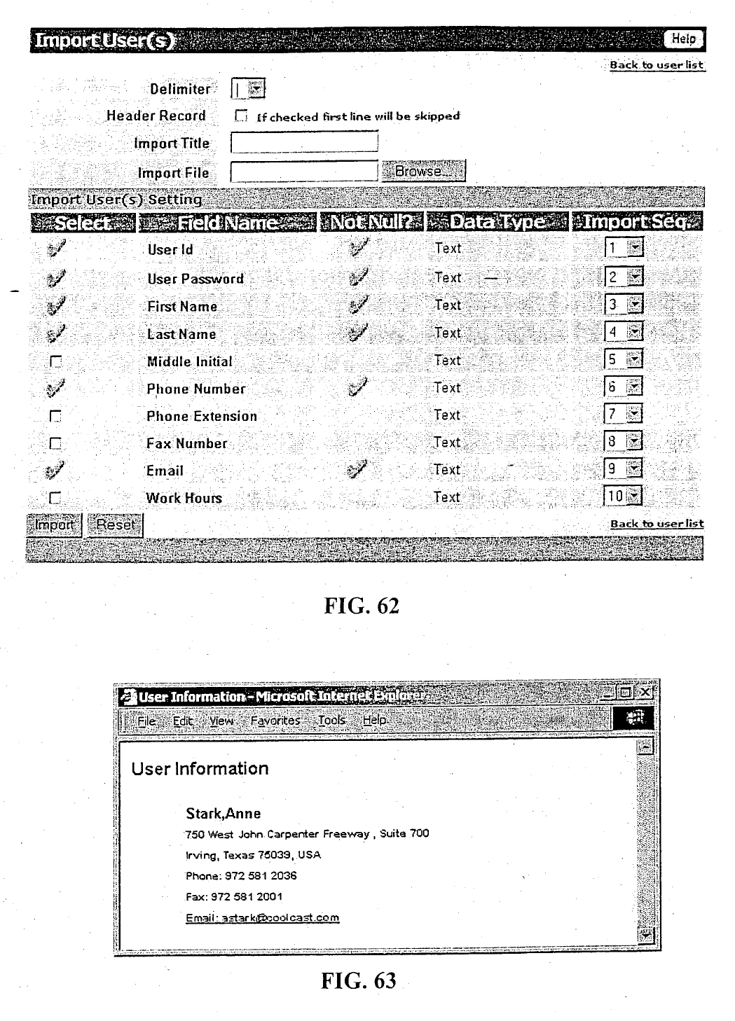

In order to be able to use AdCatalog, a new user will need to be added to the organization's Security and Catalog groups. It is also possible to add a new user by importing the file of an existing user. To do this, click Import user. This will open the Import User(s) page, as shown in FIG. 62.

1) Delimiter—choose the delimiter used to separate fields in your user file: |, # or ˜.2)

2) Header Record—check this if the first line in your file is a head or file name. AdCatalog will then skip it.

3) Import Title—enter the title of the imported user file.

4) Import File—enter the location of the imported user file, or click Browse to locate the import file on your system. The file should be a plain text file (suffix .txt).

In the Import User(s) Setting table, you can choose which optional fields will be included in the imported user file and the sequence of the fields.

1) Select—a green checkmark means that the field is mandatory and will be included in the new user record. Check the box of an optional field (Middle Initial, Phone Extension, Fax Number, Work Hours) to indicate that this information is included in the imported user file and should be added to the new user record.

2) Field Name—the name of the fields in a user record.

3) Not Null—a green checkmark means the field contains data and must be included in the new user record.

4) Data type—text.

5) Import Seq.—Use this column to match the expected AdCatalog fields to the sequence of fields as listed in the imported user file.

Click Import to import the user file. AdCatalog will process the file and add the new user to the User list within a half hour. You can also track the progress of this processing iin the Reports>User Imports tab. Click Reset to clear the fields and reset the Import Sequence to the default setting.

(Read-Only User)

Description

In the User function, you can view user information for users in your organization and edit your own information. You can also view a user's assigned Organization and Catalog groups, as well as their status in each group.

User information is shown in the following table:

1) Name—the user's name

2) Phone Number—the user's phone number.

3) Email—email address of the user.

4) Status—status of the user in the organization.

At the end of each row is a button marked View—click this to view a user's information.

At the end of your row is a button marked Edit—click this to edit your user information.

Step-by-Step

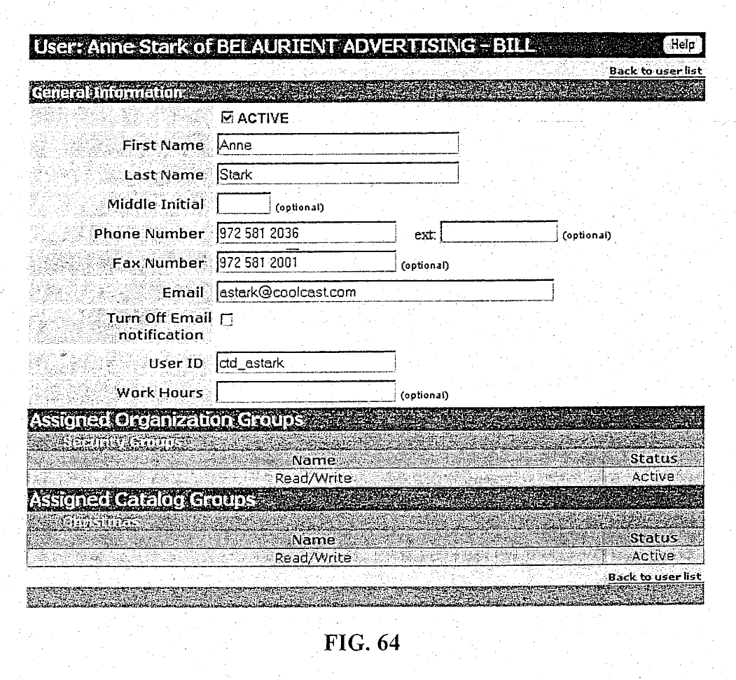

To view basic information on a user (name, address, phone, fax and email), click on their name. This will open a pop-up window called User Information, as shown in FIG. 63. Click on the email link to send email to the user. To view a user's information, click View. This will open the User page, as shown in FIG. 64 The User page contains personal, password and group membership for a user.

1) Active—check this to make the user active within the organization (default is checked).

2) First name—the first name of the user.

3) Last name—the last name of the user.

4) Middle Initial (optional)—the middle initial of the user.

5) Phone Number—the user's phone number (and extension, if possible)

6) Fax Number (optional)—the user's fax number.

7) Email—the user's email address.

8) Turn off Email Notification—if the user does not want to receive email notification of events associated with AdCatalog functions, check this box.

9) User ID—the user's user ID.

10) Work Hours (optional)—the user's standard work hours (e.g. 8:00 am. to 5 p.m.) This can be used as a way of determining when the user will be in the office and available.

At the bottom of the page are tables that list the user's Assigned Organization and catalog groups. Organization groups include Security and User Groups, while Catalog groups include all the catalogs the user can currently access. The Name field indicates the user's security level (Admin, Read/Write or Read only) in each group and the Status field indicates the user's status in each group (Active or Inactive).

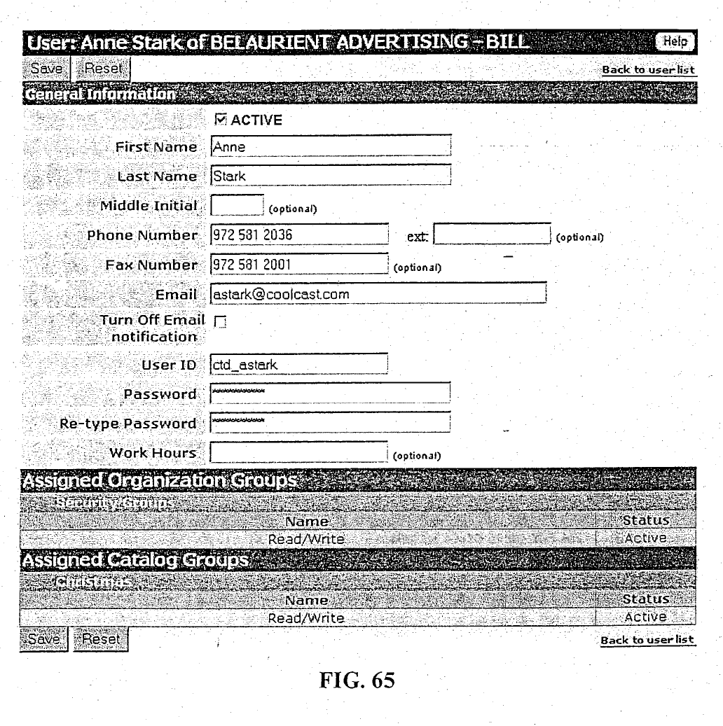

To edit your user information, click Edit in your row. This will open your User page, as shown in FIG. 65. The User page contains your personal, password, and group membership information, as well as a toggle for making you inactive within an organization. Click a field to add or modify its information.

1) Active—check this to make yourself active within the organization (default is checked).

2) First name—your first name.

3) Last name—your last name

4) Middle Initial (optional)—your middle initial.

5) Phone Number—your phone number (and extension, if possible)

6) Fax Number (optional)—your fax number.

7) Email—your email address.

8) Turn off Email Notification—if you do not want to receive email notification of events associated with AdCatalog functions, check this box.

9) User ID—your user ID.

10) Password—your password (length is 8 to 30 characters)

11) Re-type password—re-enter the password to confirm it.

12) Work Hours (optional)—your standard work hours (e.g. 8:00 am. to 5 p.m.)

This can be used as a way of determining when you will be in the office and available.

At the bottom of the page are tables that list your Assigned Organization and catalog groups. Organization groups include Security and User Groups, while Catalog groups include all the catalogs the user can currently access. The Name field indicates your security level (Read only) in each group and the Status field indicates your status in each group (Active or Inactive). To save changes, click Save. To reset the original settings without saving them, click Reset. To return to the User list, click Back to User List.

### Group

(DG Administrator)

Description

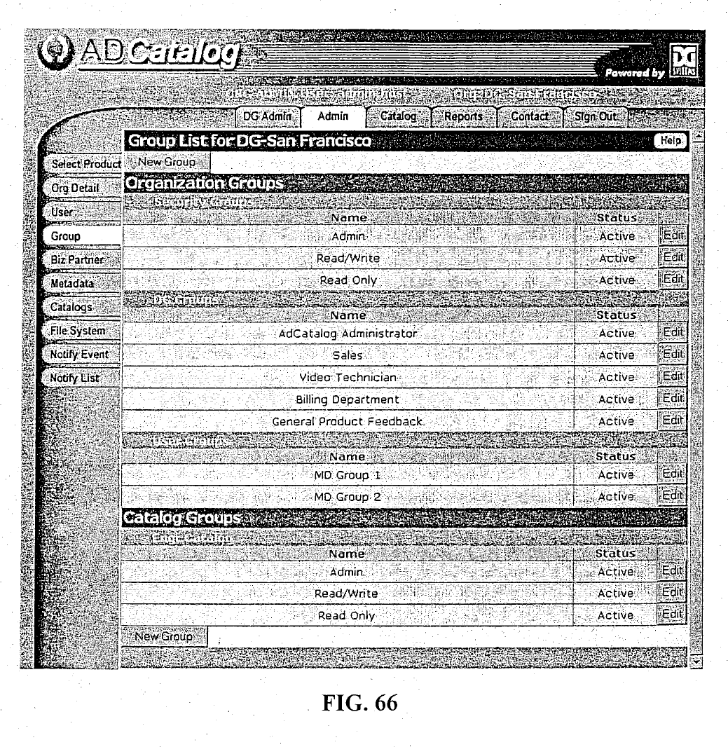

In the Group function, as shown in FIG. 66, you can assign users to various groups in an organization, as well as create user groups that can be used for notification lists and events.

The Group function is divided into two main sections, Organization Groups and Catalog Groups. An Organization Group is any group that has DG Systems-wide functions—this includes the Security Groups (where you can assign Admin, Read/Write or Read Only security levels to a user), the DG Groups (where you can assign users to five main positions in the DG Organization—AdCatalog Administrator, Sales, Video Technician, Billing Department and General Product Feedback), and, if applicable, User Groups (these contain users that will be on a specific notification list, and are created by clicking New Group at the top or bottom of the page).

The Catalog Groups include all catalogs in an organization. You can assign a user Admin, Read/Write or Read-Only security levels for each catalog group—this is useful in situations where different catalogs need to be administered by different people, but the catalogs are grouped in the same directory. Using the security function, you can give each catalog its own administrator.

Step-by-Step

Adding a User to a Security Group

The Security Groups is where you can assign AdCatalog-wide security privileges to a user. There are three Security Groups—Admin, Read/Write and Read-only.

1) Admin—adding a User to the Admin group gives them DG Administrator privileges throughout AdCatalog—they have complete administrative control in any organization and can add users, edit organization settings, etc.

2) Read/write—Adding a user to the read/write group gives them read/write user privileges throughout AdCatalog—they can work as a regular user in any organization.

3) Read Only—Adding a User to the Read-only group gives them Read Only user privileges throughout AdCatalog—they can view the catalogs in any organization.

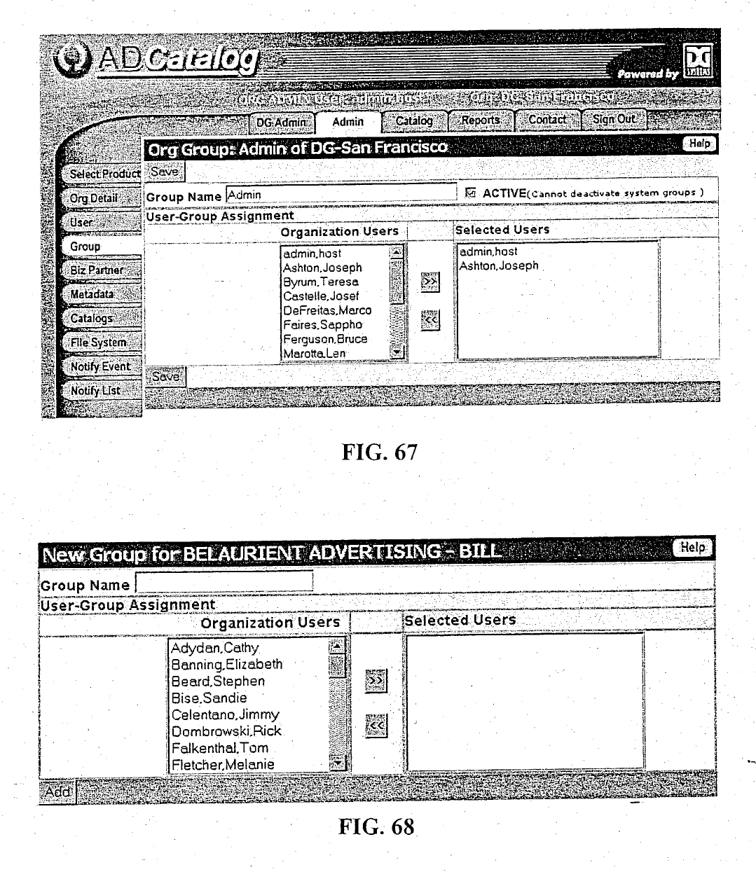

To add a user to a group, click Edit. This will open a page where you can add or remove users from a group, as shown in FIG. 67.

The Group Name lists the name of the group, and the ACTIVE checkbox shows whether or not the group is active within the organization (Security, DG and Catalog groups are default active).

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Adding a User to a DG Group

This is performed the same way as adding a user to a Security Group. The DG Groups is where you can assign users to the main positions in the DG Organization. These positions will be listed in the Contact tab.

There are five DG Groups—AdCatalog Administrator, Sales, Video Technician, Billing Department and General Product Feedback.

1) AdCatalog Administrator—these users are listed as the main AdCatalog administrators, and will handle the administrative duties for the application

2) Sales—this user is listed as the main Sales contact for AdCatalog, and will handle any sales questions.

3) Video Technician—this user is listed as the Video Technician contact for AdCatalog and will handle any video transfer or transcoding problems.

4) Billing Department—this user is listed as the main billing contact for AdCatalog and will handle any billing problems.

5) General Product Feedback—this user is listed as the main feedback contact for AdCatalog, and will handle all feedback on the tool.

To add a user to the group, click Edit. This will open a page where you can add or remove users from a group.

The Group Name lists the name of the group and the ACTIVE checkbox shows whether or not the group is active within the organization (Security, DG and Catalog groups are default active.)

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Adding a User to a User Group

This is performed the same way as adding a user to a Security group.

The User Groups are created by a DG or Organization Administrator, and contain selected users for Notify List functions (i.e., Admin-level users can be added to a User Group and that group will be notified when AdCatalog goes down for maintenance.)

To add a user to the group, click Edit. This will open a page where you can add or remove users from a group.

The Group Name lists the name of the group, and the ACTIVE checkbox shows whether or not the group is active within the organization. If a group needs to be made inactive (vacation, groups transition, etc.), click on the checkbox to remove the check.

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Adding a User to a Catalog Group

This is performed the same way as adding a user to a Security Group.

The Catalog Groups are automatically created when a catalog is created in the Catalog tab. Each catalog has the same security levels as the Security Groups:

1) Admin—an Admin user can create and edit directories and catalogs, the Corporate page, organizational and catalog-specific metadata, create/import/export media records, attach spots to records and transfer spots to DG Online.

2) Read/Write—a read/write user can create/import/export media records, attach spots to records and transfer spots to DG Online.

3) Read Only—a Read Only user can only view catalog data.

To add a user to a group, click Edit. This will open a page where you can add or remove users from a group.

The Group Name lists the name of the group, and the ACTIVE checkbox shows whether or not the group is active within the organization (Security, DG and Catalog groups are default active).

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Creating a New User Group

To create a new User Group for use with a Notification List, click New Group. This will open the New Group page, as shown in FIG. 68.

In the Group Name field, enter a name for the group (e.g. Admin List). To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Add to add the new group to the User Groups.

(Organization Administrator)

Description

In the Group function, you can assign users to various groups in an organization, as well as create user groups that can be used for notification lists and events.

The Group function is divided into two main sections, Organization Groups and Catalog Groups. An Organization group is any group that has DG Systems-wide functions—this includes the Security Groups (where you can assign Admin, Read/Write or Read Only security levels to a user) and if applicable, User Groups (these contain users that will be on a specific notification list, and are created by clicking New group at the top or bottom of the page.)

The Catalog Groups include all catalogs in an organization. You can assign a user Admin, Read/Write or Read-Only security levels for each catalog group—this is useful in situations where different catalogs need to be administered by different people, but the catalogs are grouped in the same directory. Using the security function, you can give each catalog its own administrator.

Step-by-Step

Adding a User to a Security Group

The Security Groups is where you can assign AdCatalog-wide security privileges to a user. There are three Security Groups—Admin, Read/Write and Read-Only.

1) Admin—adding a user to the Admin group gives them DG Administrator privileges throughout AdCatalog—they have complete administrative control in any organization and can add users, edit organization settings, etc.

2) Read/Write—Adding a user to the Read/Write group gives them Read/write user privileges throughout AdCatalog—they can work as a regular user in any organization.

3) Read Only—Adding a user to the Read-Only group gives them Read Only User privileges throughout AdCatalog—they can view the catalogs in any organization.

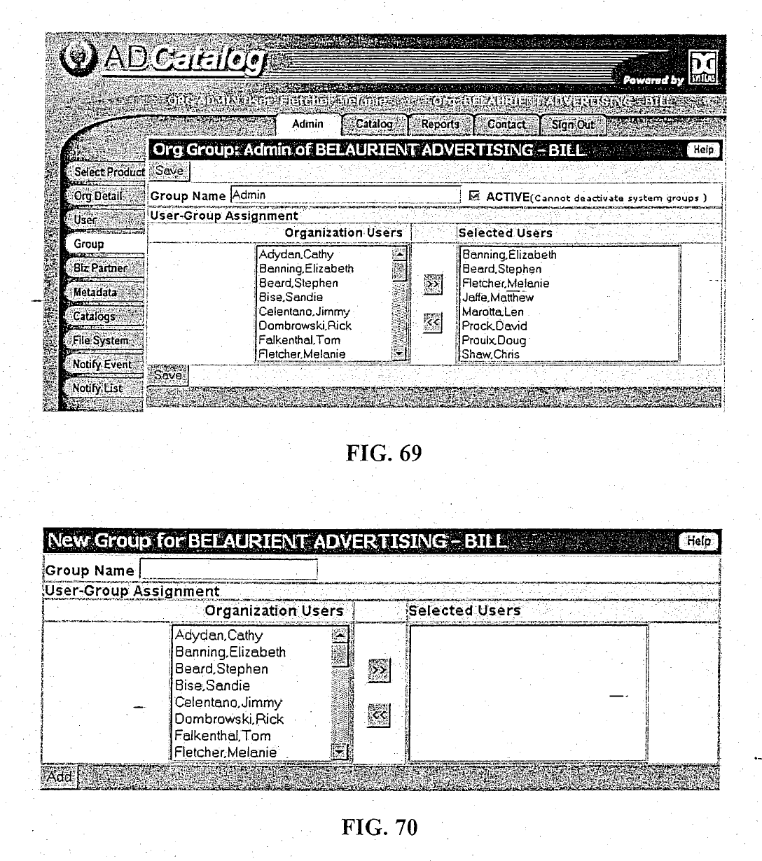

To add a user to a group, click Edit. This will open a page where you can add or remove users from a group, as shown in FIG. 69.

The Group Name lists the name of the group, and the ACTIVE checkbox shows whether or not the group is active within the organization (Security and Catalog groups are default active).

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Adding a User to a User Group

This performed the same way as adding a user to a Security Group.

The User Groups are created by a DG or Organization Administrator, and contain selected users for Notify List functions (i.e. Admin-level users can be added to a User Group, and that group will be notified when AdCatalog goes down for maintenance).

To add a user to a group, click Edit. This will open a page where you can add or remove users from a group.

The Group Name lists the name of the group, and the ACTIVE checkbox shows whether or not the group is active within the organization. If a group needs to be made inactive (vacation, groups transitions, etc.) click on the checkbox to remove the check.

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Adding a User to a Catalog Group

This is performed the same way as adding a user to a Security Group.

The Catalog Groups are automatically created when a catalog is created in the Catalog tab. Each catalog has the same security levels as the Security Groups:

1) Admin—an Admin user can create and edit directories and catalogs, the Corporate page, organizational and catalog-specific metadata, create/import/export media records, attach spots to records and transfer spots to DG Online.

2) Read/Write—a Read/Write user can create/import/export media records, attach spots to records and transfer spots to DG Online.

3) Read Only—a Read Only user can only view catalog data.

To add a user to a group, click Edit. This will open a page where you can add or remove users from a group.

The Group Name lists the name of the group, and the ACTIVE checkbox shows whether or not the group is active within the organization (Security and Catalog groups are default active.)

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

Creating a New User Group

To create a new User Group for use with a Notification List, click New Group. This will open the New Group page, as shown in FIG. 70.

In the Group Name field, enter a name for the group (e.g. Admin List). To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Add to add the new group to the User Groups.

### Biz Partner

(DG Administrator)

Description

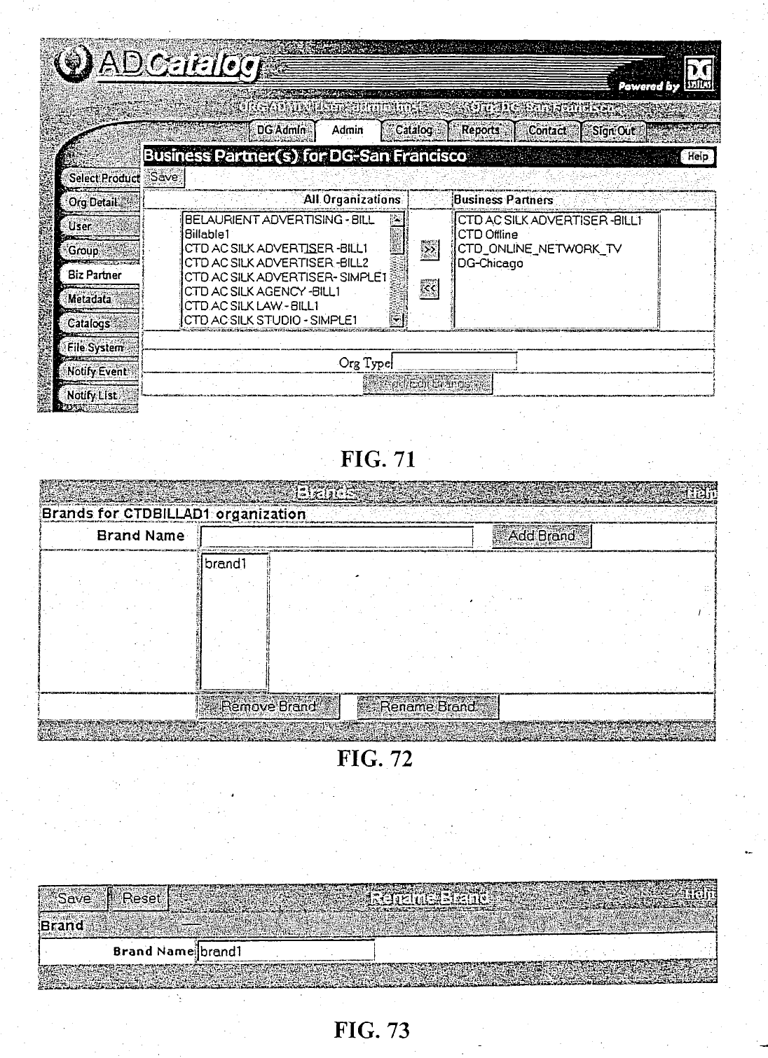

In the Biz Partner function, you can select business partners for an organization in AdCatalog, as shown in FIG. 71. A business partner is an organization (advertiser, law firm) that will be working with the selected organization (transferring spots, clearing spots, etc.) You can also add or edit brands associated with an Advertiser.

Step-by-Step

To add a business partner to an organization, click on an organization in the All Organizations window to highlight it, then click the >> button to add it to the Business Partners window. To remove a business partner from an organization, highlight it in the Business Partners window and click the << button. The organization will be removed from the Business Partners window. Click Save to save changes.

The Organization Type field indicates the type of the organization selected in the Business Partners window (the organization category and type was determined when the organization was originally created in AdCatalog). For an Advertiser Business Partner, you can add or edit the list of product brands associated with them. To do this, click on the Advertiser organization in the Business Partners window, then click Add/Edit Brands—this will open the Brands window, as shown in FIG. 72.

(You can only add brands for a Business Partner that is an Advertiser organization.)

In the Brands window, enter the name of a brand in the Brand Name field, then click Add Brand. The brand will appear in the window below this field, and has been added to the Advertiser.

To remove a brand, click on the brand, the click Remove Brand. The brand will be removed from the Advertiser. To rename a brand, click on the brand, the click Rename Brand. This will open the Rename Brand window, as shown in FIG. 73.

Edit the brand name in the Brand Name field, the click Save. This will NOT affect previously created spots. To reset the original name before saving, click Reset.

(Organization Administrator)

Description

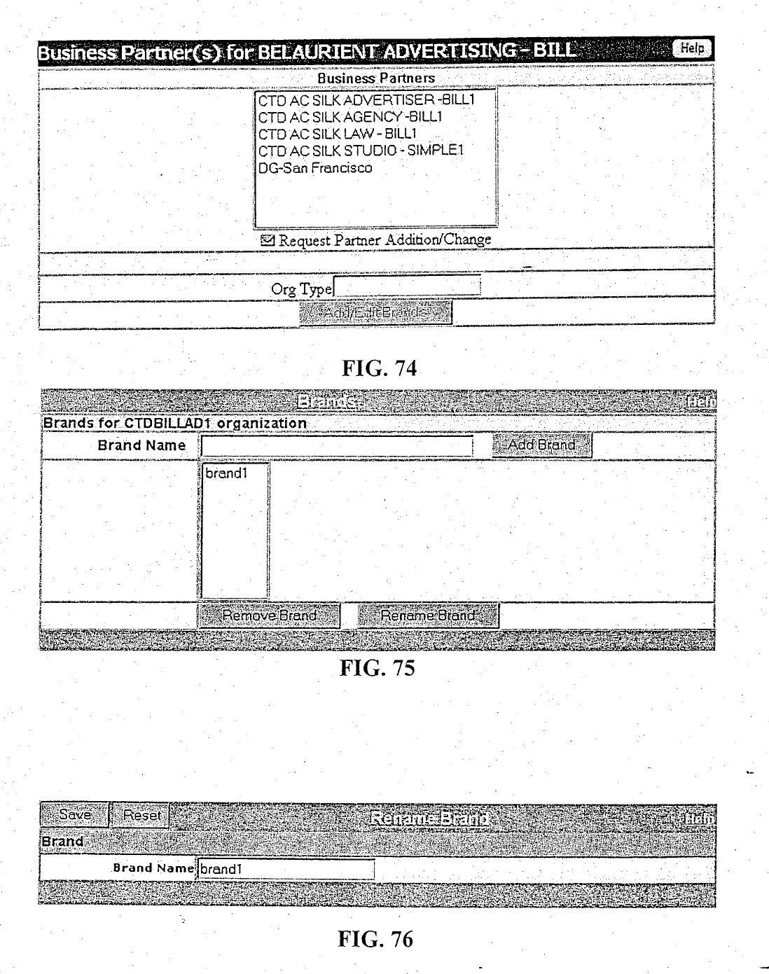

In the Biz Partner function, you can review business partners associated with your organization in AdCatalog, as shown in FIG. 74. A business partner is an organization (advertiser, law firm) that will be working with your organization (transferring spots, clearing spots, etc.) You can also request new or changed business partners, and add or edit brands associated by your organization with an Advertiser.

Step-by-Step

The business partners associated with your organization are listed in the Business Partners window. To see the organization type of a business partner (e.g. Agency, Advertiser, Law Firm) click on it. Its organization type will appear in the Organization Type field.

If you want to request a new business partner or changes to an existing business partner, click on the envelope icon labeled Request Partner Addition/Change. This will open an email message in your email application, where you can write your request and send it to DG Systems.

For an Advertiser Business Partner, you can add or edit the list of product brands associated with them. To do this, click on the Advertiser organization in the Business Partners window, the click Add/Edit Brands—this will open the Brands window, as shown in FIG. 75. You can only add brands for a Business Partner that is an Advertiser organization.

In the Brands window, enter the name of a brand in the Brand Name field, then click Add Brand. The brand will appear in the window below this field, and has been added to the Advertiser. To remove a brand, click on the brand, the click Remove Brand. The brand will be removed from the Advertiser. To rename a brand, click on the brand, the click Rename Brand. This will open the Rename Brand window, as shown in FIG. 76.

Edit the brand name in the Brand Name field, then click Save. This will not affect previously created spots. To reset the original name before saving, click Reset.

### Metadata

(DG Administrators)

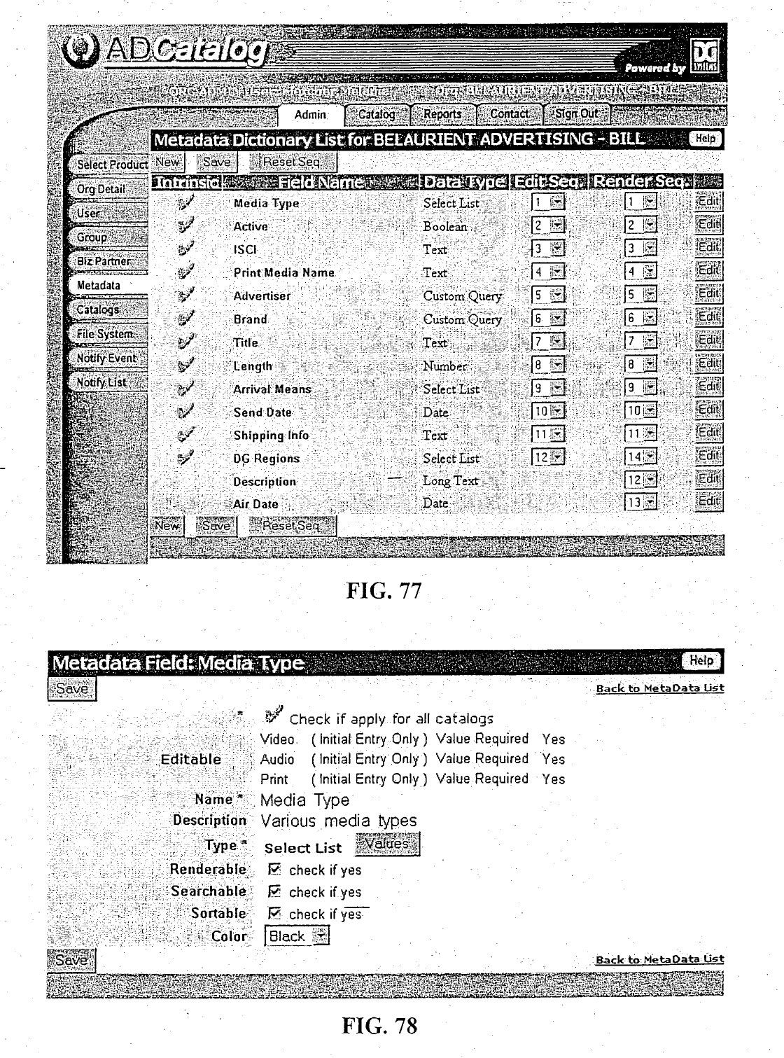

The Metadata function in the Admin tab allows you to set metadata fields for your organization, as shown in FIG. 77. See the Metadata function in the DG Admin Tab for instructions.

(Organization Administrators)

Description

In the Metadata function, you can modify current metadata settings and create new settings for your organization.

Metadata is specific information about a spot that is included in the spot's media record, and is listed in the Metadata Dictionary List for {your organization}. The Metadata Dictionary List is organized in the following columns:

1) Intrinsic—the metadata field is active and will appear in all media records in the organization.

2) Field name—name of the field.

3) Data type—data type of the field (Text, Long Text, Number, Boolean, Date, Select List).

4) Edit Seq.—how the fields are listed in the metadata dictionary list.

5) Render Seq.—how the fields are listed in a media record. The first eight fields will appear in the main section of a record—to see all the fields, a user will need to click Details.

There are eleven metadata fields that will be included in every AdCatalog media record:

1) Media type—the media type of the spot (Video, Audio, Print).

2) Active—whether or not a spot is active and should show up in a catalog.

3) ISCI—the ISCI code of the audio or video spot.

4) Print Media Name—the filename of a print/image file.

5) Advertiser—the advertiser represented by the spot.

6) Brand—the brand advertised in the spot.

7) Title—the title of the spot.

8) Length—the length of the spot in seconds.

9) Arrival Means—how the spot is arriving at DG Systems

10) Send Date—the date and time the spot was sent to DG Systems.

11) Shipping Info—shipping information about the spot.

You can also create additional metadata fields for all media records in your organization by clicking New—this will start the Add New Metadata Wizard, where you can select what data type you wish to use for your metadata and create the metadata field itself. To edit information about a metadata field, click Edit—this will open the metadata field and allow you to edit it.

You can use the Edit Seq. and Render Seq. columns to determine the sequence in which the fields will be listed in the metadata dictionary List and a media record, respectively. Clicking on a field's position number and selecting a new position will exchange that field with the one previously in the selected position. To save these sequence changes, click Save. Any changes made to a metadata field will not show up in AdCatalog until you log out and start a new session.

Step-by-Step

Editing an Existing Metadata Field

Click Edit in the row of the metadata field you want to edit. This will open the Metadata Field: Media Type page, as shown in FIG. 78. If you are editing one of the nine metadata fields that must appear in all AdCatalog media records (e.g. Media Type), you will only be able to edit the following options:

1) Renderable—check this if the field should appear in new media records (unchecking this box will disable the metadata field and it won't be used in any new media records).

2) Searchable—check this if the field can act as a search parameter.

3) Sortable—check this if the field can act as a sorting parameter.

4) Color—select the color of the metadata text as it will appear in a media record (default is black).

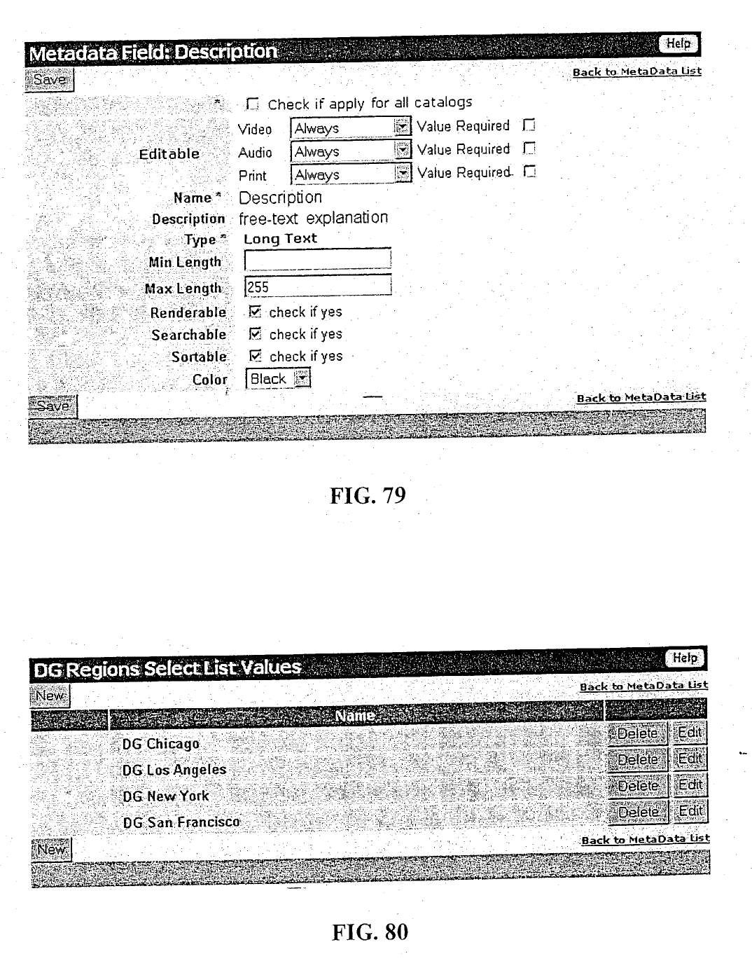

Once you have made your changes, click Save. Your changes will be saved and you will be returned to the metadata list, as shown in FIG. 79.

If you are editing a metadata field that has been created by a DG Administrator, you can make changes to all the following options (the terms in parentheses refers to the data type of the metadata field—Text, Long Text, Number, Boolean, Date or Select List):

1) Editable—(all data types)—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name (all data types)—enter the name of the field (e.g. File Name).

3) Description (all data types)—enter a short description of the metadata field (e.g. filename).

4) Min. Length (Text, Long Text)—enter the minimum character length of text.

5) Max. Length (Text, Long Text)—enter the maximum character length of text.

6) Min Value (number)—enter the minimum number of characters in field.

7) Max Value (number)—enter the maximum number of characters in field.

8) Min Date (date)—enter a start date for the metadata activity. Click on the Calendar icon, if needed, to find and select a date.

9) Max Date (date)—enter an end date for the metadata activity. Click on the Calendar icon, if needed, to find and select a date.

10) Renderable (all data types)—check this if the field should appear in new media records (unchecking this box will disable the metadata field, and it won't be used in any new media records.)

11) Searchable (all data types)—check this if the field can act as a search parameter.

12) Sortable (all data types)—check this if the field can act as a sorting parameter.

13) Color—select the color of the metadata text as it will appear in a media record (default is black).

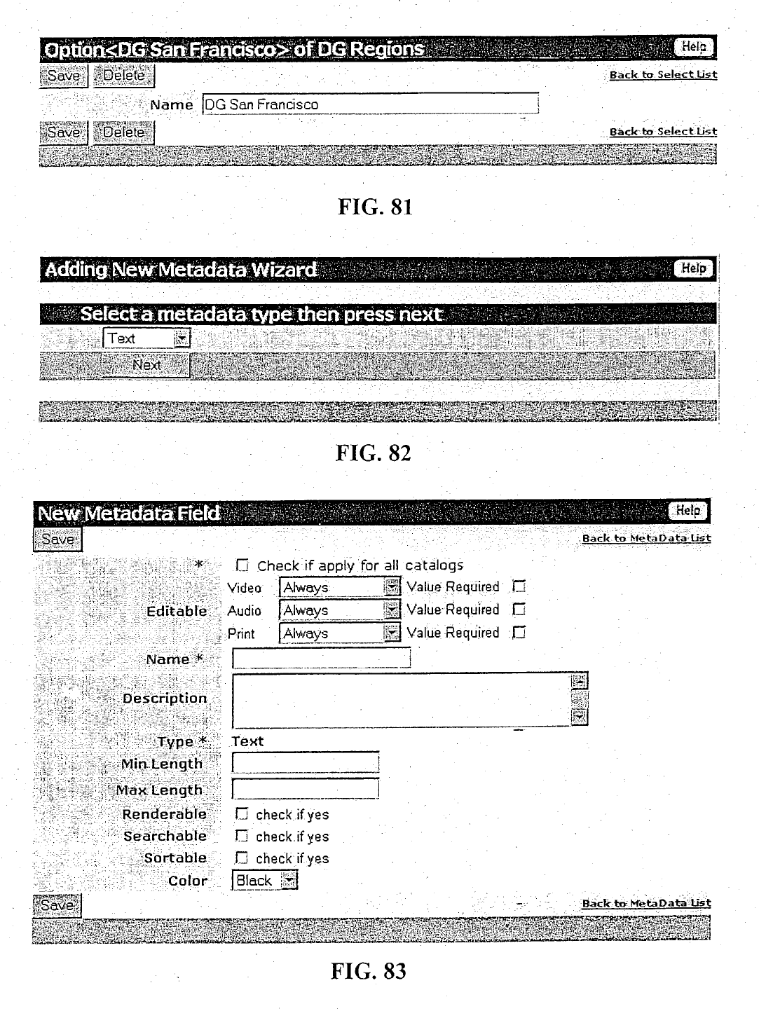

When editing a Select List metadata field, you may want to edit or delete list values in the select list. To do this, click Values—this will open the Select List Values page, as shown in FIG. 80. To delete a list value from the select list, click Delete. To edit a list value, click Edit—this will open the value and you can edit the name of the list value in the Name field, as shown in FIG. 81. To save your changes, click Save. To delete this list from the select list, click Delete.

Creating a New Metadata Field

Click New on the Metadata Dictionary List. This will start the Add New Metadata Wizard, as shown in FIG. 82. From the drop-down box, select a metadata type:

1) Text—a field that contains short text (e.g. filename).

2) Long Text—a field that contains longer text (e.g. instructions, comments).

3) Number—a field that contains numbers (e.g. phone numbers, fax number).

4) Boolean—a drop-down box with Yes/No choices (e.g. Active—yes or no.)

5) Date—a field where you can set minimum and maximum dates for an activity (e.g. flight dates).

6) Select List—a drop-down box with multiple choices (e.g. business partners, campaigns).

Click Next. This will open the New Metadata Field page, as shown in FIG. 83, where you can complete the new metadata field.

New Metadata Field—Text

If this field should be used throughout your organization, check the “Check if apply for all catalogs” box.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. File Name).

3) Description—enter a short description of the metadata field (e.g. filename).

4) Type—Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Long Text

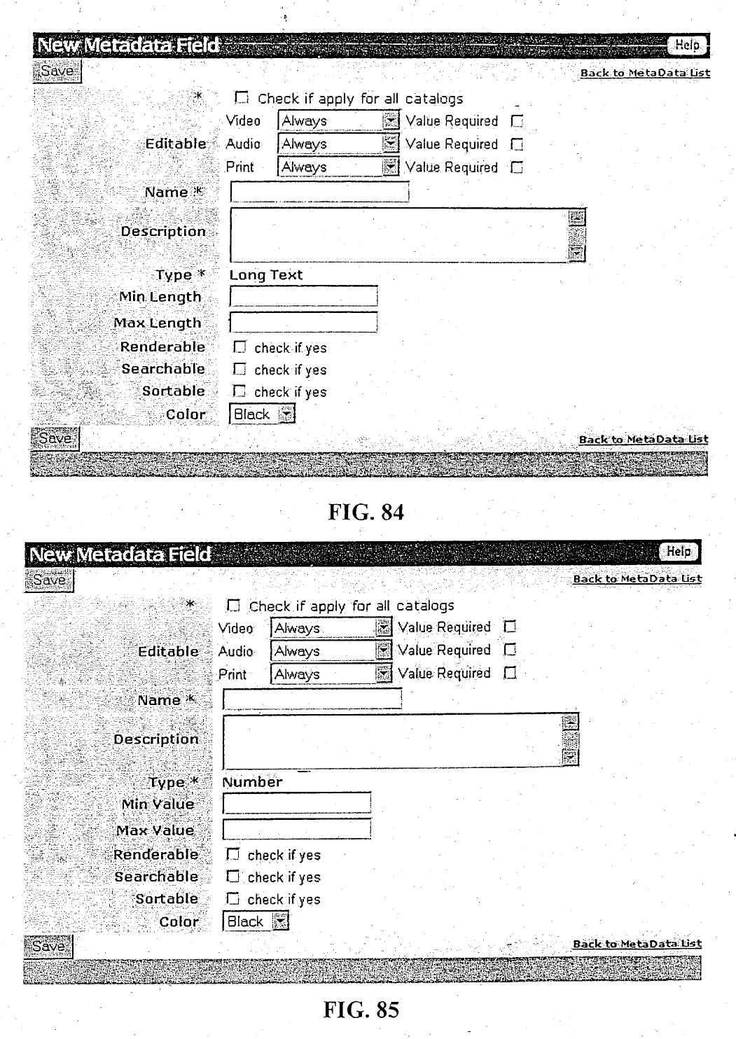

If this field should be used throughout your organization, check the Check if apply for all catalogs box. See FIG. 84.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Air Information).

3) Description—enter a short description of the metadata field (e.g. instructions for airing the spot).

4) Type—Long Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Number

If this field should be used throughout your organization, check the Check if apply for all catalogs box. See FIG. 85.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Order ID).

3) Description—enter a short description of the metadata field (e.g. AdCatalog order ID number).

4) Type—Number.

5) Min. Value—minimum number of characters in field

6) Max.Value—maximum number of characters in field.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Boolean

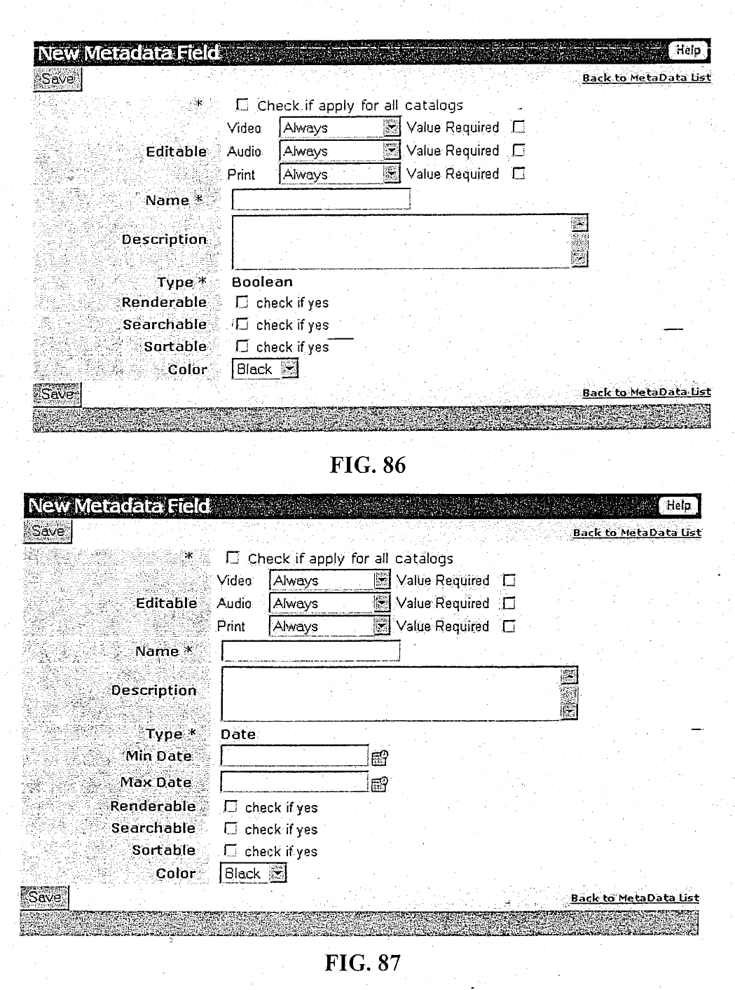

If this field should be used throughout your organization, check the Check if apply for all catalogs box. See FIG. 86.

1) Editable—use Editable to determine whether the metadata field can be edited when used for various media types. Choose “Always” if the metadata field should always be editable, “Initial Entry Only” if the metadata field should only be. editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Active).

3) Description—enter a short description of the metadata field (e.g.yes—available; no—unavailable).

4) Type—Boolean.

5) Renderable—check this if the field should appear in new media records (unchecking this box will disable the metadata field, and it won't be used in any new media records.)

6) Searchable—check this if the field can act as a search parameter.

7) Sortable—check this if the field can act as a sorting parameter.

8) Color—select the color of the metadata text as it will appear in a media record (default is black).

Click Save to save all changes and return to the Metadata List. Click Back to Metadata List if you do not want to make or save any changes.

New Metadata Field—Date

If this field should be used throughout your organization, check the Check if apply for all catalogs box. See FIG. 87.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Flight Date).

3) Description—enter a short description of the metadata field (e.g. flight date for spot).

4) Type—Date.

5) Min. Date—enter a start date for the metadata activity. Click on the Calendar icon, if needed, to find and select a date.

6) Max. Date—enter an end date for the metadata activity.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Select List

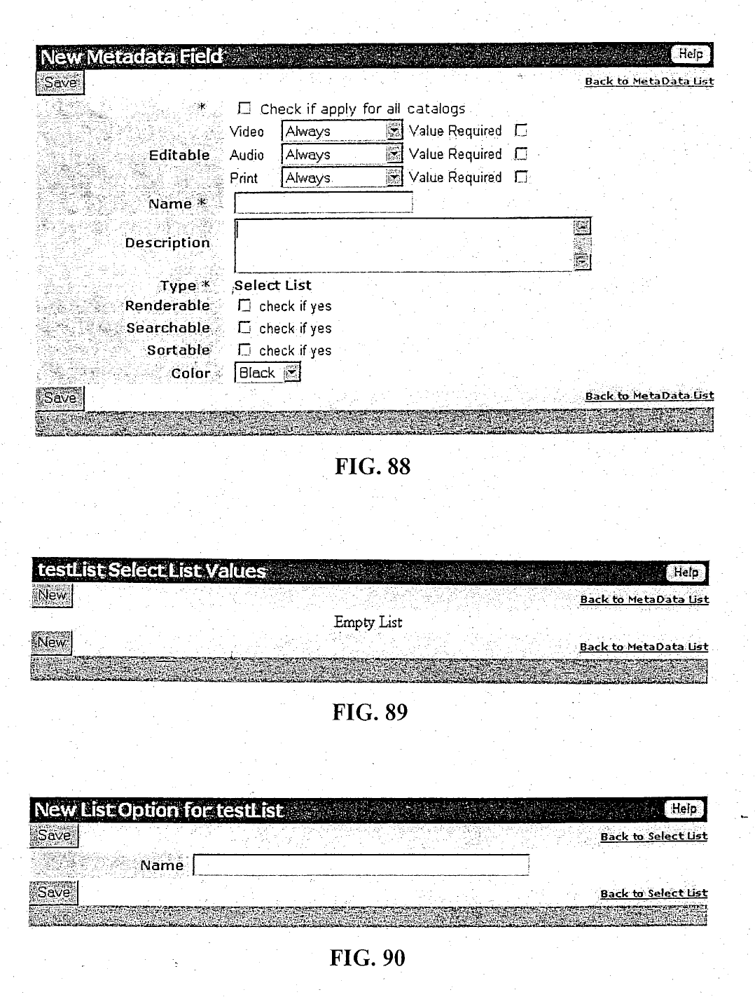

If this field should be used throughout your organization, check the Check if apply for all catalogs box. See FIG. 88.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. DG Regions).

3) Description—enter a short description of the metadata field (e.g. DG Regions to administrate spot).

4) Type—Select List.

5) Renderable—check this if the field should appear in new media records (unchecking this box will disable the metadata field, and it won't be used in any new media records.)

6) Searchable—check this if the field can act as a search parameter.

7) Sortable—check this if the field can act as a sorting parameter.

8) Color—select the color of the metadata text as it will appear in a media record (default is black).

Click Save. This will open a page called (fieldname) Select List Values, as shown in FIG. 89, where you can enter values for your list.

Click New. This will open the New List Option for (fieldname) page, as shown in FIG. 90.

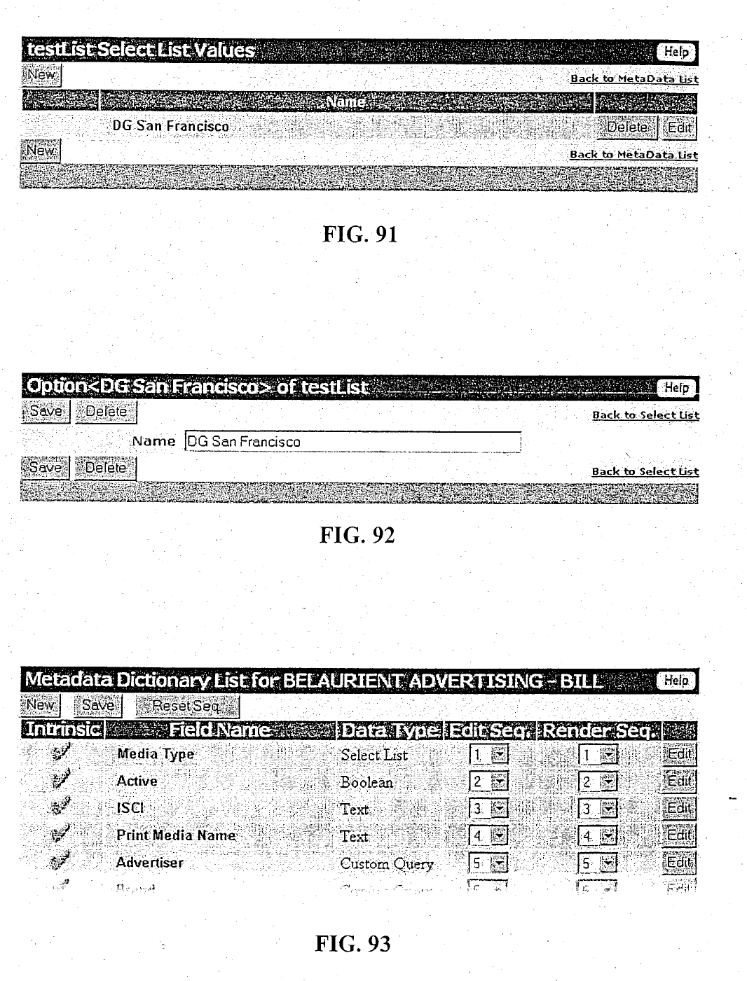

Enter the name of the list value (e.g. San Francisco) in the Name field, then click Save. This will return you to the Select List Values page, where the new list value will appear, as shown in FIG. 91. Continue the process until you have added all the list values to the select list. To delete a list value, click Delete. To edit the name of a list value, click Edit—this will open the value, and you can edit the name of the list value, as shown in FIG. 92. To save your changes, click Save. To delete the list value, click Delete.

Once you have added all the list values to the select list, click Back to Metadata List to return to the Metadata List.

Change the Editing Sequence

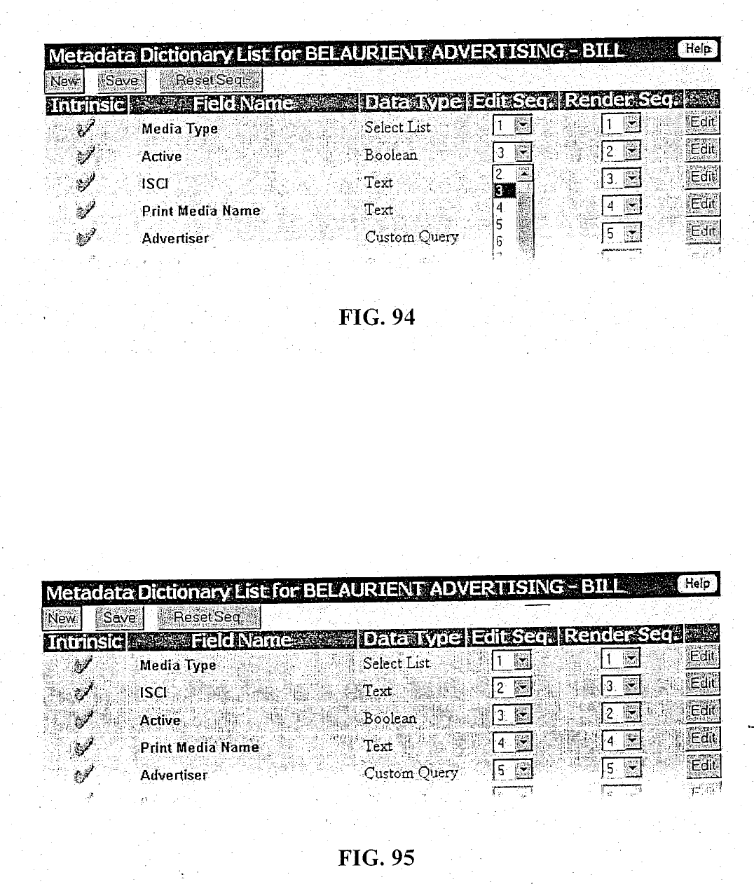

In the Edit Seq. columns, you can determine the sequence in which the fields will be listed in the Metadata Dictionary List, as shown in FIG. 93. Click on a field's position number and select a new position, as shown in FIG. 94. Click Save. This will exchange the field with the one previously in the selected position, as shown in FIG. 95.

Change the Rendering Sequence

As with the Edit Seq. column, in the Render Seq. columns, you can determine the sequence in which the fields will be listed in a media record. Click on a field's position number and select a new position. Click Save. This will exchange the field with the one previously in the selected position. If you have not clicked Save and want to undo a sequence change, click Reset Seq. This will restore the original sequence in both columns.

### Catalogs

(DG/Organization Administrator)

Description

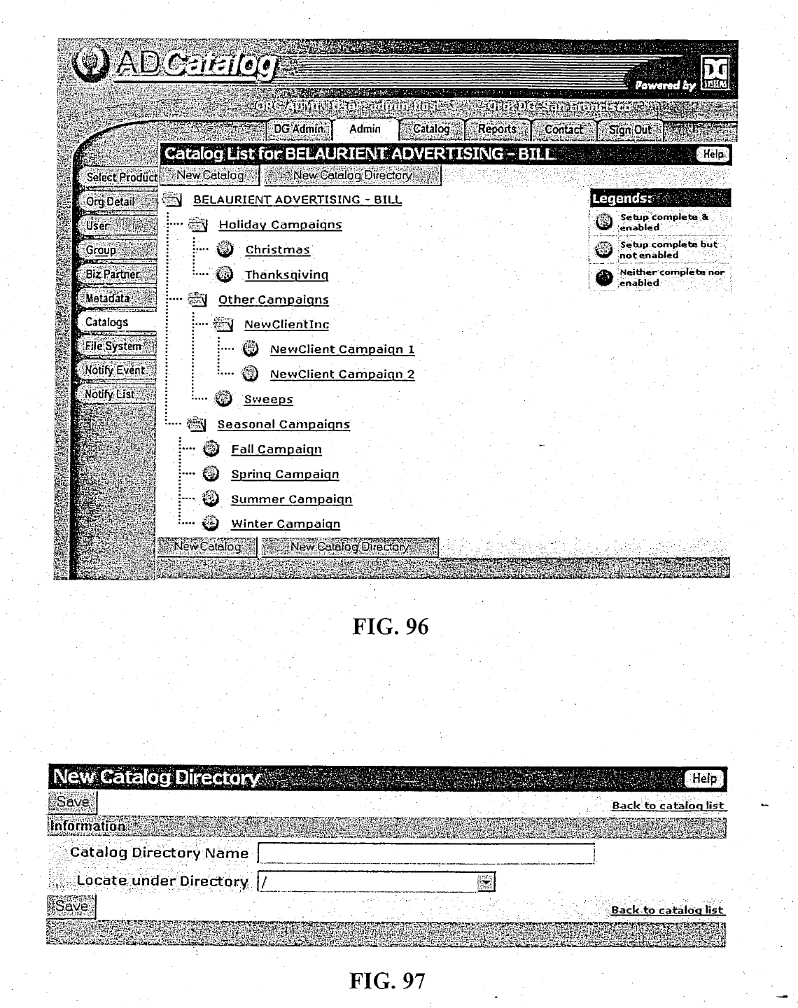

In the Catalog function, as shown in FIG. 96, you can add new directories and catalogs for your organization. A directory (represented by a file icon) is a file that contains catalogs and subdirectories. A catalog (represented by a red, green or yellow circle) is a file that contains spots and media records.

You can select an administrator for an individul catalog—this is useful if the same directory contains catalogs for three different divisions, each with an administrator who will oversee their individual catalog.

The Catalog function shows the current directory structure of your organization—the top level is the Organization folder, and below it are directories, subdirectories and catalogs. You can nest subdirectories to a depth of (?).

There are three stages of catalog creation. This is due to AdCatalog's ability to assign an administrator to a catalog—as Organization Administrator, you can create a catalog and assign,a Catalog Administrator to it. It is then the DL Administrator's responsibility to set up and enable the catalog. A green circle means a catalog has been set up and enabled—it is ready to accept media records. A yellow circle means a catalog has been set up, but is not enabled and visible on the Catalog page (this can happen when a catalog needs to be taken off—line for some reason). A red circle means that a catalog has been created, but the administrator has not yet completed and enabled it.

Step-by-Step

Click on any directory or catalog to open it in the Catalog tab.

Create a New Directory

Click New Catalog Directory. This will open the New Catalog Directory window, as shown in FIG. 97. Enter a name for the new directory in the Catalog Directory Name field. Position the new directory in the organization's structure by clicking the Locate Under Directory drop-down box and selecting a directory in which to save you new directory (/ is the Organization Directory, the topmost level). Click Save.

Create a New Catalog

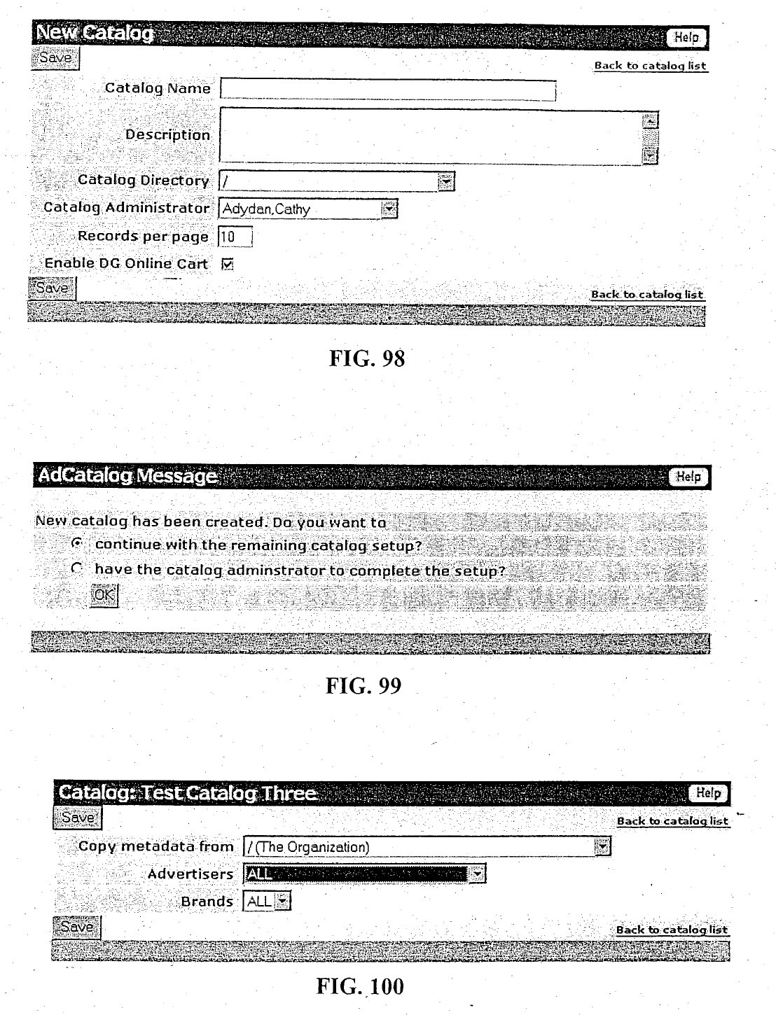

Click New Catalog. This will open the New Catalog window, as shown in FIG. 98. Enter the following information:

1) Catalog Name—enter the name of the catalog.

2) Description—enter a short description of the catalog.

3) Catalog Directory—choose a directory for the catalog (/ is the Organization Directory).

4) Catalog Administrator—choose a Catalog Administrator from the users in your organization.

5) Records per page—choose the default number of media records that will appear in the Media Search function.

6) Enable the DG Online Cart—check this enable AdCatalog to transfer spots from this catalog to DG Online via the Cart function.

Click Save. This will create the catalog and open an AdCatalog Message window, as shown in FIG. 99. If you want to continue setting up the catalog, click the continue with the remaining catalog setup radio button. See FIG. 100.

1) Copy Metadata from—select the metadata fields for the entire organization, or metadata fields for individual catalogs.

2) Advertisers—select ALL to include all advertisers associated as Business Partners with your organization, or individual advertisers.

3) Brands—select ALL to include all brands associated with advertiser Business Partners to your organization, or individual brands that will be specific to this catalog.

If you have chosen someone else to be the catalog administrator, click the have the catalog administrator complete the setup radio button. The catalog will appear on the Catalog page, but will be marked with a red circle until the catalog administrator completes it.

File System

Description

The File System function, as shown in FIG. 101, is similar to the Catalogs function, in that it represents the directory system of your organization. Instead of storing spots and actual media, however, the File System allows you to store raw files, such as the image and HTML files used for the corporate page.

Step by Step

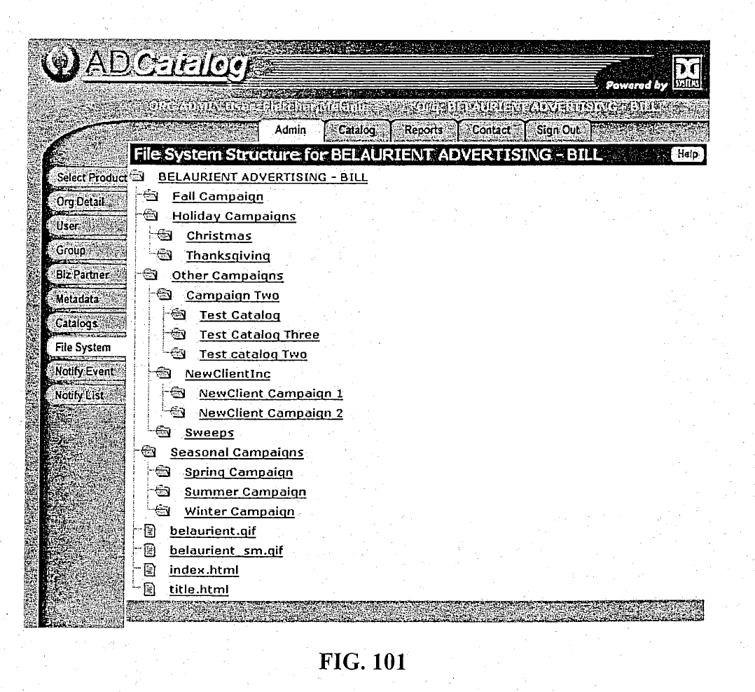

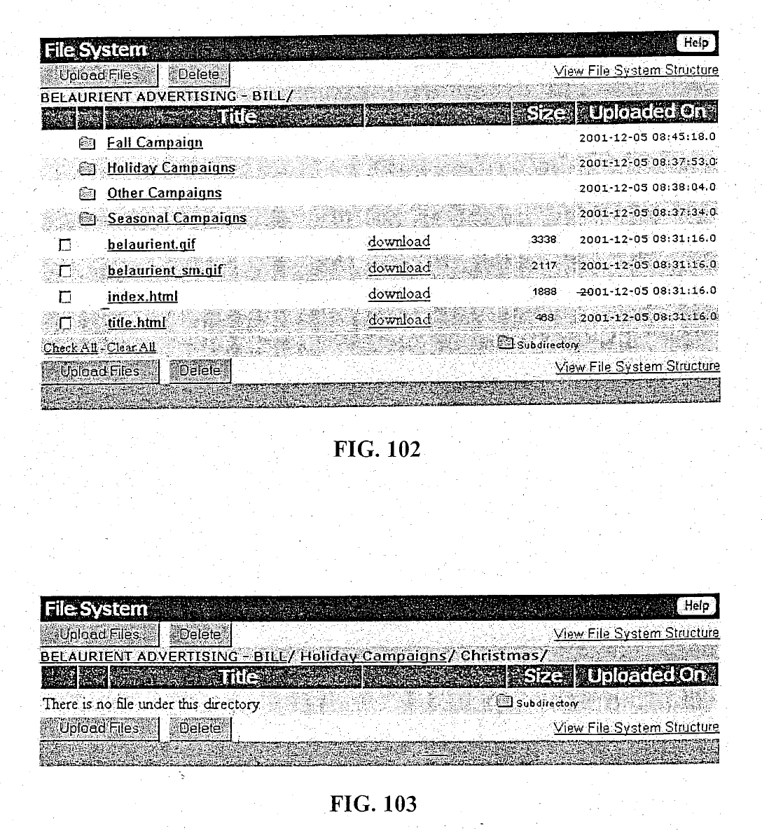

Click on a directory or catalog to open its File System page, as shown in FIG. 102.

The File System page for a directory lists all the subdirectories (indicated with a folder icon) and catalogs listed in it, along with their title, size, and date and time on which they were uploaded to AdCatalog. Click on a subdirectory or catalog to open its File System Page. Clicking on a catalog, which is the lowest level in the structure, will open a File System page, as shown in FIG. 103.

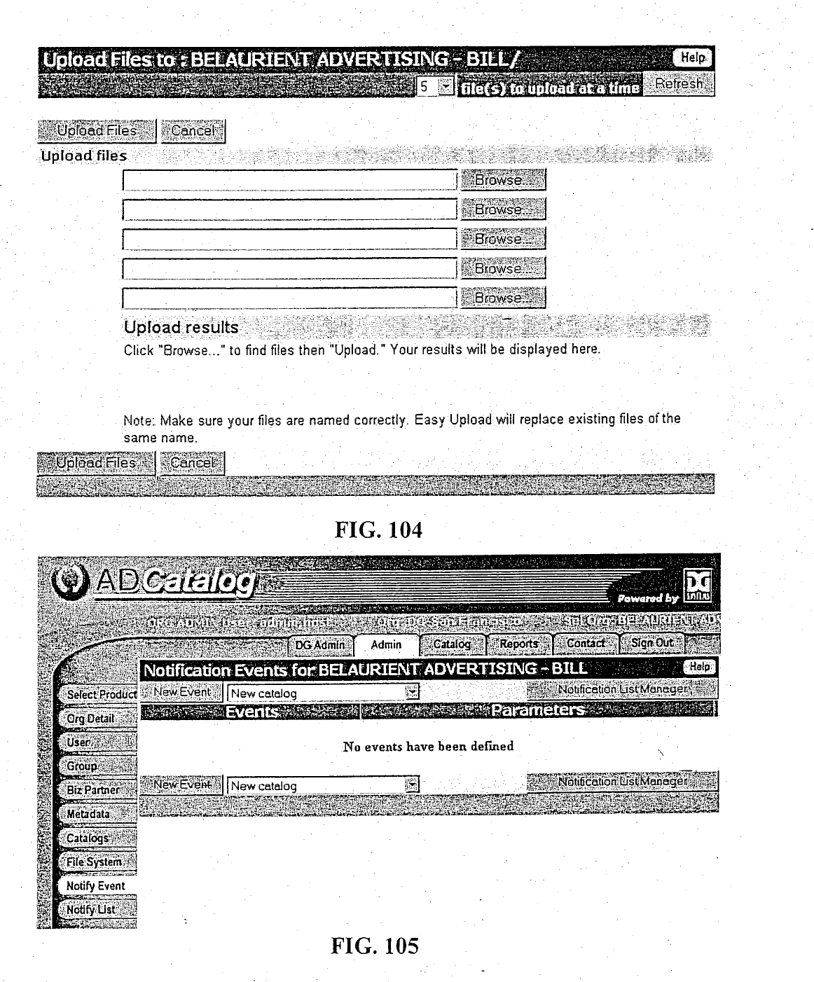

The File System page also lists any raw files (such as image or HTML files) in the directory. To view the file in your browser, click on its title. To download the file to your system, click download. To upload a file to a directory, click Upload Files. This will open the Upload File page, as shown in FIG. 104.

At the top of the page, you can select how many files you want to upload at a time (default is 5). When you have chosen a new number, click Refresh. The page will be refreshed with the new number of file fields.

In each field, enter the location of the file to be uploaded on your system, or use the Browse button to locate it. When you have finished entering all the files to be uploaded, click Upload Files. The files will be uploaded to AdCatalog and placed in the directory you choose. If you do not want to upload files you choose, click Cancel.

You cannot delete catalogs or directories from the File System, but you can delete other raw files. To do this, check the box next to the file that you want to delete. Click Delete. The file will be deleted from the file system.

Notify Event

Description

In the Notify Event function, as shown in FIG. 105, you can create notification events using Notify Lists based on members of User Groups. When an event occurs, notification will be sent out to all members of the Notify List via email.

Step by Step

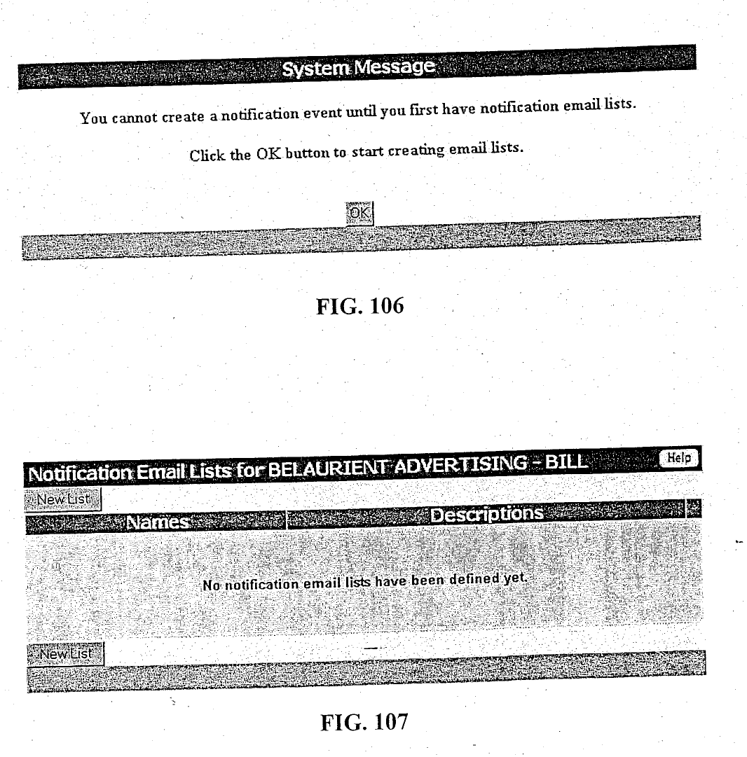

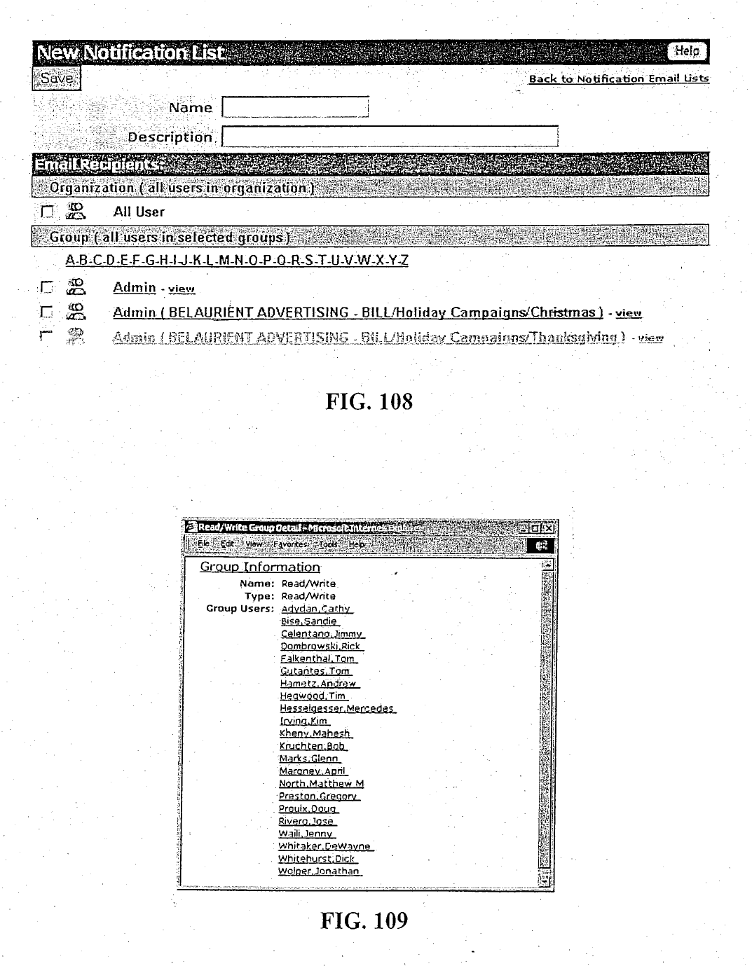

Before you create a notify event, you will need to create a notify list. If you do not have a notify list created, there will be a message displayed on the Notify Event page, as shown in FIG. 106. Click the OK button to create a Notify List. This will open the Notification Email Lists page, as shown in FIG. 107. Click New List. This will open the New Notification List page, as shown in FIG. 108.

At the top of the page, enter a Name for the notification list and a brief Description of the notification list's purpose. Below the Name and Description fields is a section called Email Recipients. Recipients are split into four groups

1) Organization (all users in organization)—click the check box to add all users in the organization to a notification list.

2) Group (all users in selected groups)—click on the check box next to a group to add all users in that group to a notification list. To see a list of all users in the group, click on the group's name; this will open a Group Information window, as shown in FIG. 109, that lists the group's name, type and users. Click on a user's name to open a User Information window about that person.

3) Users—click on the check box next to a user to add individual users to the notification list.

4) Additional Email Addresses—enter email addresses of people outside the organization in the top field, then click Add. To delete an email address, click on it, then click Delete. See FIG. 110.

Once you have selected or entered all the users you want to add to your notification list, click Save. This will add the list to the Notification Email Lists page, as shown in FIG. 111.

Once you have created a notification list, click the Notify Events tab again, where you can now define a notification event or create more notification lists via the Notification List Manager, as shown in FIG. 112.

Select a notification event type form the drop down box next to the New Event Button:

1) New Catalog—a new catalog has been added.

2) New record in catalog—a new record has been added to a catalog.

3) Importing records into catalog—a new record has been imported into a catalog.

4) Exporting records form catalog—a record has been exported from a catalog.

5) Importing users—a new user has been imported into a catalog.

6) New news for catalog path—new news has been added to a directory.

7) Document activity in catalog path—files in a directory have been modified.

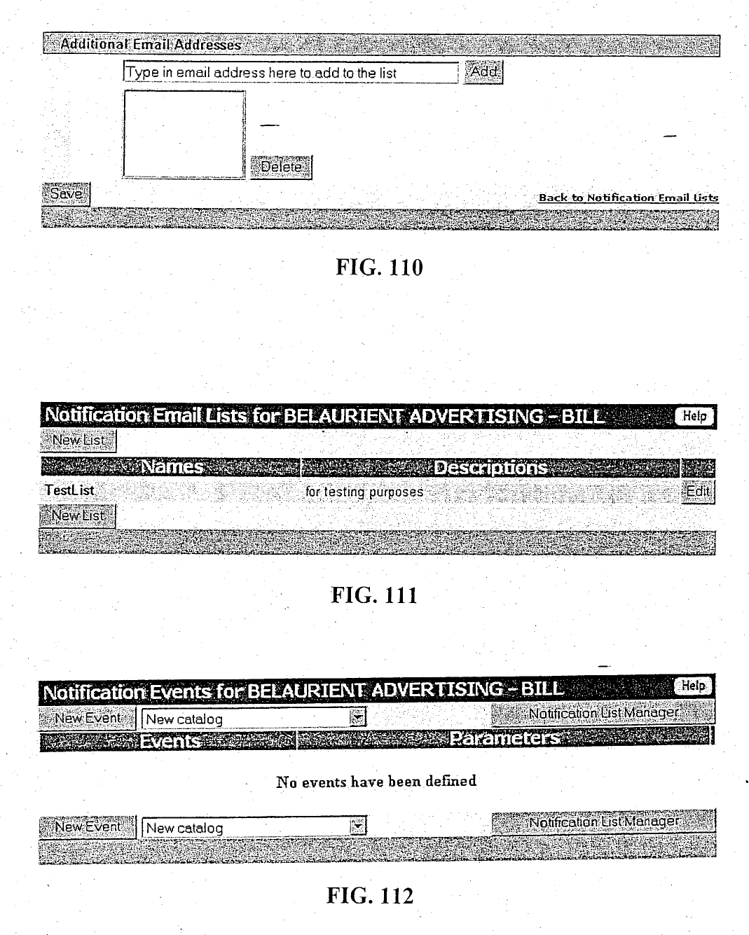

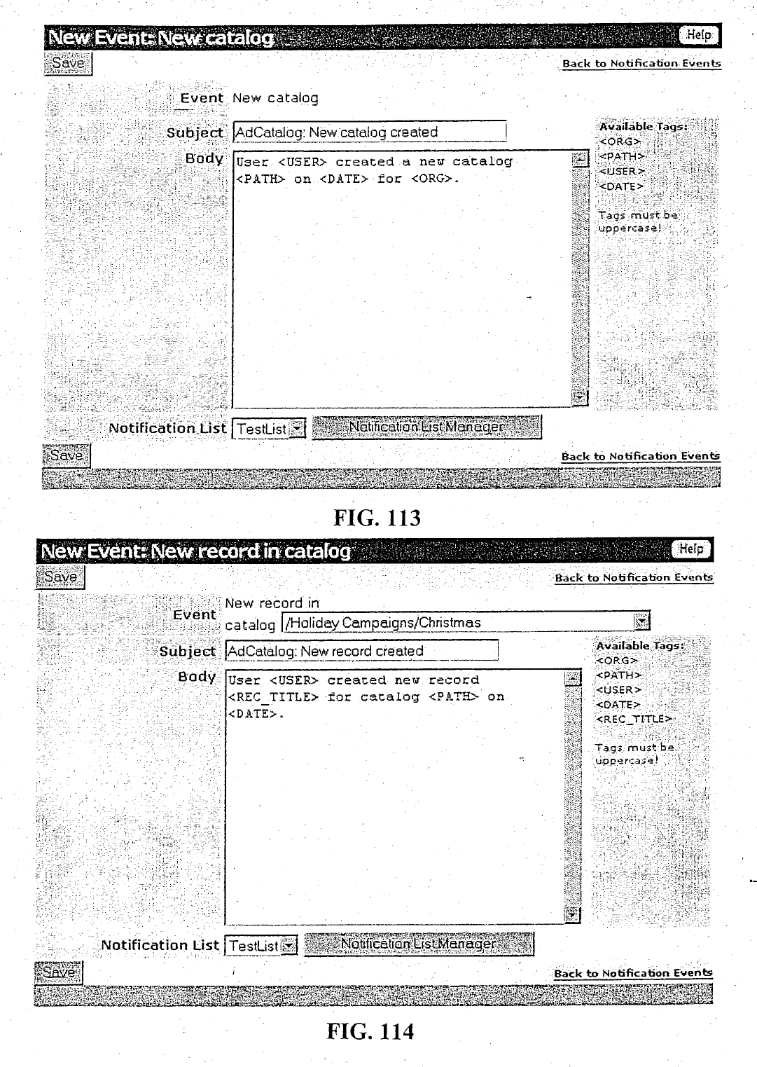

Once you have selected an event type, click New Event. This will open the New Event page, as shown in FIG. 113.

New Event—New Catalog

Use the New Event: New catalog page to create an email that will be sent out every time a new catalog is added to your organization.

1) Subject—The subject heading of the email. Use the preprogrammed heading or create your own.

2) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, and <DATE>, and must be in uppercase.

3) Notification List—select a notification list for the event. If you need to create a new list, click Notification List Manager to open the Notification Email Lists page. (instructions for creating a notification list previously provided).

When you have finished creating your email, click Save. The next time a catalog is added to your organization, a notifying email will be sent to all users on the notification list.

New Event—New Record in Catalog

Use the New Event: New record in catalog page, as shown in FIG. 114, to create an email that will be sent out every time a new record is added to a specific catalog in your organization.

1) Event—New record in catalog. Use the drop-down box to choose a specific catalog in your organization.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, and <DATE>, and must be in uppercase.

4) Notification List—select a notification list for the event. If you need to create a new list, click Notification List Manager to open the Notification Email Lists page. (instructions for creating a notification list previously provided).

When you have finished creating your email, click Save. The next time a record is added to the catalog you selected, a notifying email will be sent to all users on the notification list.

New Event—Importing Records into Catalog

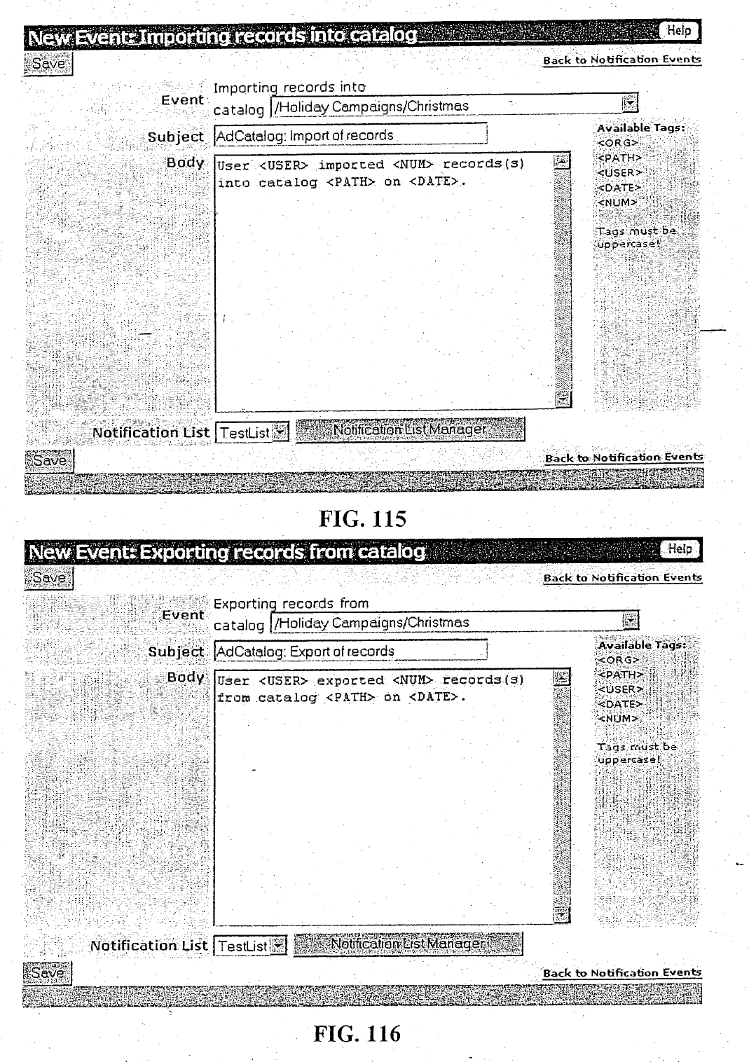

Use the New Event: Importing records into catalog page, as shown in FIG. 115, to create an email that will be sent out every time a new record is imported into a specific catalog in your organization.

1) Event—Importing records into catalog. Use the drop-down box to choose a specific catalog in your organization.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, and <DATE>, and must be in uppercase.

4) Notification List—select a notification list for the event. If you need to create a new list, click Notification List Manager to open the Notification Email Lists page. (instructions for creating a notification list previously provided).

When you have finished creating your email, click Save. The next time a record is imported into the catalog you selected, a notifying email will be sent to all users on the notification list.

New Event—Exporting Records from Catalog

Use the New Event: Exporting records from catalog page, as shown in FIG. 116, to create an email that will be sent out every time a record is exported from a specific catalog in your organization.

1) Event—Exporting records from catalog. Use the drop-down box to choose a specific catalog in your organization.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, and <DATE>, and must be in uppercase.

4) Notification List—select a notification list for the event. If you need to create a new list, click Notification List Manager to open the Notification

Email Lists page. (instructions for creating a notification list previously provided).

When you have finished creating your email, click Save. The next time a record is exported from the catalog you selected, a notifying email will be sent to all users on the notification list.

New Event—Importing Users

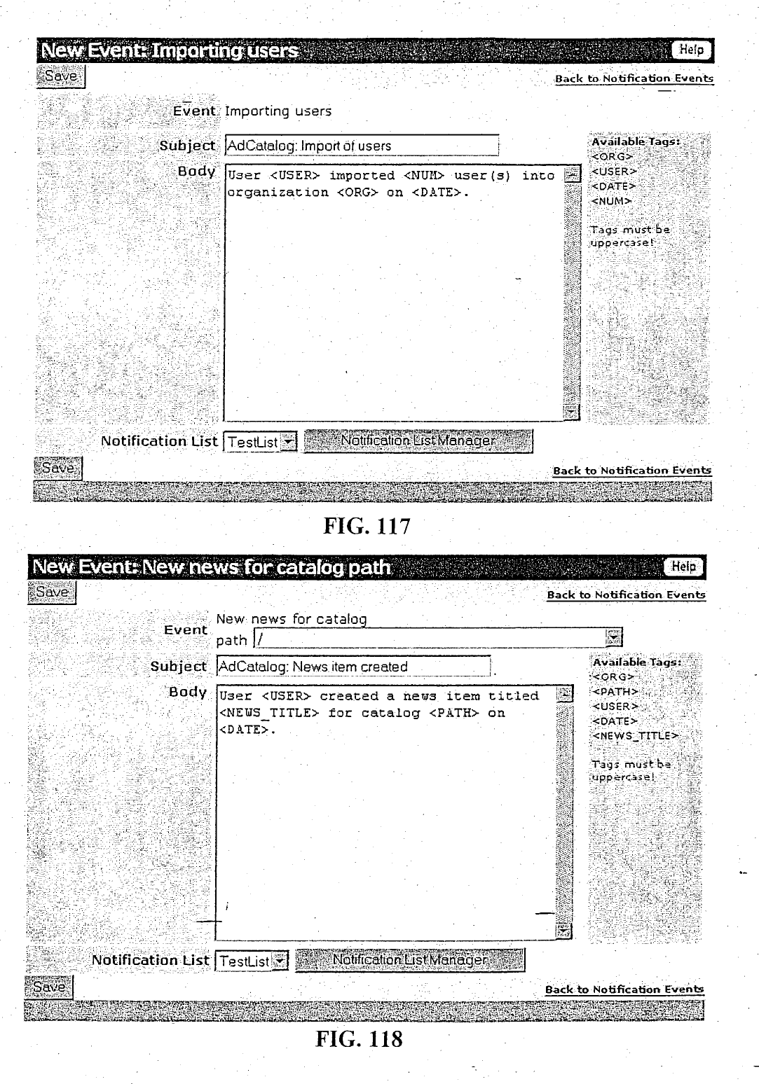

Use the New Event: Importing users page, as shown in FIG. 117, to create an email that will be sent out every time a new user is imported into your organization.

1) Event—Importing users.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <USER>, <DATE>, and <NUM>, and must be in uppercase.

4) Notification List—select a notification list for the event. If you need to create a new list, click Notification List Manager to open the Notification Email Lists page. (instructions for creating a notification list previously provided).

When you have finished creating your email, click Save. The next time a user is imported into your organization, a notifying email will be sent to all users on the notification list.

New Event—New News for Catalog Path

Use the New Event: New nevs for catalog path page, as shown in FIG. 118, to create an email that will be sent out every time new news is added to a specific directory or catalog in your organization.

1) Event—New news for catalog path. Use the drop-down box to choose a specific catalog in your organization.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, <DATE>, and <NEWS_TITLE>, and must be in uppercase.

4) Notification List—select a notification list for the event. If you need to create a new list, click Notification List Manager to open the Notification Email Lists page. (instructions for creating a notification list previously provided).

When you have finished creating your email, click Save. The next time news is added to the directory or catalog you selected, a notifying email will be sent to all users on the notification list.

New Event—Document Activity in Catalog Path

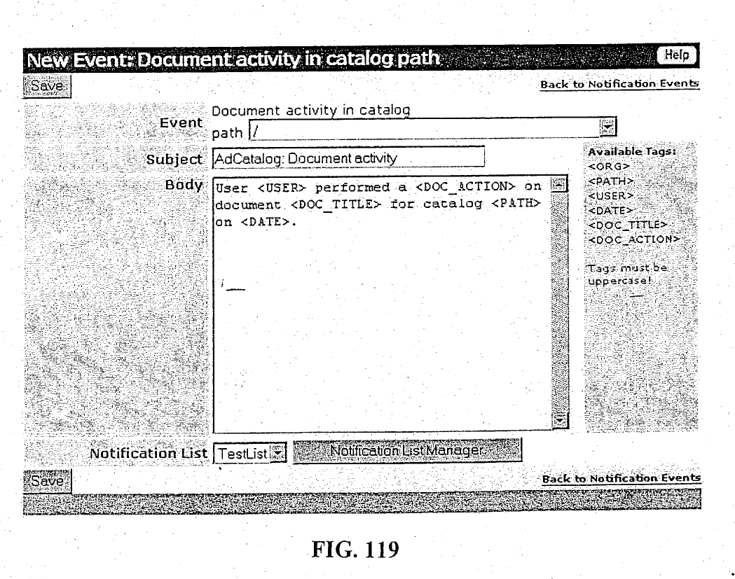

Use the New Event: Document activity in catalog path page, as shown in FIG. 119, to create an email that will be sent out every time documents are modified in a specific directory or catalog in your organization.

1) Event—Document activity in catalog path. Use the drop-down box to choose a specific catalog in your organization.

2) Subject—The subject heading of the email. Use the preprogrammed heading or create your own.

3) Body—the body of the email. Use the preprogrammed message or create your own. NOTE: Tags that are enclosed in angle brackets (e.g. <ORG>) are replaced by AdCatalog with information about the event, and must be included in the body of the email. The required tags are <ORG>, <PATH>, <USER>, <DATE>, and <NEWS_TITLE>, and must be in uppercase.

4) Notification List—select a notification list for the event. If you need to create a new list, click Notification List Manager to open the Notification Email Lists page. (instructions for creating a notification list previously provided).

When you have finished creating your email, click Save. The next time a document is modified in the directory or catalog you selected, a notifying email will be sent to all users on the notification list.

Notify List

In the Notify List function, as shown in FIG. 120, you can create notification lists that will be used for notification events (see Notify Event for more information).

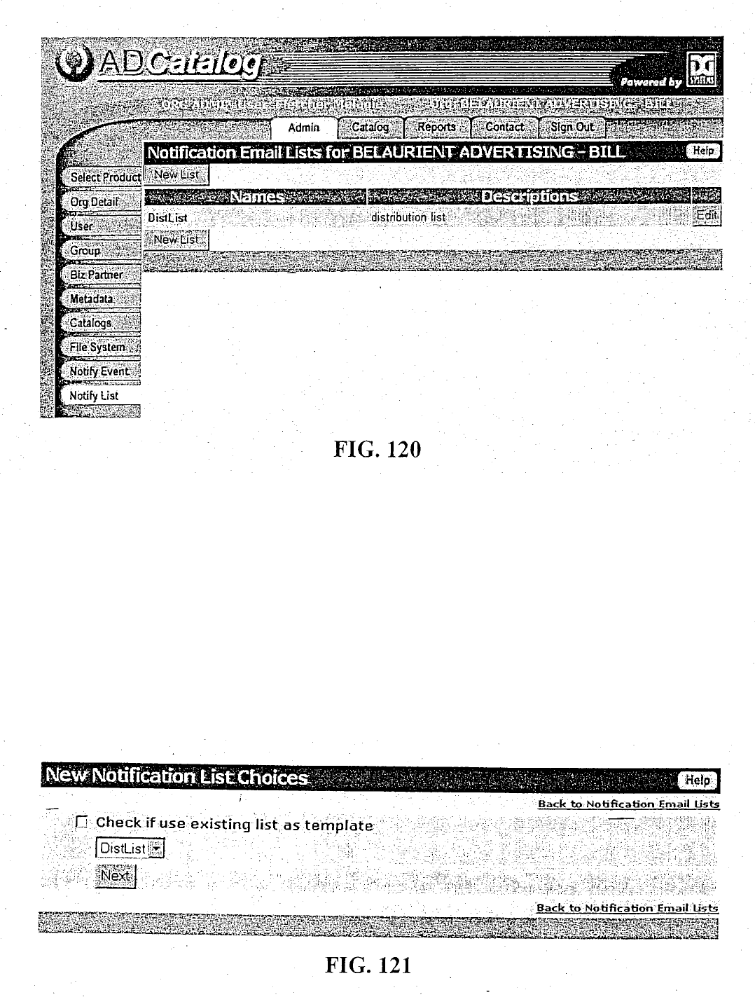

The Notify List page lists all the existing notification lists for your organization by Name and Description. To create a new list, click New List—this will open the New Notification List Choices page, as shown in FIG. 121.

If you would like to copy the users fonn an existing list into your new list, select a list from the drop-down box and click the Chick if use existing list as template checkbox. If not, leave this box unchecked.

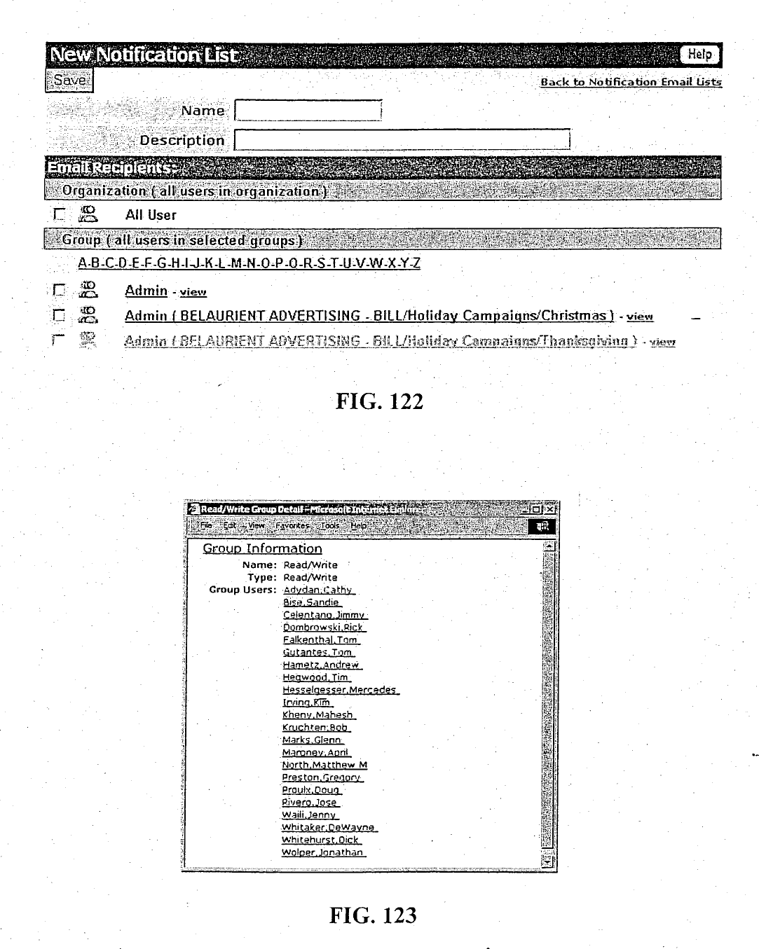

Click Next, this will open the New Notification List page, as shown in FIG. 122. At the top of the page, enter a Name for the notification list and a brief Description of the modification list's purpose.

Below the Name and Description fields is a section called Email Recipients. If you have used an existing list as a template, all the users from that list will be selected as recipients for your new list. Recipients are split in four groups:

1) Organization (all users in organization)—click the check box to add all users in the organization to a notification list.

2) Group (all users in selected groups) click on the check box next to a group to a notification list. To see a list of all users in the group, click on the group's name; this will open a Group Information window, as shown in FIG. 123, that lists the group's name, type and users. Click on a user's name to open a User Information window about that person.

3) Users—click on the check box next to a user to add individual users to the notification list.

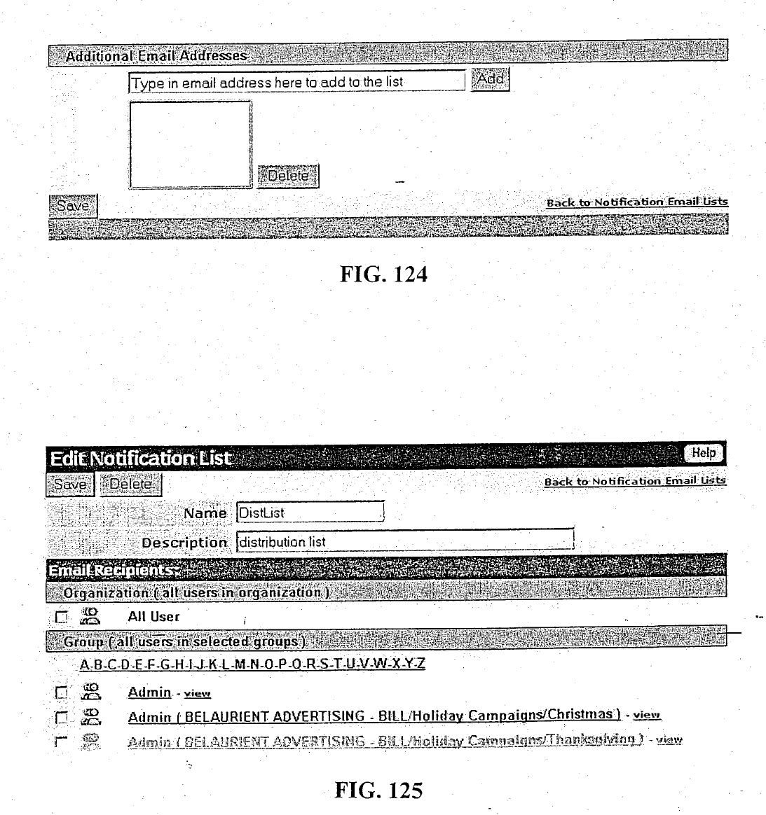

4) Additional Email Addresses—enter email addresses of people outside the organization in the top field, then click Add. To delete an email address, click on it, then click Delete. See FIG. 124.

Once you selected or entered all the users you want to add to your notification list, click Save. This will add the list to the Notification Email Lists page.

To edit an existing list, click Edit. This will open the Edit Notification List page, as shown in FIG. 125. Follow the instructions for creating a new notification list. To delete the list, click Delete at the top or bottom of the page. The list will be deleted from the Notification Email Lists page

Catalog

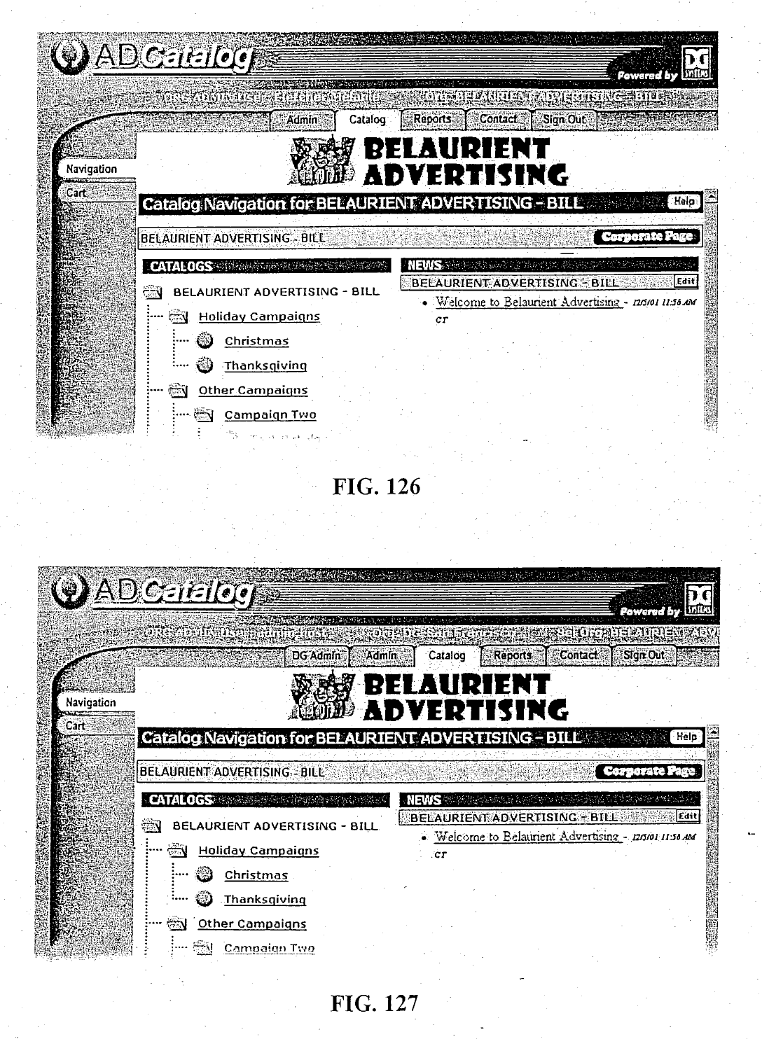

In the catalog tab, as shown in FIG. 126, you can:

1) Navigate between catalogs and catalog directories, add news blurbs to an individual directory or catalog.

2) Search for spots, review spots and collateral materials in a record, and add spots to the Shopping Cart function for transfer to the distribution server.

3) Create a new record and add spots to it.

4) Add, edit or disable spot metadata in the catalog's metadata dictionary list.

5) Add or remove spots in the Shopping Cart, and print an order summary.

6) Import and export catalog records, and create a status report of all import/export efforts.

Navigation

Description

As shown in FIG. 127, the user will be taken to the Navigation function the first time the user clicks on the Catalog tab or when he/she logs into AdCatalog. The Navigation function is where you can access directories and catalogs in your organization, read news about a directory or catalog, or view the Corporate Page for your organization.

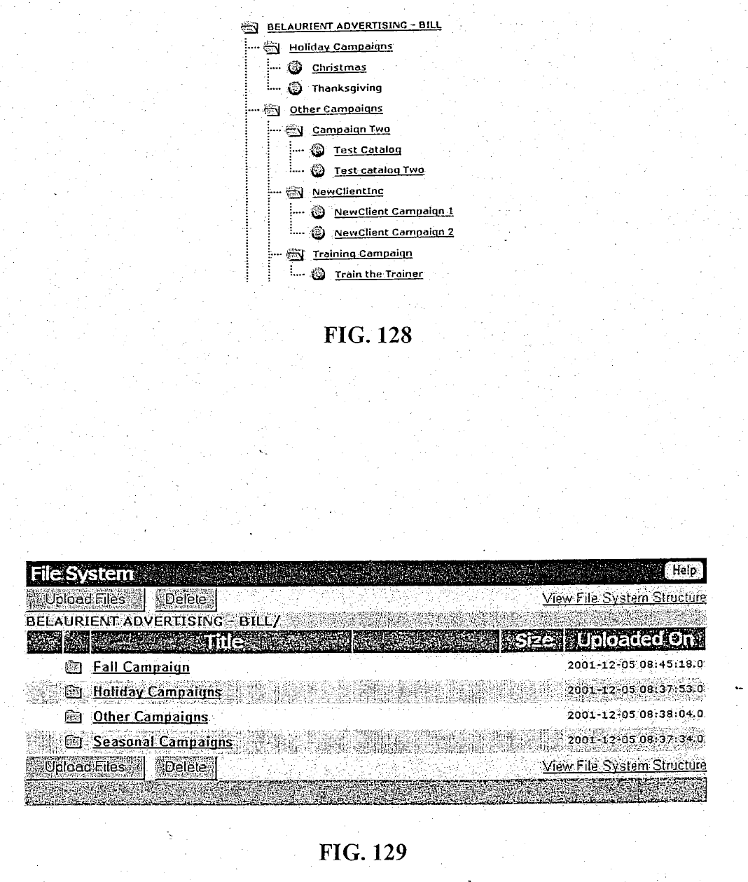

The Navigation page consists of your organization's directory system, including subdirectories and catalogs, as shown in FIG. 128. Each directory and catalog acts as a link. Clicking in a directory will give you access to the Navigation and Cart ftinctions, allowing you to navigate in the directory and review spots currently in the Shopping Cart for transfer to the distribution server. Clicking on a catalog will give you access to the Navigation, Media, New Record, Metadata, Settings, Security, Cart and Import/Export functions.

1) Navigation—navigate in the organizations directory system.

2) Media—perform a media search for spots in a catalog.

3) New Record—create a new media records for a spot in a catalog.

4) Metadata—specific information about a spot that is included in the spot's media record.

5) Settings—setting for a catalog.

6) Security—security settings and users for a catalog.

7) Cart—spots to be transferred to DG Online.

8) Import/Export—import and export of catalog media records, including status report.

In addition to working with catalogs and spots, you can also view information about the organization by clicking Corporate Page. This will open a new browser window containing a corporate webpage created by the Organization Administrator and stored in the Admin>File System function. You can use the Corporate page as a contact page, or to list procedures, instructions, or additional information about your organization.

Each directory and catalog also contains a News section, where you can read or post information about the directory or catalog (e.g. new files that have been added or information about the creation of a new directory). Finally, you can include a corporate logo in your Catalog page.

Step-by-Step

Select a Directory: In the directory system, click on a directory (indicated by a folder icon). This will open the directory in the Navigation page, and the name of the directory will be changed to black boldface. Available function tabs are the Navigation and Cart functions.

Select a Catalog: In the directory system, click on a catalog (indicated by a red, yellow or green spot icon). This will open the catalog in the Navigation page, and the name of the catalog will be changed to black boldface. Available function tabs are the Navigation, Media, New Record, Metadata, Settings, Security, Cart and Import/Export functions.

Once you have selected a catalog, you can create media records, work with spots, set catalog-level metadata and perform other tasks. We will discuss these functions later in the section.

View and Create/Edit a Corporate Page: To view an organization's corporate website, click Corporate Page. This will open the corporate page stored in an organization's AdCatalog account.

DG/Organization Administrators: To install a corporate website in AdCatalog, you will need to create HTML pages for the site or have the pages created by a web designer. You can have as many pages as you like, but you can only upload HTML and graphic files to AdCatalog. Also, the main page (the one that is opened when the Corporate Page button is clicked) must be named index.html, otherwise AdCatalog will not recognize it as the HTML file for the Corporate Page.

Once the pages are ready, go the Admin tab and click on the File System function. The website files must be uploaded to your organization directory (the topmost level of the directory system), otherwise the site will not open when the Corporate Page button is clicked.

In File System, locate you organization directory (the folder at the very top of the page) and click on it. This will open the directory's File System page, as shown in FIG. 129.

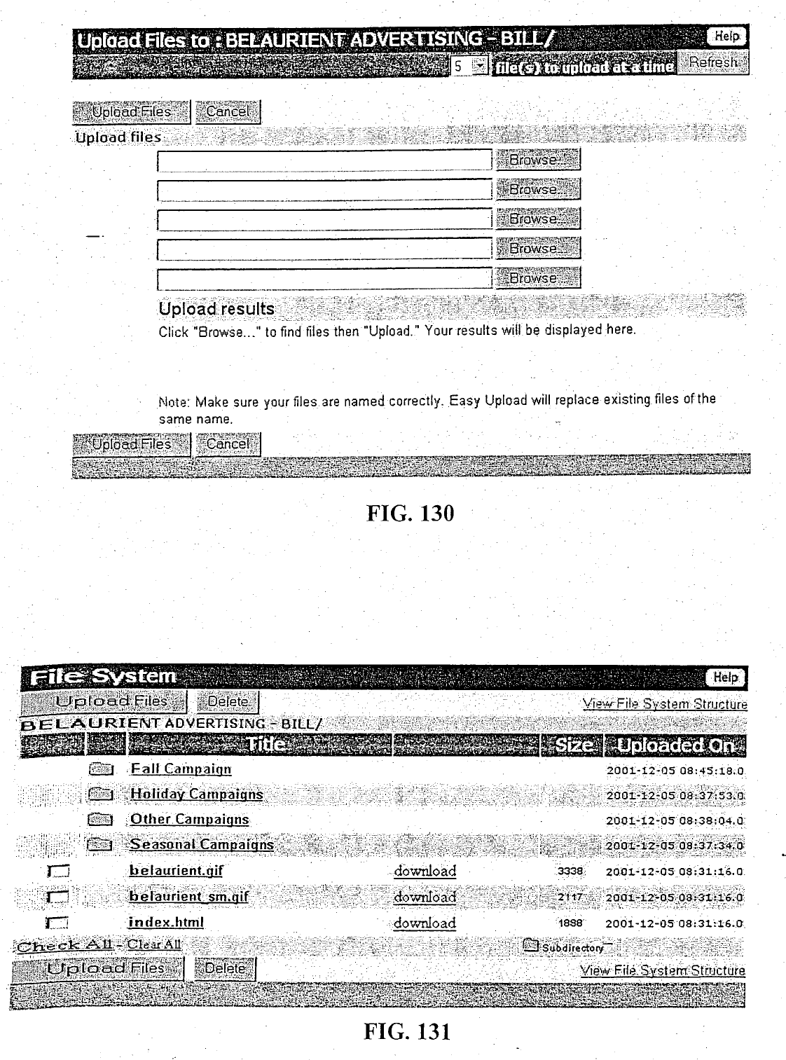

Click Upload Files. In the Upload Files page, as shown in FIG. 130, use the Browse button to locate the website files (HTML and graphic files only), then click upload. The website files will be added to your organization directory.

If you go back to the Catalog tab and click Corporate Page, you should see your corporate website. NOTE: AdCatalog is a web-based tool, which means it follows HTML rules. Many web designers will use subdirectories to keep image files or the related files for a specific page in one place. This structuring system is permitted in AdCatalog, but you will then need to mimic your website's directory structure by creating a new subdirectory (or subdirectories) in the organization directory. To do this, click on Admin>Catalogs and follow the instructions for creating a directory. Remember to give the new subdirectory the same name you used in your HTML links (e.g. “images” for an image subdirectory, “general_info” for the General Information subdirectory, etc.) Remember, however, that the index.html page MUST be kept in the organization directory.

If your organization already has a corporate website on the Internet that you want to have opened when someone click on the Corporate Page button, you can use auto-redirect code in the index.html page that will redirect users to your website.

To edit corporate website, edit the HTML pages on your favorite browser and reload them in AdCatalog.

Read, Add, Edit or Hide News

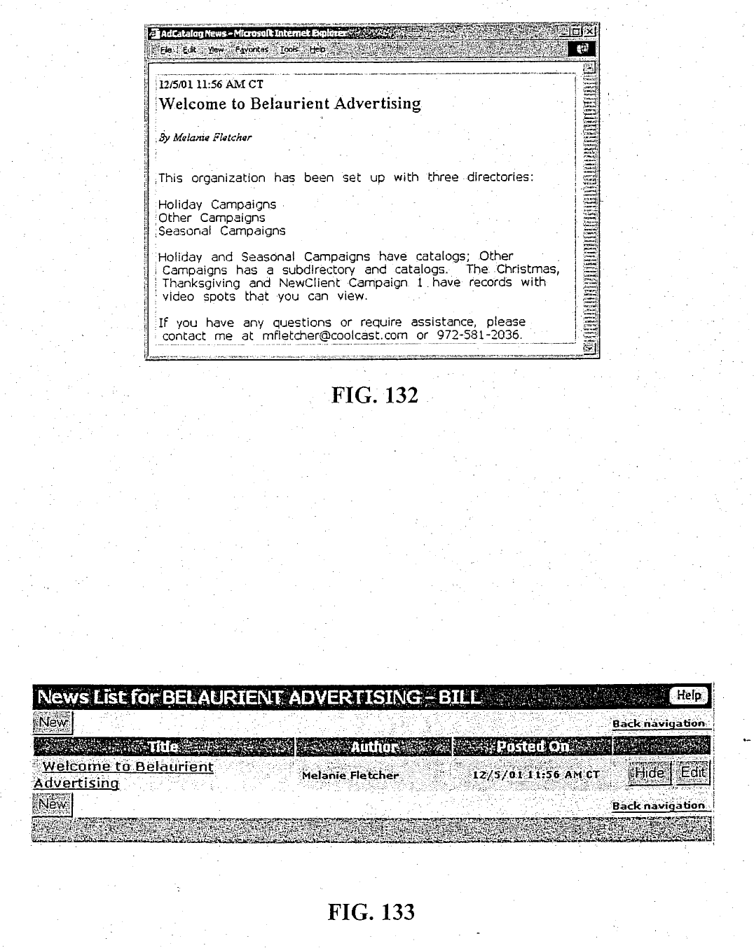

To read news about a directory or catalog, click on a news item in the News section. This will open a small browser window with the news item, as shown in FIG. 132. When you are finished reading the item, close the window.

To create a new news item or edit an existing one, click Edit. This will open the News List page for the directory or catalog, as shown in FIG. 133. In the News List page, you can create new news items, as well as edit or hide old items. Information about new news are presented below:

1) Title: the title of the item.

2) Author: the author of the item.

3) Posted On: the date and time the item was first posted to AdCatalog.

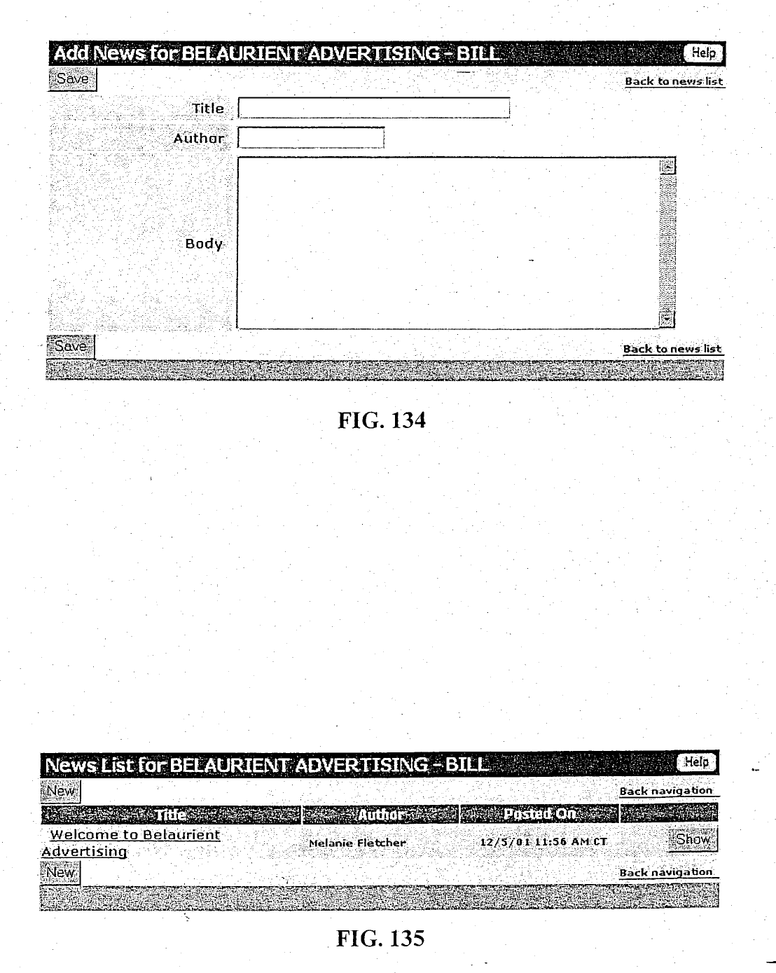

To create a new news item, click New. This will open the Add News page, as shown in FIG. 134, where you can enter information in the following fields

1) Title: the title of the news item. This will act as a link in the News section.

2) Author: your name, or the name of the item's author.

3) Body: the text of the news item.

When you are finished, click Save. The news item will be added to the News section.

To edit an existing news item, click Edit next to the item. This will open the Edit News page, where you can edit the title, author and body of the news item in the same way you created them in the Add News page. When you are finished, click Save. The edited news item will be re-inserted into the News section.

You cannot delete existing news items, but you can hide them and prevent their titles from appearing in the News section. To do this, click Hide next to the item. AdCatalog will remove the item's title from the News section, while keeping the item itself. The Hide and Edit buttons will be replaced by a Show button.

To show a hidden article, click Show. The article will be re-inserted into the News section.

Add a Corporate Logo to the Catalog Page

To add a corporate logo to the catalog page, create an HTML page that includes the logo graphic (we recommend keeping the image to 336 by 66 pixels). This page must be named title.html, otherwise AdCatalog will not recognize it as the HTML file for the Corporate Logo.

Like the Corporate Page files, the Corporate Logo files must also be uploaded to your organization directory (the topmost level of the directory system), otherwise the logo will not appear on the Catalog page. To upload the files, follow the instructions for the Corporate Page files. If you go back to the Catalog tab, your organizations logo should appear at the top of the page.

Media

Description

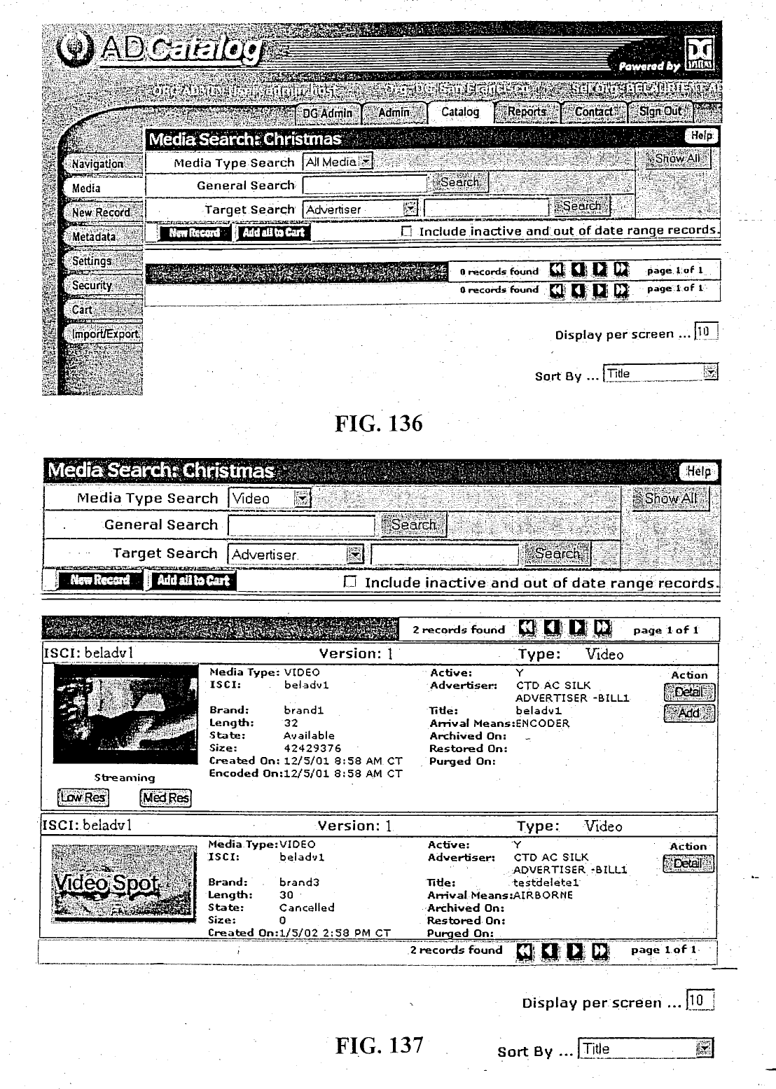

The Media function, as shown in FIG. 136, is where you can run a search on spots in a catalog, create new media records, and add spots to the Shopping Cart function for transfer to the distribution server.

The top part of the page shows three types of searches—the Media Type Search, General Search and Target Search.

1) Media Type Search—use this to search by media type (audio, video, print or all media).

2) General Search—use this to search for general terms (“30”, “Miller”, etc.)

3) Target Search—use this to search by preset parameters based on metadata fields, further specified by a field where you can enter a specific term for a parameter (e.g. Send date: Jul. 28, 2001).

You can also include inactive and excluded records in a search by checking the Include inactive and out of date range records box. To show all spots included in the catalog, click Show All. To create a new media record for a spot, click New Record.

To add all spots that were found in a search to the Shopping Cart function, click Add All to Cart. Please note that you can only add up to 20 spots to the Cart at one time—if you try to add more spots, you will see a message requesting you to decrease the number of spots to be transferred to DG Online.

FIG. 137 is an example of the media records that the user will see as a result of using the search function. Ten records is the default number to be shown on each page, and you can use the <<<>>> buttons to flip through multiple pages.

If a record contains a video spot that has been received by DG Systems, a thumbnail of the spot will be displayed on the left side of the record. Click on it to download it to your system for viewing. If you wish to watch streaming video of the spot, you can choose Low Res or Med Res, depending on whether you are using a dial-up connection or a high-speed (DSL, cable or T1) connection. If the spot has not yet been received by DG Systems, you will see a graphic that says “Video Spot” If a record contains an audio spot, you will see a graphic that says “Audio Spot”. Click on the graphic to hear the spot. If a record contains print (text or image) media, you will see a graphic that says “Print”. Click on the graphic to view the text or image in a new browser window. Each media record will show eight metadata fields (determined in the Metadata function), as well as the following fields:

1) State—the current state of the spot: (available, cancelled, purge requested)

2) Size—the size of the spot in bytes.

3) Created on—the date and time the media record for the spot was created.

4) Encoded on—the date and time the spot was encoded by the agency or studio that created the spot.

5) Archived on—the date and time the spot was archived at DG Systems

6) Restored on—the date and time the spot was restored to active status.

7) Purged on—the date and time the spot was purged from DG Systems.

Although you can only see eight metadata fields on the Media Search program, other general, organization and catalog-specific metadata may be available for a record. To view all the metadata for a spot, click Detail—this will open the Edit Record Page, where you can review all metadata fields, edit certain fields, view the spot assets, add attachments, and save your changes. You can also archive and purge a record from the Edit Record page.

Use the Add/Remove buttons to add or remove spots from the Shopping Cart function. You can also change the number of record per page by entering a chosen amount into the Display per Screen field. Use the Sort By drop-down box to select how you want spots to be sorted on the page (e.g. by advertiser, active status, etc.)

Step-by-Step

Search for Media Records

Select your search method:

1) Media Type Search—select a media type (video, audio, print or all media). AdCatalog will search the catalog for all spots that match the selected media type.

2) General Search—enter a general search term (“DG Chicago”, “McDonalds”), then click Search. AdCatalog will search the catalog for all spots that contain the search term.

3) Target Search—select a search parameter:

a. Advertiser—the advertiser represented by the spot.

b. Arrival Means—how the spot is arriving at DG Systems

c. Brand—the brand advertised in the spot.

d. DG Regions—the DG Region managing the spot.

e. ISCI—the ISCI code for a spot.

f. Length—the length in seconds of the spot.

g. Media Type—the type of spot media.

h. Print Media Name—the filename of a print/image file.

i. Send Date—the date the spot was sent to DG Systems.

j. Shipping info—shipping information for the spot.

k. Title—title of the spot.

Enter a search term for that parameter (e.g. Arrival Means: Airborne), and click Search. AdCatalog will search the catalog for all spots that contain the search term.

If you want to include inactive records and records outside of a present range in your search, check the Include inactive and out of date range records box. Or if you want to see all the spots in the catalog, click Show All.

The spots located by your search will be shown at the bottom of the page. Because a catalog can contain many spots, you can use the Sort By drop-down box to sort the spots by the following values:

1) Active—whether or not the spot is listed as active in AdCatalog.

2) Advertiser—the advertiser represented by the spot.

3) Arrival Means—how the spot is arriving at DG Systems

4) Brand—the brand advertised in the spot.

5) DG Regions—the DG Region managing the spot.

6) ISCI—the ISCI code for a spot.

7) Length—the length in seconds of the spot.

8) Media Type—the type of spot media.

9) Print Media Name—the filename of a print/image file.

10) Send Date—the date the spot was sent to DG Systems.

11) Shipping info—shipping information for the spot.

12) Title—title of the spot.

Add a Spot to the Cart

To add a spot to the Cart function for transfer to the distribution server, click the record's Add button. The spot will be added to the Cart, and the Add button will turn into a Remove button. To remove a spot that has been added to the Cart, click Remove.

If there is no Add/Remove button on a record, the record is incomplete for some reason (it has been cancelled, DG Systems hasn't received the spot yet, etc.) and cannot be added to the cart.

Create a New Record

To create a new media record for a spot, click New Record. This will open the Starting New Record page.

Add All Spots to the Shopping Cart

If you want to add all the spots from the search to the shopping cart, click Add all to Cart. All available spots will be added to the Cart function for transfer to the distribution server. To remove a spot from the Cart, click Remove on the spot's media record.

Working with a Media Record

Video Spots

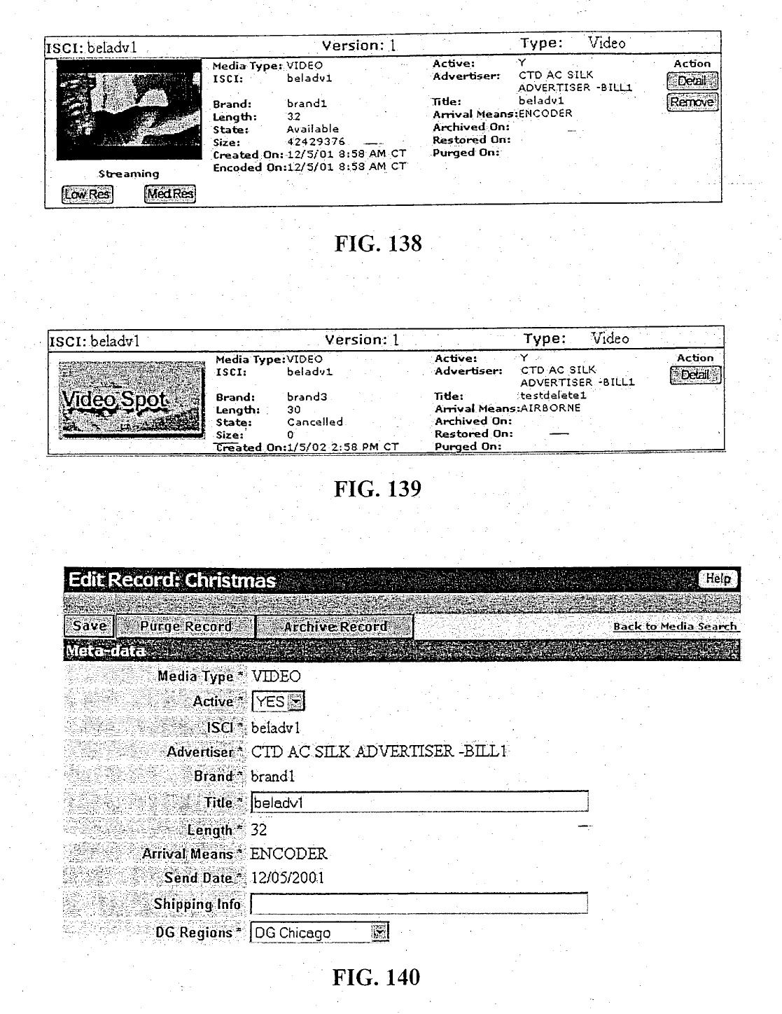

There are three types of spots—Video, Audio and Print. A media record for a Video spot that has been encoded by the creating agency and studio and received by DG Systems will look similar to the screen shot as shown in FIG. 138.

The record header contains the spot's ISCI code, the version number of the spot, and the spot's media type—in this case, Video. On the left is a thumbnail of the spot—click on it to download the spot to your system for viewing. If you want to view streaming video of the spot (you will require RealPlayer for this), click Low Res if you are accessing AdCatalog via a dial-up modem, or Med Res if you are using DSL or a T1+ line. This will open the RealPlayer application and allow you to watch the spot.

If a video spot has been cancelled or DG Systems has not received it yet, the thumbnail will be replaced by a “Video Spot” graphic and the Add/Remove button will be missing, preventing the incomplete record from being added to the Cart function, as shown in FIG. 139.

In the middle of the record are eight metadata fields, and six or seven record fields. The metadata fields have been set by the DG Administrator and/or the Organization Administrator and include metadata common to all spots in AdCatalog, as well as metadata specific to the organization and catalog.

The record fields include the following:

8) State—the current state of the spot:

a. Available—the spot is available for use.

b. To arrive—the spot has not arrived at DG Systems yet.

c. Cancelled—the spot has been cancelled and is not available.

d. Archive Requested—the spot will be archived

e. Archived—the spot is archived.

f. Purge Requested—the spot will be purged from DG Systems.

g. Purged—the spot has been purged.

9) Size—the size of the spot in bytes.

10) Created on—the date and time the media record for the spot was created.

11) Encoded on—the date and time the spot was encoded by the agency or studio that created the spot.

12) Archived on—the date and time the spot was archived at DG Systems

13) Restored on—the date and time the spot was restored to active status.

14) Purged on—the date and time the spot was purged from DG Systems.

Only eight metadata fields can be shown in a media record—to review all metadata fields, as well as edit certain fields and view the spot assets, click Detail. This will open the Edit Record Page, which is comprised of three sections—Metadata, Miscellaneous and Assets

Metadata

In the Metadata section, as shown in FIG. 140, you can review metadata fields for the record, as well as edit certain fields. The mandatory fields are:

1) Media Type—the media type of the spot (Video, Audio, Print).

2) Active—select YES if a spot is active and should show up in a search, or NO if a spot should be listed as inactive.

3) ISCI—the ISCI code of the audio or video spot.

4) Advertiser—the advertiser represented by the spot.

5) Brand—the brand advertised in the spot.

6) Title—the title of the spot. Enter a new title for the spot in this field.

7) Length—the length of the spot in seconds.

8) Arrival Means—select how the spot is arriving at DG Systems:

i. Airborne—delivered by Airborne.

ii. Courier—delivered by courier service.

iii. Encoder—delivered by encoder.

iv. FedEx—delivered by FedEx.

v. Fiber Feed—delivered by land-based fiber (Vyvx).

vi. Onhand—already at DG Systems.

vii. Unknown—other method of delivery

viii. UPS—delivered by UPS.

9) Send Date—the date and time the spot was sent to DG Systems

10) Shipping Info—shipping information about the spot.

Other metadata fields may be present, depending on what fields have been selected in the DG Systems, Organization and Catalog Metadata Dictionary Lists.

Miscellaneous

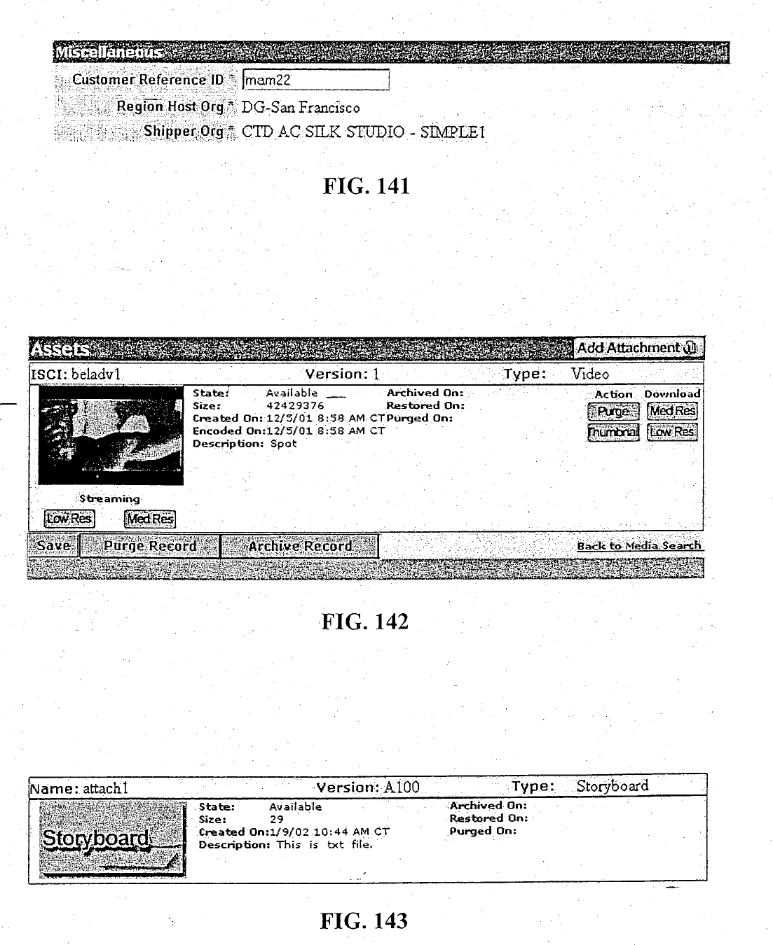

In the Miscellaneous Section, as shown in FIG. 141, you can review and/or edit the following fields:

1) Customer Reference ID—the customer reference ID number for the spot. Enter a new or revised Customer Reference ID here.

2) Region Host Org—the DG Regional organization that is administrating the spot.

3) Shipper Org—the organization that shipped the spot to DG Systems.

When you are finished making changes, click Save. The modified record will be saved in AdCatalog.

Assets

In the Assets section, as shown in FIG. 142, you can review data about the spot, click on the thumbnail (for high resolution) or the Download Med Res/Low Res buttons to download the selected version of the spot to your system for viewing, or use streaming media to watch the spot, as described on the Media Search page.

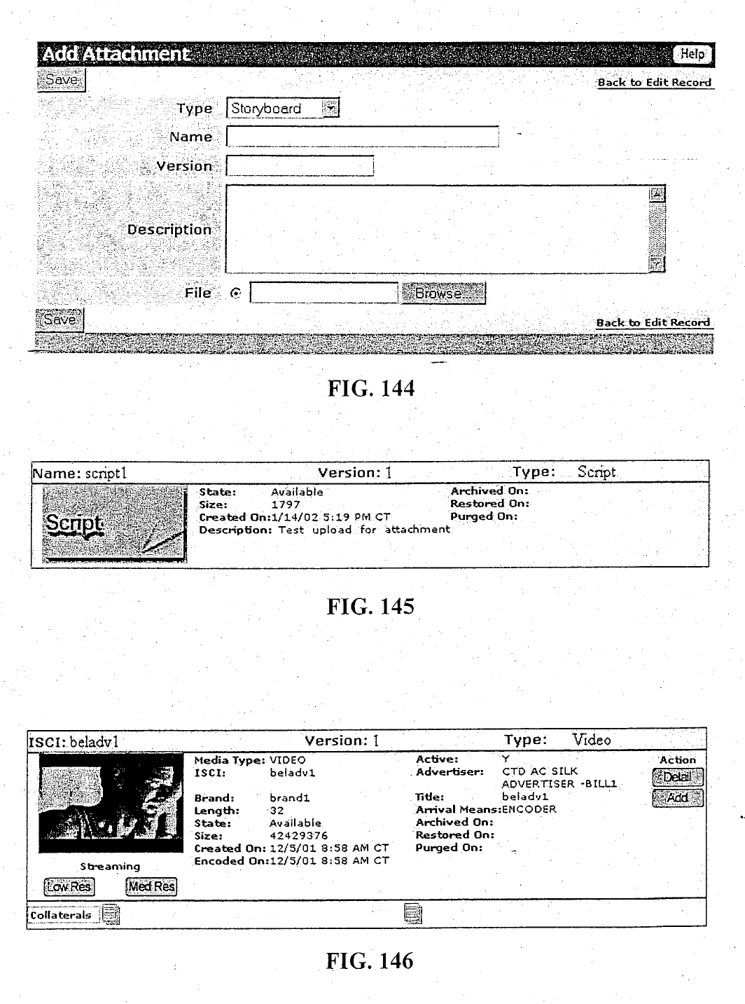

You can also view attachments—files such as scripts, storyboards, etc. that are associated with a spot. To view an attachment, click on its graphic, and the file will open in a new browser window, as shown in FIG. 143. To add an attachment (such as a storyboard or script) to the spot, click Add Attachment—this opens the Add Attachment page, as shown in FIG. 144.

Select an attachment Type (Storyboard, Script, Substantiation, CoverPage, Other) and enter a Name for the attachment, a Version number and a short Description of the attachment. In the File field, click Browse to locate the attachment file on your system.

Click Save. If successful, you will see a system message with the file name and length in bytes. Click OK. The attachment file will be uploaded to AdCatalog and attached to the media record, as shown in FIG. 145.

When you return to the Media Search page, the media record will now have another field called Collaterals, as shown in FIG. 146. Click on a page icon to open each attachment.

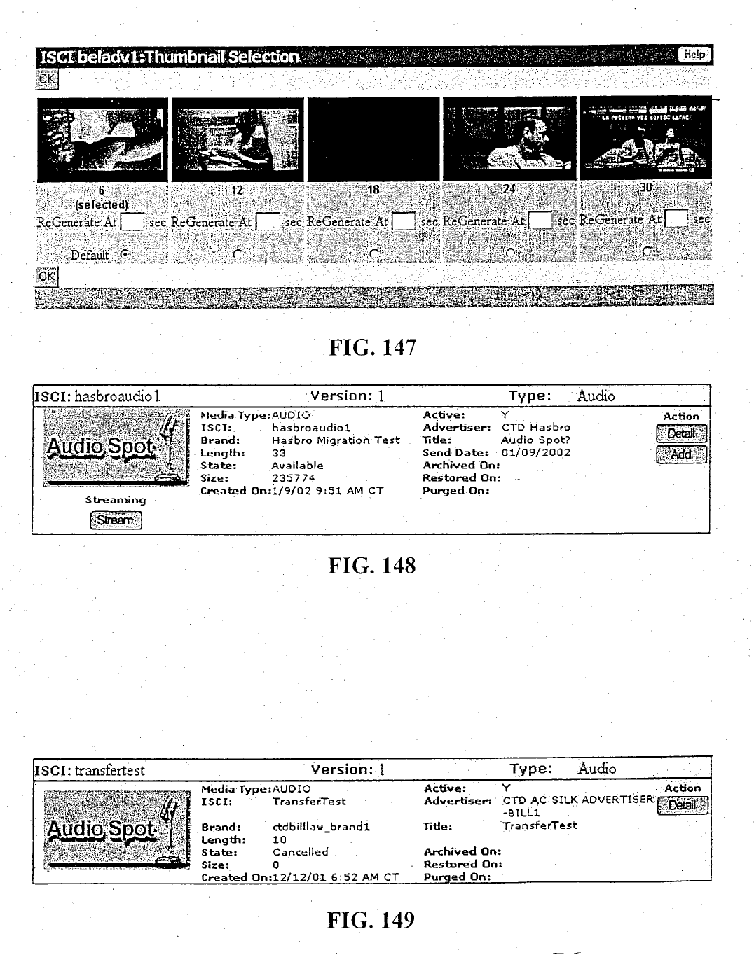

You can also use the Assets section to generate a different thumbnail for the media report. Click on Thumbnail—this opens the Thumbnail Selection page, as shown in FIG. 147.

The thumbnail currently displayed on the media record is listed as Default. To select another thumbnail, click the radio button in the selected thumbnail's frame.

If you do not like any of the available thumbnails, you can generate five new ones for review. In each frame, enter a time in seconds in the “Regenerate at [] sec” field (e.g. take sample frames from the spot at 5, 10, 15, 20 and 25 seconds). Click OK—the window will close and the “working” cursor will appear while AdCatalog samples the spot for the selected frames. When the cursor disappears, click on Thumbnail again—the Thumbnail selection page will appear with the new frames. Click the radio button for the one you want to use as a thumbnail, then click OK The new thumbnail will now appear on the media record.

Audio Spot

A media record for an Audio Spot that has been encoded by the creating agency and studio and received by DG Systems will look like the screen shot as shown in Figure The record header contains the spot's ISCI code, the version number of the spot, and the spot's media type—in this case, Audio. One the left is an Audio Spot graphic—click on it to download the spot to your system for listening. If you want to listen to streaming audio of the spot (you will require RealPlayer for this), click Stream. This will open the RealPlayer application and allow you to listen to the spot.

If an audio spot has been cancelled or DG Systems hasn't received it yet, the Stream button will not be shown and the Add/Remove button will be missing, preventing the incomplete record from being added to the Cart function, as shown in FIG. 149.

In the middle of the record are eight metadata fields, and six or seven record fields. The metadata fields have been set by the DG Administrator and/or the Organization Administrator and include metadata common to all spots in AdCatalog, as well as metadata specific to the organization and catalog.

The record fields include the following:

1) State—the current state of the spot:

a. Available—the spot is available for use.

b. To arrive—the spot has not arrived at DG Systems yet.

c. Cancelled—the spot has been cancelled and is not available.

d. Archive Requested—the spot will be archived

e. Archived—the spot is archived.

f. Purge Requested—the spot will be purged from DG Systems.

g. Purged—the spot has been purged.

2) Size—the size of the spot in bytes.

3) Created on—the date and time the media record for the spot was created.

4) Encoded on—the date and time the spot was encoded by the agency or studio that created the spot.

5) Archived on—the date and time the spot was archived at DG Systems

6) Restored on—the date and time the spot was restored to active status.

7) Purged on—the date and time the spot was purged from DG Systems.

Only eight metadata fields can be shown in a media record—to review all metadata fields, as well as edit certain fields and view the spot assets, click Detail. This will open the Edit Record Page, which is comprised of three sections—Metadata, Miscellaneous and Assets.

Metadata

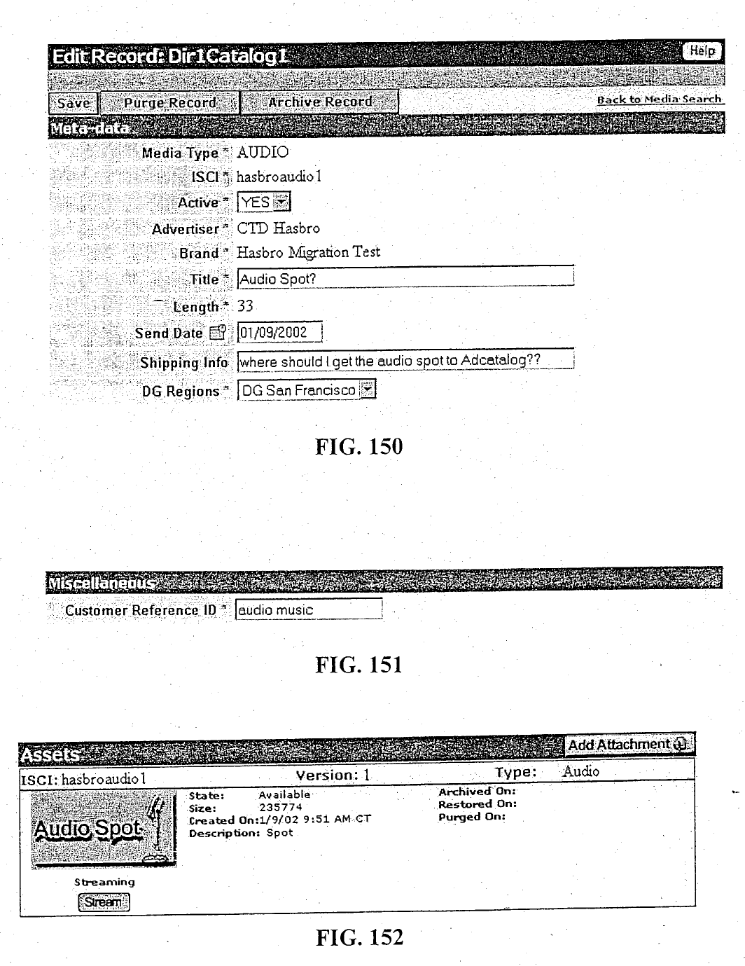

In the Metadata section, as shown in FIG. 150, you can review metadata fields for the record, as well as edit certain fields. The mandatory fields are:

1) Media Type—the media type of the spot (Video, Audio, Print).

2) Active—select YES if a spot is active and should show up in a search, or NO if a spot should be listed as inactive.

3) ISCI—the ISCI code of the audio or video spot.

4) Advertiser—the advertiser represented by the spot.

5) Brand—the brand advertised in the spot.

6) Title—the title of the spot. Enter a new title for the spot in this field.

7) Length—the length of the spot in seconds.

8) Send Date—the date and time the spot was sent to DG Systems

9) Shipping Info—shipping information about the spot.

Other metadata fields may be present, depending on what fields have been selected in the DG Systems, Organization and Catalog Metadata Dictionary Lists.

Miscellaneous

In the Miscellaneous Section, as shown in FIG. 151, you can review and/or edit the following field:

1) Customer Reference ID—the customer reference ID number for the spot. Enter a new or revised Customer Reference ID here.

When you are finished making changes, click Save. The modified record will be saved in AdCatalog.

Assets

In the Assets section, as shown in FIG. 152, you can review data about the spot, click on the Audio Spot graphic to download the selected version of the spot to your system for viewing, or use streaming media to watch the spot, as described on the Media Search page.

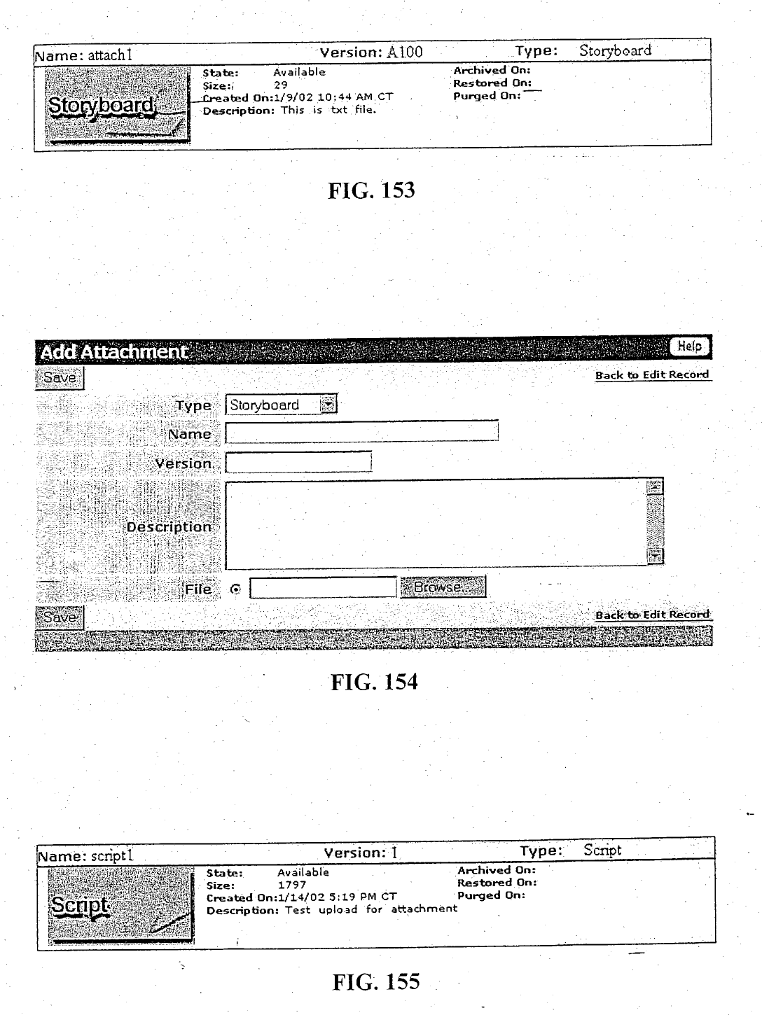

You can also view attachments—files such as scripts, storyboards, etc. that are associated with a spot. See FIG. 153. To view an attachment, click on its graphic, and the file will open in a new browser window. To add an attachment (such as a storyboard or script) to the spot, click Add Attachment—this opens the Add Attachment page, as shown in FIG. 154.

Select an attachment Type (Storyboard, Script, Substantiation, CoverPage, Other) and enter a Name for the attachment, a Version number and a short Description of the attachment. In the File field, click Browse to locate the attachment file on your system.

Click Save. If successful, you will see a system message with the file name and length in bytes. Click OK. The attachment file will be uploaded to AdCatalog and attached to the media record. See FIG. 155.

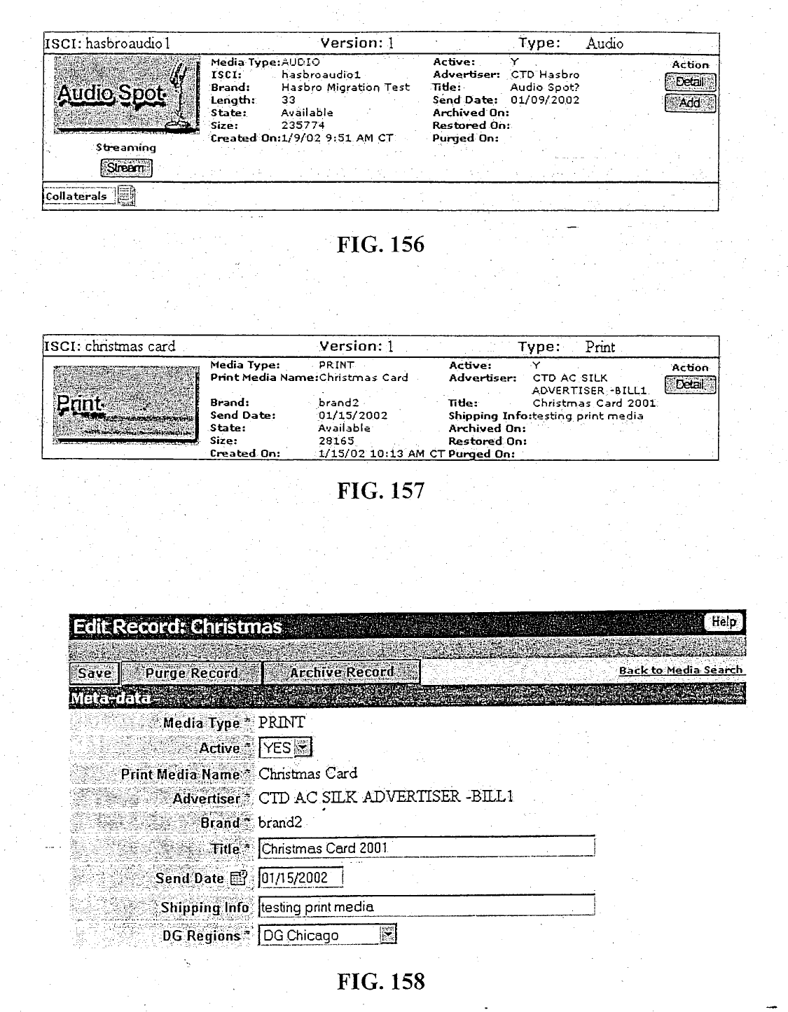

When you return to the Media Search page, the media record will now have another field called Collaterals, as shown in FIG. 156. Click on a page icon to open each attachment.

Print Spot

Unlike Video or Audio spots, Print spots are not distributed by DG Systems. However, AdCatalog hasd been designed to store print collateral materials as a way for users to catalog all material—audio, video and print—associated with an advertiser or brand. A media record for a print spot that has been received by DG Systems will look like the screen shot as shown in FIG. 157.

The record header contains the spot's ISCI code, the version number of the spot, and the spot's media type—in this case, Print. On the left is a Print Spot graphic—click on it to view the spot in a new browser window. If a print spot has not been received at DG Systems, it will look the same as the available media record. However, nothing will happen if you click on the Print Spot graphic, and the state of the record will say “To Arrive”.

In the middle of the record are eight metadata fields, and six or seven record fields. The metadata fields have been set by the DG Administrator and/or the Organization Administrator and include metadata common to all spots in AdCatalog, as well as metadata specific to the organization and catalog.

The record fields include the following:

8) State—the current state of the spot:

h. Available—the spot is available for use.

i. To arrive—the spot has not arrived at DG Systems yet.

j. Cancelled—the spot has been cancelled and is not available.

k. Archive Requested—the spot will be archived

1. Archived—the spot is archived.

m. Purge Requested—the spot will be purged from DG Systems.

n. Purged—the spot has been purged.

9) Size—the size of the spot in bytes.

10) Created on the date and time the media record for the spot was created.

11) Encoded on—the date and time the spot was encoded by the agency or studio that created the spot.

12) Archived on—the date and time the spot was archived at DG Systems

13) Restored on—the date and time the spot was restored to active status.

14) Purged on—the date and time the spot was purged from DG Systems.

Only eight metadata fields can be shown in a media record—to review all metadata fields, as well as edit certain fields and view the spot assets, click Detail. This will open the Edit Record Page, which is comprised of three sections—Metadata, Miscellaneous and Assets.

Metadata

In the Metadata Section, as shown in FIG. 158, you can review metadata fields for the record, as well as edit certain fields. The mandatory fields are:

1) Media Type—the media type of the spot (Video, Audio, Print).

2) Active—select YES if a spot is active and should show up in a search, or NO if a spot should be listed as inactive.

3) Print Media Name—the filename of a print/image file.

4) ISCI—the ISCI code of the audio or video spot.

5) Advertiser—the advertiser represented by the spot.

6) Brand—the brand advertised in the spot.

7) Title—the title of the spot. Enter a new title for the spot in this field.

8) Length—the length of the spot in seconds.

9) Send Date—the date and time the spot was sent to DG Systems

10) Shipping Info—shipping information about the spot.

Other metadata fields may be present, depending on what fields have been selected in the DG Systems, Organization and Catalog Metadata Dictionary Lists.

Miscellaneous

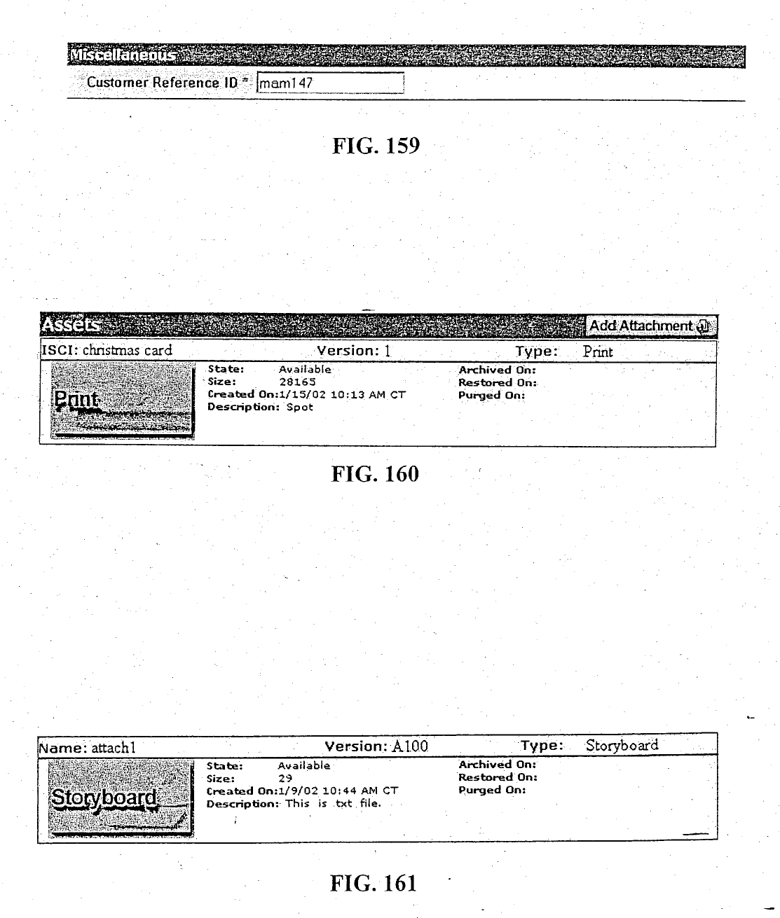

In the Miscellaneous section, as shown in FIG. 159, you can review and/or edit the following field:

1) Customer Reference ID—the customer reference ID number for the spot. Enter a new or revised Customer Reference ID here.

When you are finished making changes, click Save. The modified record will be saved in AdCatalog.

Assets

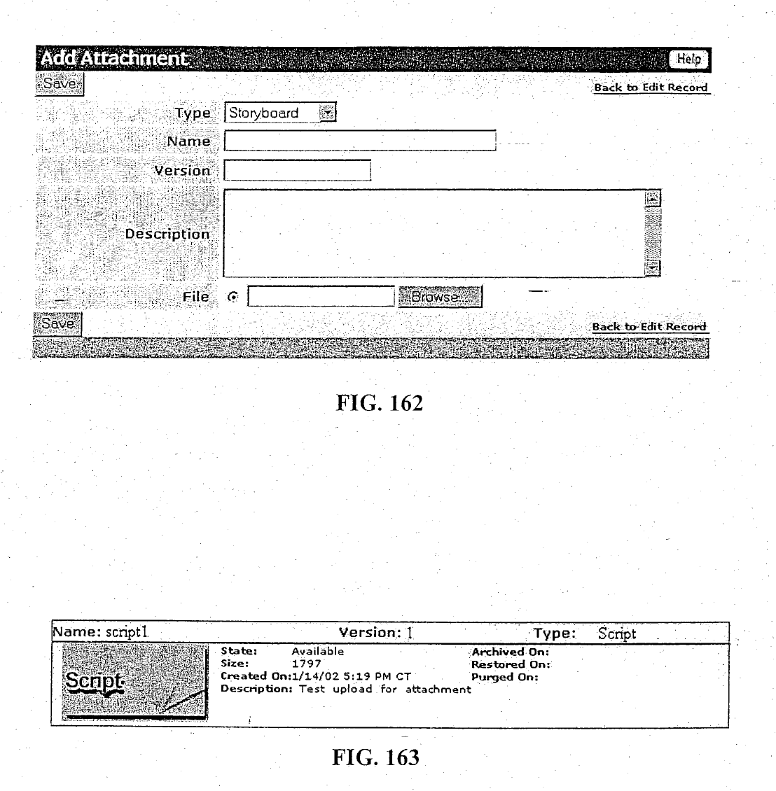

In the Assets section, as shown in FIG. 160, you can review data about the spot and click on the Print Spot graphic to view the spot in a new browser window, as described on the Media Search page. You can also view attachinents—files such as scripts, storyboards, etc. that are associated with a spot. See FIG. 160. To view an attachment, click on its graphic, and the file will open in a new browser window. To add an attachment (such as a storyboard or script) to the spot, click Add Attachment—this opens the Add Attachment page, as shown in FIG. 162.

Select an attachment Type (Storyboard, Script, Substantiation, CoverPage, Other) and enter a Name for the attachment, a Version number and a short Description of the attachment. In the File field, click Browse to locate the attachment file on your system.

Click Save. If successful, you will see a system message with the file name and length in bytes. Click OK. The attachment file will be uploaded to AdCatalog and attached to the media record. See FIG. 163.

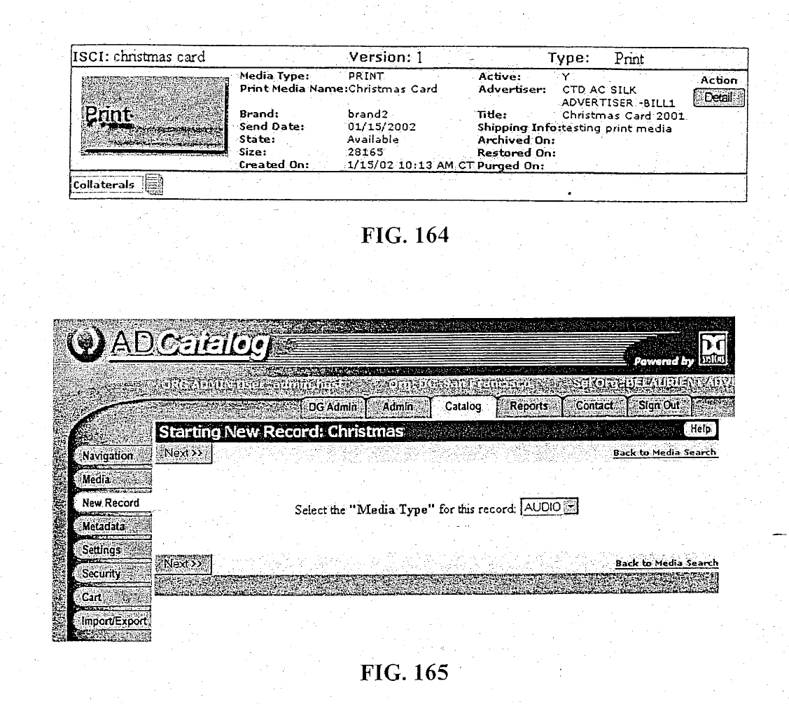

When you return to the Media Search page, the media record will now have another field called Collaterals. See FIG. 164. Click on a page icon to open each attachment.

Archive a Record

If the assets (spot, collateral materials) in a media record is not actively being used by an organization, you can archive the record. Archiving a record inactiviates it and puts its assets into storage, where they can be retrieved at a later date.

To archive a record, click Detail. This opens the Edit Record page—click Archive Record at the top or bottom of the page. A message window opens telling you that any changes to the record will not be saved, and that all assets in the record will be archived. Click OK to archive the record, or Cancel to return to the Edit Record page.

The state field of the record will change to “Archive Requested”. AdCatalog archives marked records every 24 hours—when the assets have been archived, the state field will change to “Archived”.

Purge a Record

If you want to delete old or incorrectly formatted spots from DG Systems, you can purge the spot's media record. Purging a record deletes its assets from DG Systems, and the record will be marked as inactive.

To purge a record, click Detail. This opens the Edit Record page—click Purge Record at the top or bottom of the page. A message window opens telling you that any changes to the record will not be saved, and that all assets in the record will be purged. Click OK to purge the record, or Cancel to return to the Edit Record page.

The state field of the record will change to “Purge Requested”. AdCatalog purges marked records every 24 hours—when the assets have been purged, the state field will change to “Purged”.

### New Record

Description

(DG/Organization Administrator/Read-Write User)

In the New Record function, as shown in FIG. 165, you can create new media records, assign ISCIs to records that will contain video spots and upload files for records that will contain audio and print spots.

Step-by-Step

In the Starting New Record page, select the media type for the new record—Audio, Video or Print—and click Next>>>. Some catalogs will be set up by the DG or Organization Administrator so that only certain media types can be chosen.

Video

If you selected Video, you will see the New Record page for video spots. The New Record page is comprised of three sections—Spot Metadata, Spot Miscellaneous Information, and Record Information.

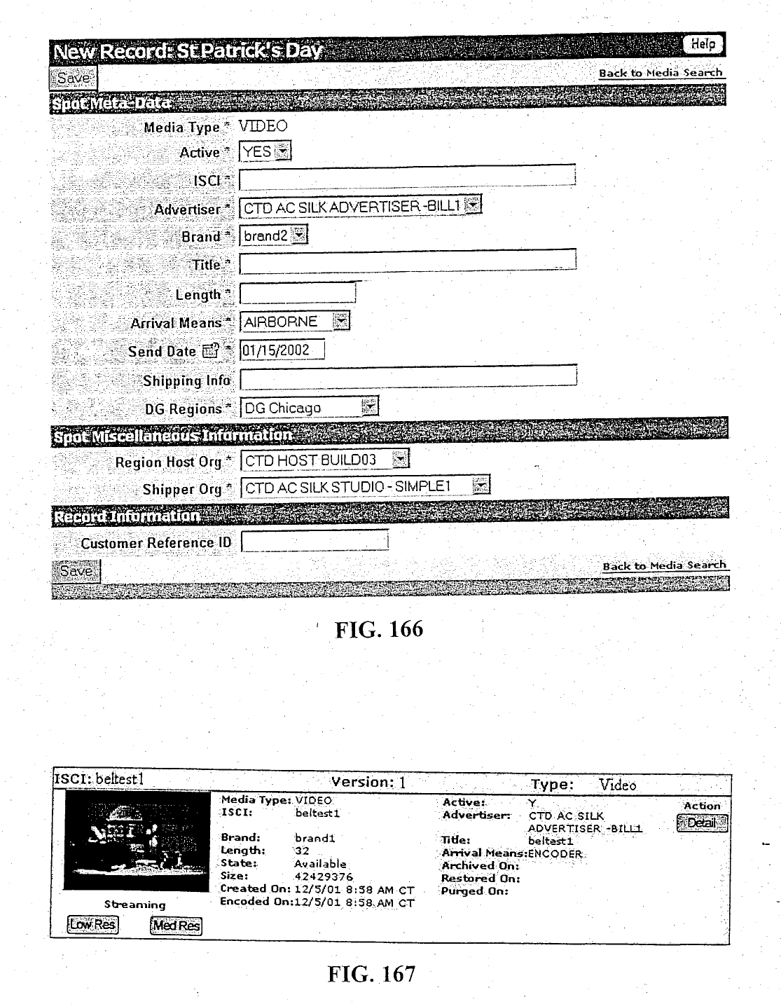

In the Spot Metadata section, as shown in FIG. 166, you can review and enter metadata fields for the spot. The mandatory fields are:

1) Media Type—the media type of the spot (Video, Audio, Print).

2) Active—select YES if a spot is active and should show up in a search, or NO if a spot should be listed as inactive.

3) ISCI—the ISCI code of the audio or video spot.

4) Advertiser—the advertiser represented by the spot.

5) Brand—the brand advertised in the spot.

6) Title—the title of the spot. Enter a new title for the spot in this field.

7) Length—the length of the spot in seconds.

8) Arrival Means—select how the spot is arriving at DG Systems:

i. Airborne—delivered by Airborne.

ii. Courier—delivered by courier service.

iii. Encoder—delivered by encoder.

iv. FedEx—delivered by FedEx.

v. Fiber Feed—delivered by land-based fiber (Vyvx).

vi. Onhand—already at DG Systems.

vii. Unknown—unknown method of delivery

viii. UPS—delivered by UPS.

9) Send Date—the date and time the spot was sent to DG Systems

10) Shipping Info—shipping information about the spot.

Other metadata fields may be present, depending on what fields have been selected in the DG Systems, Organization and Catalog Metadata Dictionary Lists.

In the Spot Miscellaneous Information section, select the Region Host Org (the DG Office that administrates the organization's spots) and the Shipping Org (the organization shipping the spot to DG Systems).

In the Record Information Section, enter the Customer Reference ID, used by the customer to classify the spot in their own organization. If there is no Customer Reference ID code for the record, AdCatalog will generate a MAM Reference ID code and use that.

When you are finished, click Save. A system message will confirm that the new record was saved—click OK. At this point, the Media Search page will open. Click Show All to view the new record. If the spot is already at DG Systems, you will see the media record with a thumbnail of the spot. See FIG. 167.

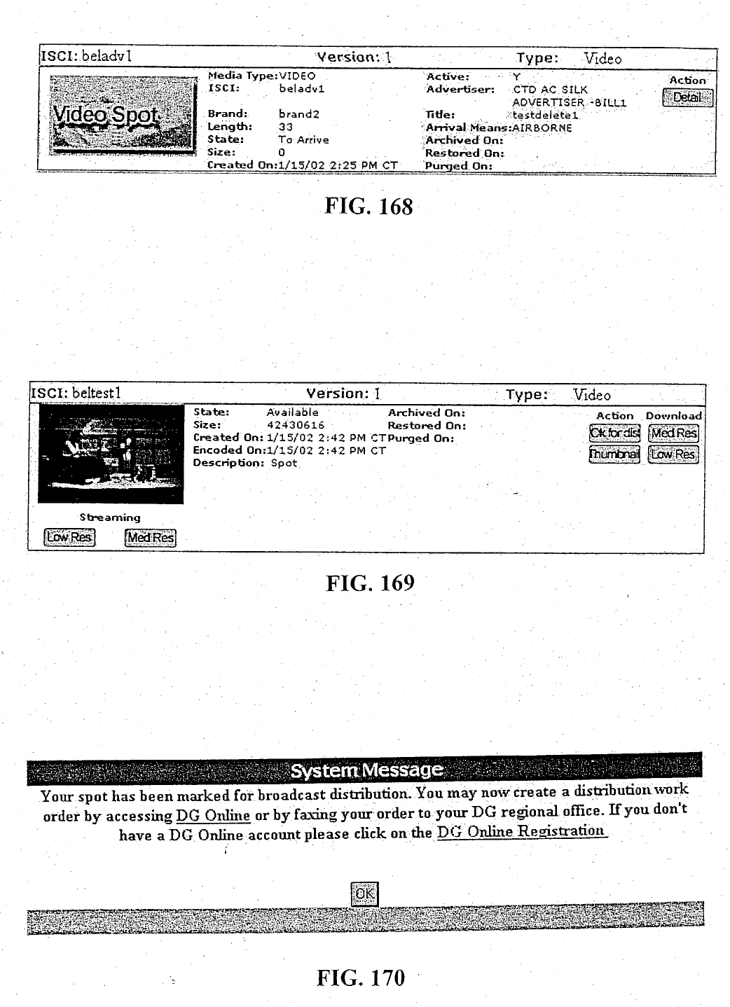

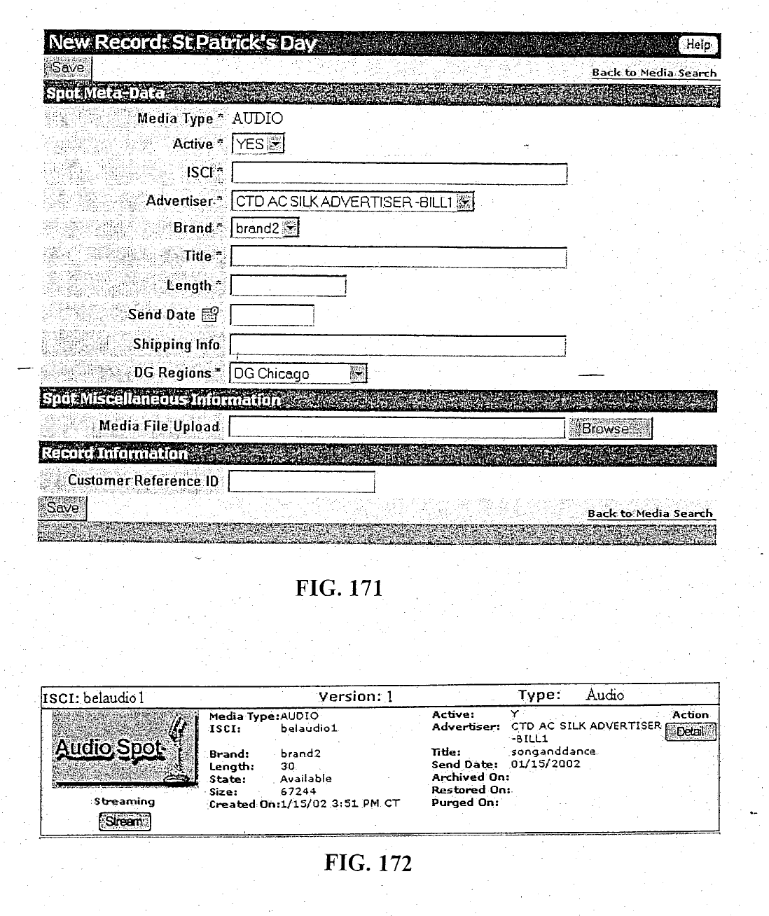

If DG Systems has not received the video spot yet, the thumbnail will be replaced by a “Video Spot” graphic and the Add/Remove button will be missing, as shown in FIG. 168. Once a spot has been received and attached to a record, you will then need to OK the record for distribution—this allows a user to add the record to the Cart for transfer to the distribution server. To do this, click Detail and scroll down to the Assets section. See FIG. 169. Click OKfor dist. The user will see a message as shown in FIG. 170. Click OK then return to the Media Search page. The record will now have an Add button, and can be added to the Cart.

Once a video spot has arrived at DG Systems, its ISCI code will either be listed in the Unmatched function or, if a media record has been created for it, assigned to its record. While a media record may have multiple collateral files, it can only contain one spot. Because of this, it is important to remember that you cannot use an ISCI code (and by inference, the video spot associated with the ISCI) in multiple media records. If you want to create multiple media records with the same video spot, each copy of the spot must have its own individual ISCI code.

Audio

If you selected Audio, you will see the New Record page for audio spots. The New Record page is comprised of tlree sections—Spot Metadata, Spot Miscellaneous Information, and Record Information.

In the Spot Metadata section, as shown in FIG. 171, you can review and enter metadata fields for the spot. The mandatory fields are:

1) Media Type—the media type of the spot (Video, Audio, Print).

2) Active—select YES if a spot is active and should show up in a search, or NO if a spot should be listed as inactive.

3) ISCI—the ISCI code of the audio or video spot. You should already have this from the organization that is shipping the spot to DG Systems.

4) Advertiser—select the advertiser represented by the spot.

5) Brand—select the brand advertised in the spot.

6) Title—the title of the spot. Enter a new title for the spot in this field.

7) Length—enter the length of the spot in seconds.

8) Arrival Means—select how the spot is arriving at DG Systems:

a) Airborne—delivered by Airborne.

b) Courier—delivered by courier service.

c) Encoder—delivered by encoder.

d) FedEx—delivered by FedEx.

e) Fiber Feed—delivered by land-based fiber (Vyvx).

f) Onhand—already at DG Systems.

g) Unknown—unknown method of delivery

h) UPS—delivered by UPS.

9) Send Date—the date and time the spot was sent to DG Systems

10) Shipping Info—shipping information about the spot.

Other metadata fields may be present, depending on what fields have been selected in the DG Systems, Organization and Catalog Metadata Dictionary Lists.

In the Spot Miscellaneous Information section, click Browse to find the audio file you want to upload on your system.

In the Record Information Section, enter the Customer Reference ID, used by the customer to classify the spot in their own organization. If there is no Customer Reference ID code for the record, AdCatalog will generate a MAM Reference ID code and use that.

When you are finished, click Save. A system message will confirm that the new record was saved—click OK At this point, the Media Search page will open. Click Show All to view the new record. See FIG. 172.

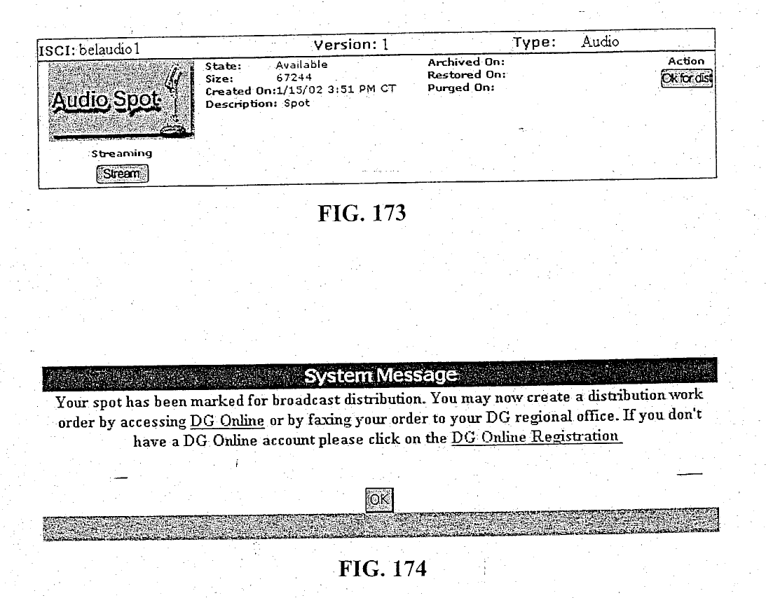

You will then need to OK the record for distribution—this allows a user to add the record to the Cart for transfer to the distribution server. To do this, click Detail and scroll down to the Assets section. See FIG. 173. Click OK for dist. The user will see a system message such as the one shown in FIG. 174. Click OK, then return to the Media Search page. The record will now have an Add button, and can be added to the Cart.

Print

If you selected Print, you will see the New Record page for print spots. The New Record page is comprised of three sections—Spot Metadata, Spot Miscellaneous Information, and Record Information.

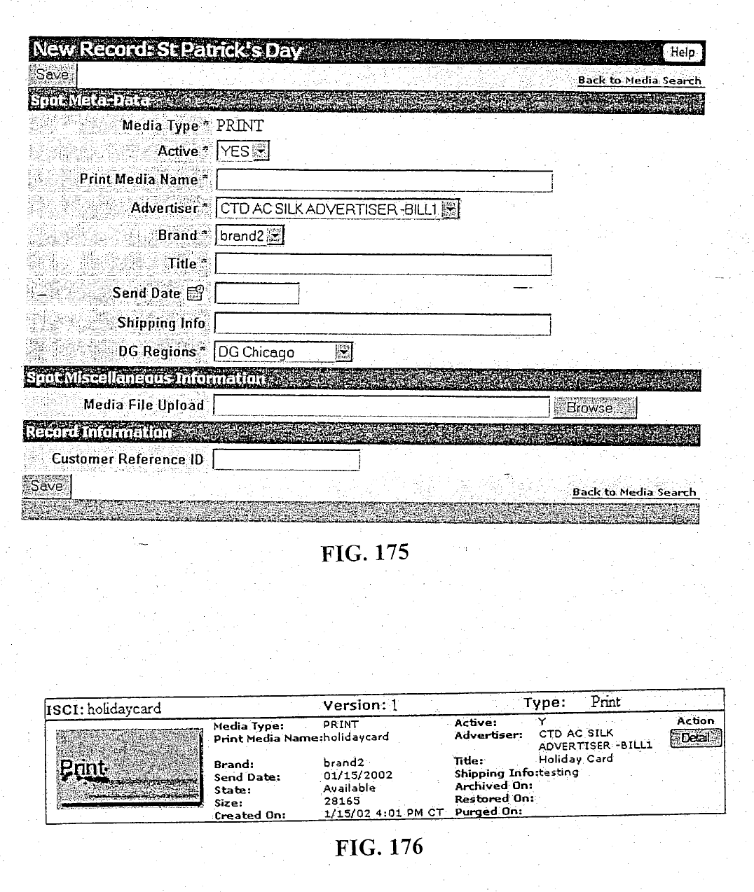

In the Spot Metadata section, as shown in FIG. 175, you can review and enter metadata fields for the spot. The mandatory fields are:

1) Media Type—the media type of the spot (Video, Audio, Print).

2) Active—select YES if a spot is active and should show Up in a search, or NO if a spot should be listed as inactive.

3) Print Media Name—enter the filename of the print/image file.

4) ISCI—the ISCI code of the audio or video spot. You should already have this from the organization that is shipping the spot to DG Systems.

5) Advertiser—select the advertiser represented by the spot.

6) Brand—select the brand advertised in the spot.

7) Title—the title of the spot. Enter a new title for the spot in this field.

8) Length—enter the length of the spot in seconds.

9) Arrival Means—select how the spot is arriving at DG Systems:

a. Airborne—delivered by Airborne.

b. Courier—delivered by courier service.

c. Encoder—delivered by encoder.

d. FedEx—delivered by FedEx.

e. Fiber Feed—delivered by land-based fiber (Vyvx).

f Onhand—already at DG Systems.

g. Unknown—unknown method of delivery

h. UPS—delivered by UPS.

10) Send Date—the date and time the spot was sent to DG Systems

11) Shipping Info shipping information about the spot.

Other metadata fields may be present, depending on what fields have been selected in the DG Systems, Organization and Catalog Metadata Dictionary Lists.

In the Spot Miscellaneous Information section, click Browse to find the print file you want to upload on your system.

In the Record Information Section, enter the Customer Reference ID, used by the customer to classify the spot in their own organization. If there is no Customer Reference ID code for the record, AdCatalog will generate a MAM Reference ID code and use that.

When finished, click Save. A system message will confirm that the new record was saved—click OK At this point, the Media Search page will open. Click Show All to view the new record. See FIG. 176.

Metadata

Description

In the Metadata function, you can modify current metadata settings and create new settings for a specific catalog. Metadata created for a specific catalog will be available in the Metadata function of other catalogs in your organization, but will not be marked as Intrinsic or used in that catalog unless a user makes it active.

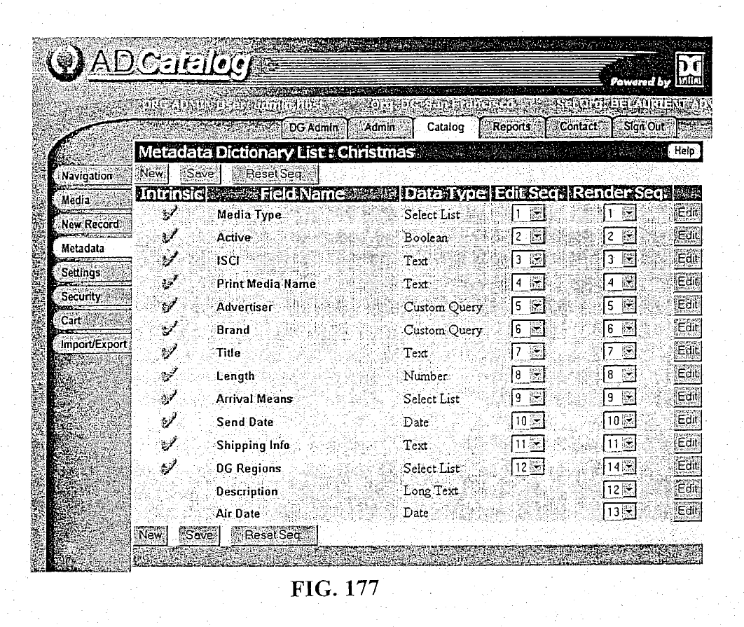

Metadata is specific information about a spot that is included in the spot's media record, and is listed in the “Metadata Dictionary List” for the catalog, as shown in FIG. 177. The Metadata Dictionary List is organized in the following columns:

1) Intrinsic—the metadata filed is active and will appear in all media records in AdCatalog.

2) Field Name—name of the field.

3) Data Type—Data type of the field. (Text, Long Text, Number, Boolean, Date, Select List).

4) Edit Seq.—how the fields are listed in the Metadata Dictionary List.

5) Render Seq.—how the fields are listed in a media record. The first eight fields will appear in the main section of a record—to see all the fields, a user will need to click “Details”.

There are eleven metadata fields that will be included in every AdCatalog media record:

1) Media Type—the media type of the spot (Video, Audio, Print).

2) Active—whether or not a spot is active and should show up in a catalog.

3) ISCI—the ISCI code of the audio or video spot.

4) Print Media Name—the filename of a print/image file.

5) Advertiser—the advertiser represented by the spot.

6) Brand—the brand advertised in the spot.

7) Title—the title of the spot.

8) Length—the length of the spot in seconds.

9) Arrival Means—how the spot is arriving at DG Systems

10) Send Date—the date and time the spot was sent to DG Systems

11) Shipping Info—shipping information about the spot.

You can also create additional metadata fields for your catalog by clicking “New”—this will start the “Add New Metadata Wizard”, where you can select what data type you wish to use for your metadata and create the metadata field itself. To edit information about a metadata field, click “Edit”—this will open the metadata field and allow you to edit it.

You can use the “Edit Seq.” and “Render Seq.” columns to determine the sequence in which the fields will be listed in the Metadata Dictionary List and a media record, respectively. Clicking on a field's position number and selecting a new position will exchange that field with the one previously in the selected position. To save these sequence changes, click Save.

Any changes made to a metadata field will not show up in AdCatalog until you log out and start a new session.

Step-by-Step

Editing an Existing Metadata Field

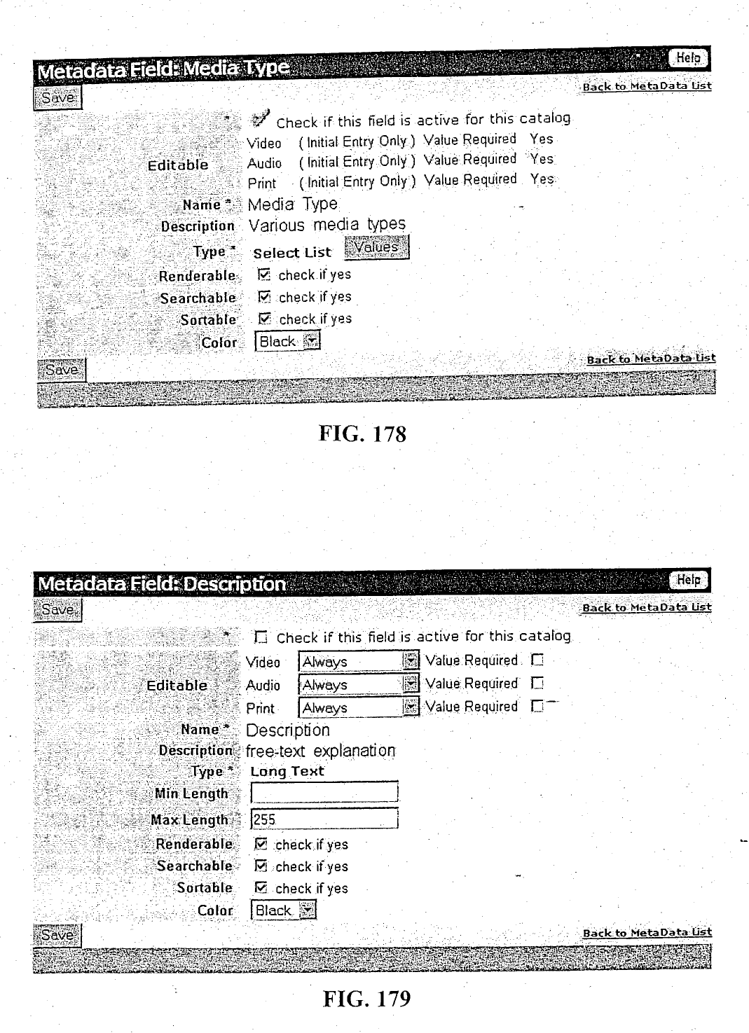

Click “Edit” in the row of the metadata field that you want to edit. This will open the “Metadata Field” page, as shown in FIG. 178.

If you are editing one of the nine metadata fields that must appear in all AdCatalog media records (e.g. Media Type), you will only be able to edit the following options:

1) Renderable—check this if the field should appear in new media records. (unchecking this box will disable the metadata field, and it won't be used in any new media records).

2) Searchable—check this if the field can act as a search parameter.

3) Sortable—check this if the field can act as a sorting parameter.

4) Color—select the color of the metadata text as it will appear in a media record. (default is black).

Once you have made your changes, click Save. Your changes will be saved and you will be returned to the Metadata List. See FIG. 179.

If you are editing a metadata field that has been created by a user, you can make changes to all the following options (the terms in parentheses refers to the data type of the metadata field—Text, Long Text, Number, Boolean, Date or Select List):

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name (all data types)—enter the name of the field (e.g. File Name).

3) Description (all data types)—enter a short description of the metadata field (e.g. filename).

4) Min. Length (Text, Long Text)—enter the minimum character length of text.

5) Max. Length (Text, Long Text)—enter the maximum character length of text.

6) Min Value (number)—enter the minimum number of characters in field.

7) Max Value (number)—enter the maximum number of characters in field.

8) Min Date (date)—enter a start date for the metadata activity. Click on the Calendar icon, if needed, to find and select a date.

9) Max Date (date)—enter an end date for the metadata activity. Click on the Calendar icon, if needed, to find and select a date.

10) Renderable (all data types)—check this if the field should appear in new media records (unchecking this box will disable the metadata field, and it won't be used in any new media records.)

11) Searchable (all data types)—check this if the field can act as a search parameter.

12) Sortable (all data types)—check this if the field can act as a sorting parameter.

13) Color—select the color of the metadata text as it will appear in a media record (default is black).

When editing a Data metadata field, you can edit additional fields, Relative Restrictions, Restrict Display on condition, and Restrict Add to Cart on condition.

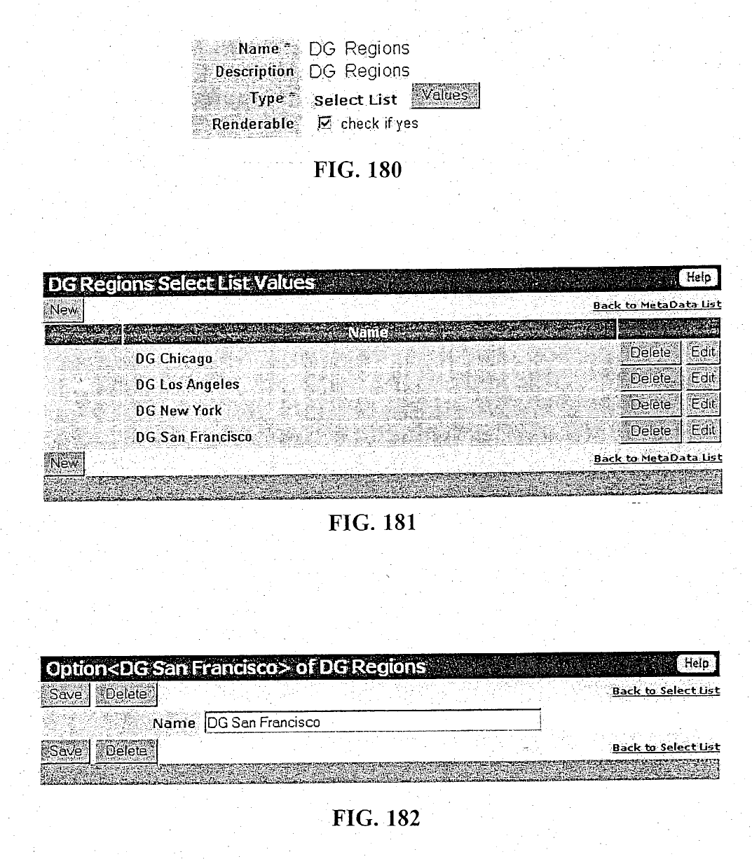

When editing a Select List metadata field, you may want to edit or delete list values in the select list. See FIG. 180. To do this, click “Values”—this will open the “Select List Values” page, as shown in FIG. 181. To delete a list value from the select list, click “Delete”. To edit a list value, click “Edit”—this will open the value and you can edit the name of the list value in the Name field. See FIG. 182. To save your changes, click Save. To delete this list from the select list, click Delete.

Creating a New Metadata Field

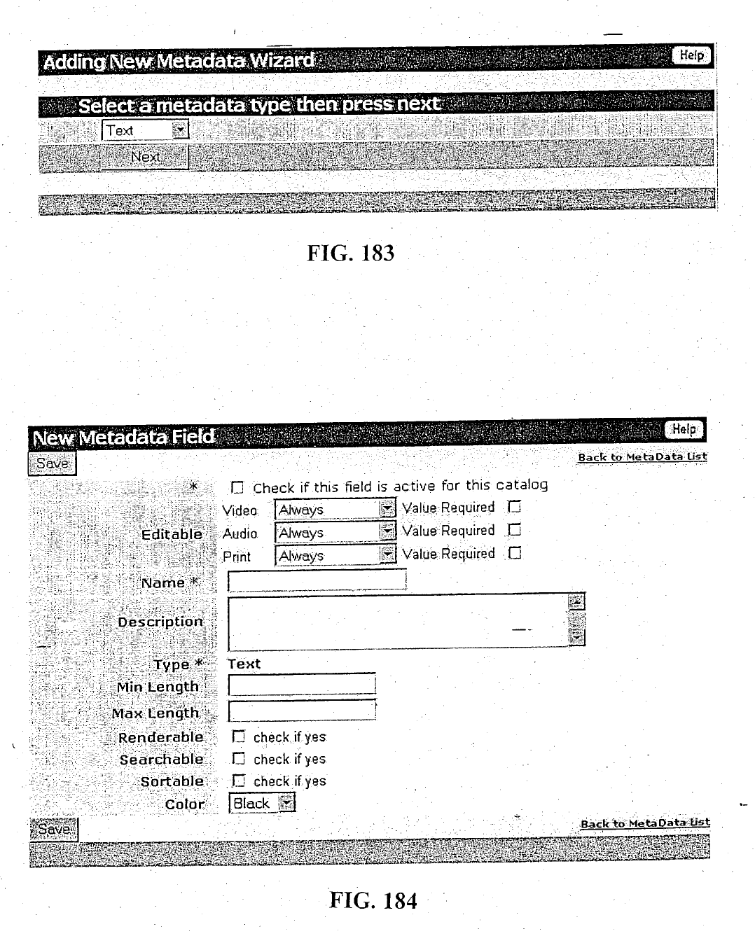

Click New on the Metadata Dictionary List. This will start the Add New Metadata Wizard, as shown in FIG. 183. From the drop-down box, select a metadata type:

1) Text—a field that contains short text (e.g. filename).

2) Long Text—a field that contains longer text (e.g. instructions, comments).

3) Number—a field that contains numbers (e.g. phone numbers, fax number).

4) Boolean—a drop-down box with Yes/No choices (e.g. Active—yes or no.)

5) Date—a field where you can set minimum and maximum dates for an activity (e.g. flight dates).

6) Select List—a drop-down box with multiple choices (e.g. business partners, campaigns).

Click Next. This will open the New Metadata Field page, where you can complete the new metadata field.

New Metadata Field—Text

If this field should be used throughout the catalog, check the Check if this field is active for this catalog box. See FIG. 184

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. File Name).

3) Description—enter a short description of the metadata field (e.g. filename).

4) Type—Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Long Text

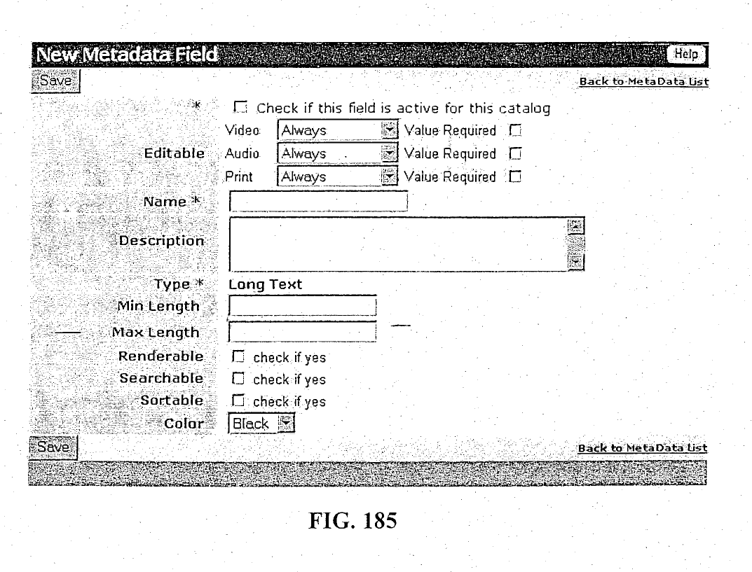

If this field should be used throughout the catalog, check the Check if this field is active for this catalog box. See FIG. 185.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never”if the metadata field should never be used for the media type at all (e.g. a Print record would not need an Air Date metadata field.) Check “Value Required” if the field should be available when creating a new record.

2) Name—enter the name of the field (e.g. Air Information).

3) Description—enter a short description of the metadata field (e.g. instructions for airing the spot).

4) Type Long Text.

5) Min. Length—minimum character length of text.

6) Max. Length—maximum character length of text.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Number

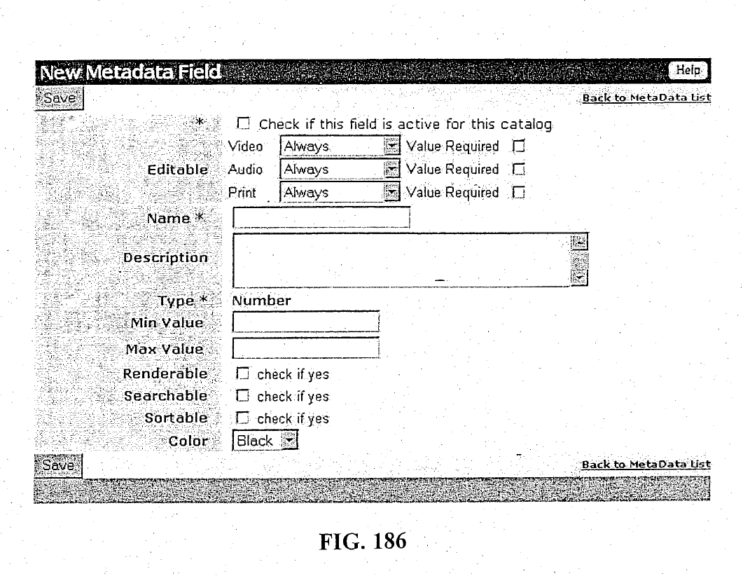

If this field should be used throughout the catalog, check the Check if this field is active for this catalog box. See FIG. 186.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Order ID).

3) Description—enter a short description of the metadata field (e.g. AdCatalog order ID number).

4) Type—Number.

5) Min. Value—minimum number of characters in field

6) Max.Value—maximum number of characters in field.

7) Renderable—check this if the field should appear in new media records (unchecking this box will disable the metadata field, and it won't be used in any new media records.)

8) Searchable—check this if the field can act as a search parameter.

9) Sortable—check this if the field can act as a sorting parameter.

10) Color—select the color of the metadata text as it will appear in a media record (default is black).

Click Save to save all changes and return to the Metadata List. Click Back to Metadata List if you do not want to make or save any changes.

New Metadata Field—Boolean

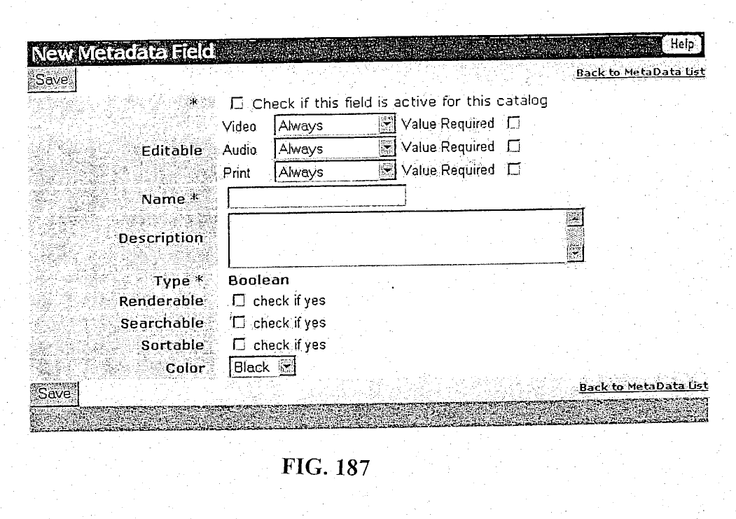

If this field should be used throughout the catalog, check the Check if this field is active for this catalog box. See FIG. 187.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Active).

3) Description—enter a short description of the metadata field (e.g.yesavailable; no—unavailable).

4) Type—Boolean.

5) Renderable—check this if the field should appear in new media records (unchecking this box will disable the metadata field, and it won't be used in any new media records.)

6) Searchable—check this if the field can act as a search parameter.

7) Sortable—check this if the field can act as a sorting parameter.

8) Color—select the color of the metadata text as it will appear in a media record (default is black).

Click Save to save all changes and return to the Metadata List. Click Back to Metadata List if you do not want to make or save any changes.

New Metadata Field—Date

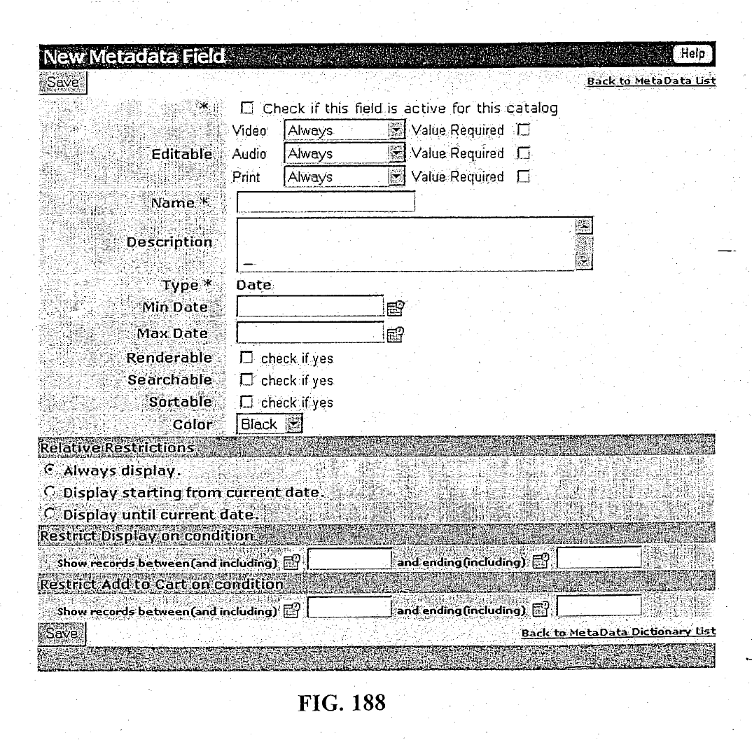

If this field should be used throughout the catalog, check the Check if this field is active for this catalog box. See FIG. 188.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. Flight Date).

3) Description—enter a short description of the metadata field (e.g. flight date for spot).

4) Type—Date.

5) Min. Date—enter a start date for the metadata activity. Click on the Calendar icon, if needed, to find and select a date.

6) Max. Date—enter an end date for the metadata activity.

7) Renderable—check this if the field should appear in new media records (unchecking this box will disable the metadata field, and it won't be used in any new media records.)

8) Searchable check this if the field can act as a search parameter.

9) Sortable—check this if the field can act as a sorting parameter.

10) Color—select the color of the metadata text as it will appear in a media record (default is black).

11) Relative Restrictions:

a. Always Display—click this if the record should always be displayed in the Media Search function.

b. Display starting from current date—click this if the record should only be displayed in the Media Search function starting from the current date.

c. Display until current date—click this if the record should be compared against the Expiration date metadata field. If that date has been reached, the record should not be displayed.

12) Restriction Display on Condition—use this field to remove old records from display by selecting records created between certain dates.

13) Restrict Add to Cart on Condition—use this field to restrict old records from being added to the Cart by selecting records created between certain dates.

Click Save to save all changes and return to the Metadata List. Click Back to Metadata List if you do not want to make or save any changes.

New Metadata Field—Select List

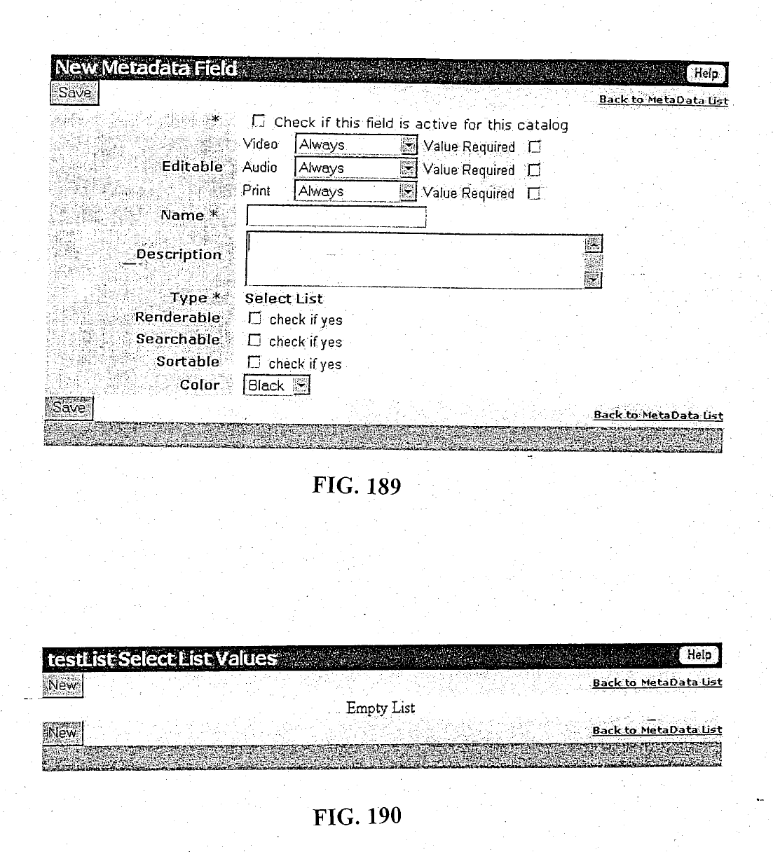

If this field should be used throughout the catalog, check the Check if this field is active for this catalog box. See FIG. 189.

1) Editable—use Editable to determine whether the metadata field can be edited when used for various media types. Choose “Always” if the metadata field should always be editable, “Initial Entry Only” if the metadata field should only be editable when a record is first created (e.g. ISCI codes), and “Never” if the metadata field should never be used for the media type at all (e.g. a Print record would not need an Air Date metadata field.) Check “Value Required” if the field should be available when creating a new record.

2) Name—enter the name of the field (e.g. DG Regions).

3) Description—enter a short description of the metadata field (e.g. DG Regions to administrate spot).

4) Type—Select List.

5) Renderable—check this if the field should appear in new media records (unchecking this box will disable the metadata field, and it won't be used in any new media records.)

6) Searchable—check this if the field can act as a search parameter.

7) Sortable—check this if the field can act as a sorting parameter.

8) Color—select the color of the metadata text as it will appear in a media record (default is black).

Click Save. This will open a page called (fieldname) Select List Values, where you can enter values for your list, as shown in FIG. 190.

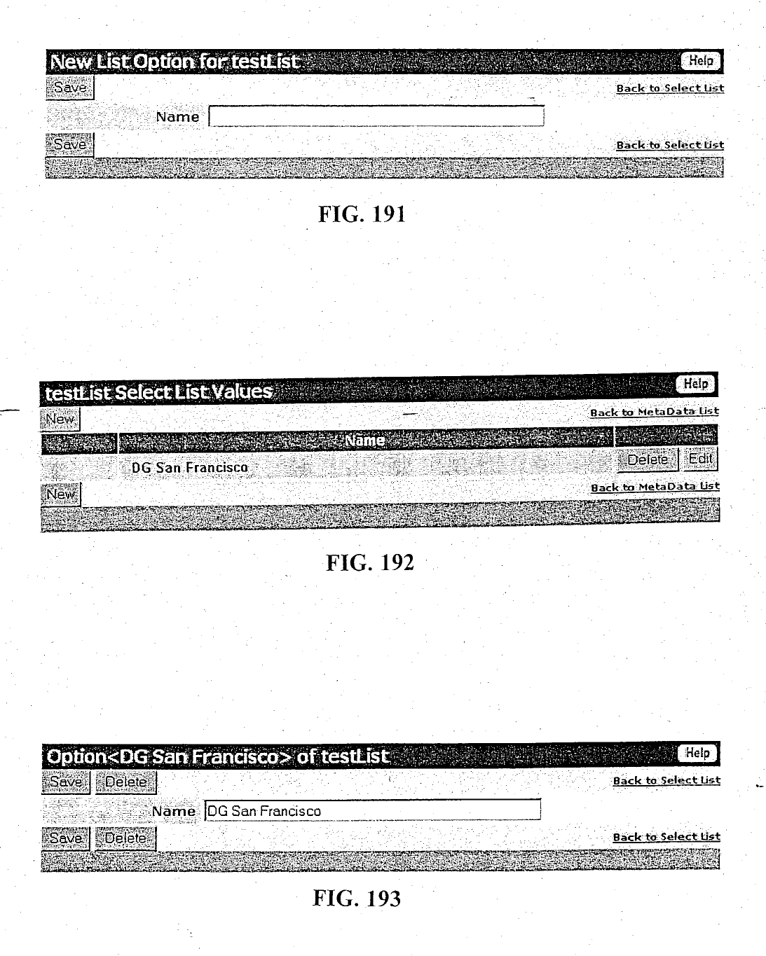

Click New. This will open the New List Option for (fieldname) page, as shown in FIG. 191.

Enter the name of the list value (e.g. San Francisco) in the Name field, then click Save. This will return you to the Select List Values page, where the new list value will appear, as shown in FIG. 192. Continue the process until you have added all the list values to the select list. To delete a list value, click Delete. To edit the name of a list value, click Edit—this will open the value, and you can edit the name of the list value. See FIG. 193. To save your changes, click Save. To delete the list value, click Delete.

Once you have added all the list values to the select list, click Back to Metadata List to return to the Metadata List.

Change the Editing Sequence

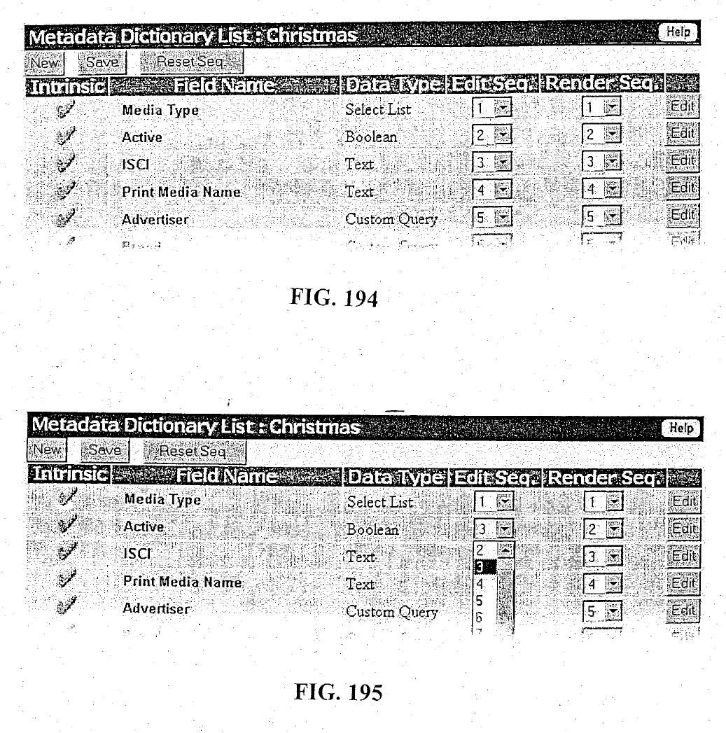

In the Edit Seq. columns, as shown in FIG. 194, you can determine the sequence in which the fields will be listed in the Metadata Dictionary List. Click on a field's position number and select a new position. See FIG. 195. Click Save. This will exchange the field with the one previously in the selected position. See FIG. 196.

Change the Rendering Sequence

As with the Edit Seq. column, in the Render Seq. columns, you can determine the sequence in which the fields will be listed in a media record. Click on a field's position number and select a new position. Click Save. This will exchange the field with the one previously in the selected position. If you have not clicked Save and want to undo a sequence change, click Reset Seq. This will restore the original sequence in both columns.

Settings

Description

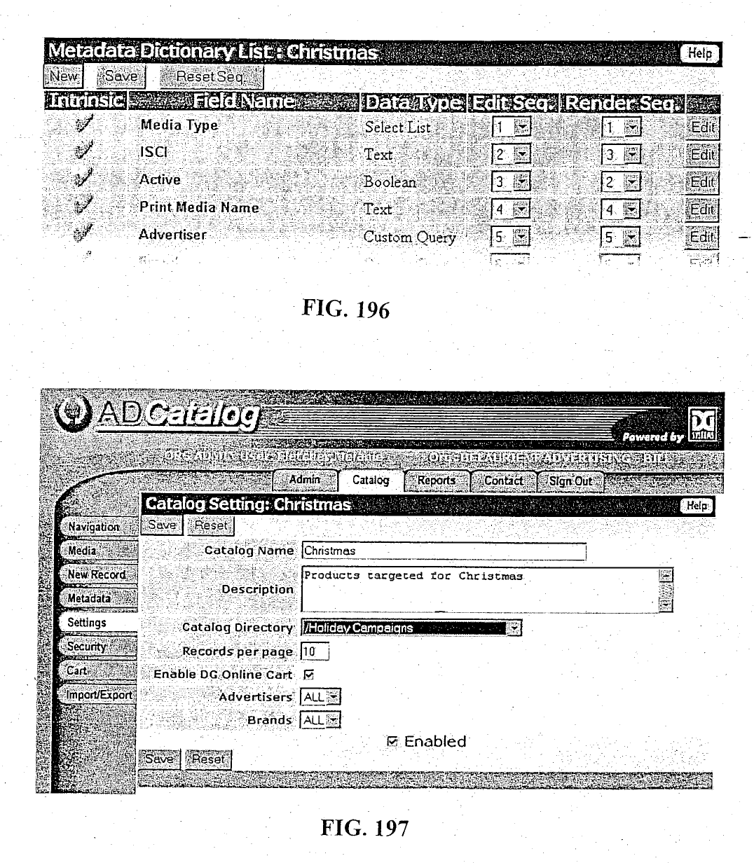

In the Settings function, as shown in FIG. 197, you can edit the settings for a catalog such as the catalog description, the directory location of the catalog, etc. You can also use Settings to enable or disable a catalog—disabled catalogs do no appear on the Navigation page.

Step-by-Step

Edit the following information:

1) Catalog Name—edit the name of the catalog.

2) Description—edit the description of the catalog.

3) Catalog Directory—select another directory location for the catalog

4) Records per page—edit the number of media records that appear on the Media Search Page.

5) Enable the DG Online Cart—check this to allow spots to be transferred from the catalog to DG Online via the Cart function.

6) Advertisers—select an advertiser or advertisers whose spots will be stored in the catalog.

7) Brands—select a brand or brands for the catalog.

Click Save to save your changes.

At the bottom of the page, Enabled is checked when the catalog is active and visible on the Navigation page. To inactivate the catalog, uncheck Enabled, then click Save. The catalog will no longer be visible on the Navigation Page.

To re—enable a disabled catalog, click on the Admin tab, then on the Catalogs function. Click on the disabled catalog in the directory system—this will open the Navigation page. The disabled catalog will be shown in black boldface with a yellow dot. Click on the Settings function and check the Enabled box, then click Save. The catalog will be enabled and added to the Navigation page.

Click Reset to delete your changes and reinsert the former settings.

Security

In the Security function, as shown in FIG. 199, a DG, Organization or Catalog Administrator can edit the security settings of users in a Catalog group, and a Read/Write or Read-Only User can view the security settings of users in a Catalog group.

Adding a User to a Catalog Group

A catalog group is automatically generated when a catalog is created, and users are assigned by the Organization Administrator. Each catalog group has the following security levels:

1) Admin—an Admin user can create and edit directories and catalogs, the Corporate page, organizational and catalog-specific metadata, create/import/export media records, attach spots to records and transfer spots to DG Online.

2) Read/Write—a read/write user can create/import/export media records, attach spots to records and transfer spots to DG Online.

3) Read Only—a Read Only user can only view catalog data.

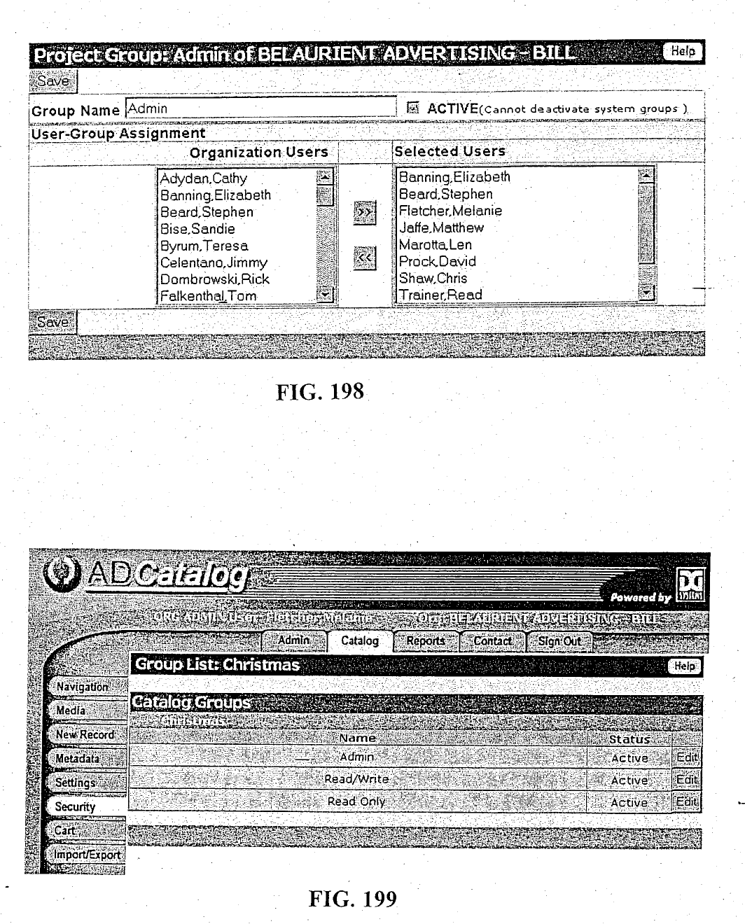

To add a user to a group, click Edit. This will open a page where you can add or remove users from a group, as shown in FIG. 198.

The Group Name lists the name of the group, and the ACTIVE checkbox shows whether or not the group is active within the organization (Catalog groups are default active).

To add a user or users to the group, find the user in the Organization Users List—this list contains all users that were added to the organization in the User function. Click on a user to highlight his or her name, the click the >> button to add the user to the Selected Users List. To remove a user from the Selected Users list, click on his or her name to highlight it, the click the << button to remove the user. Click Save to save your changes.

If you are a Read/Write or Read Only user and need to have additional users added to the group, contact your Organization Administrator.

Cart

Description

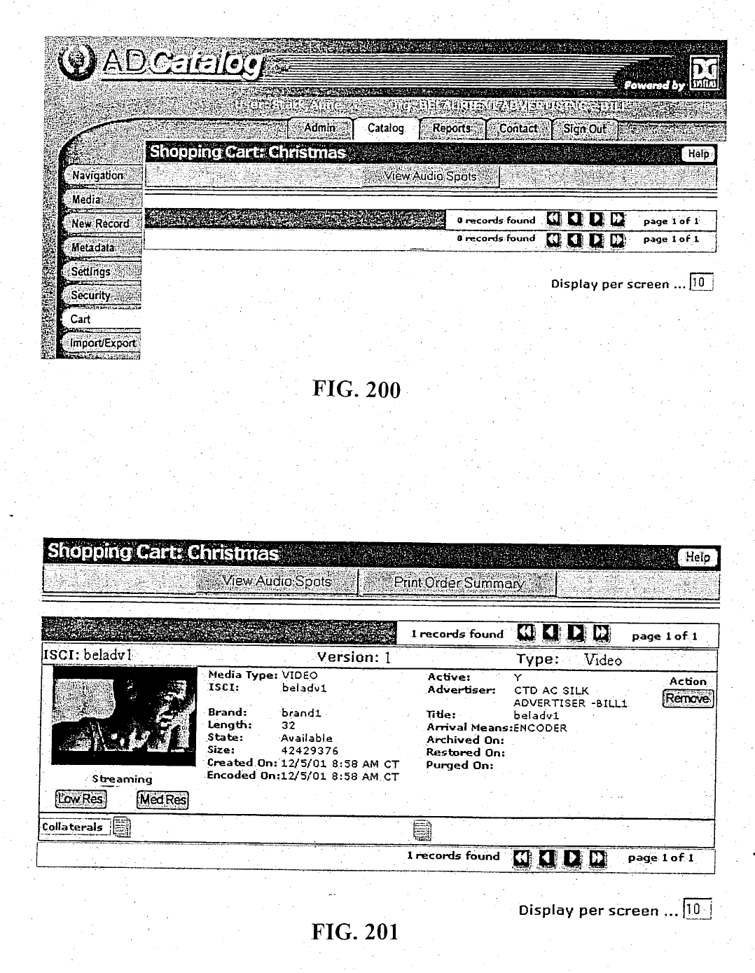

In the Shopping Cart function, as shown in FIG. 200, you can view audio and video spots that have been marked for transfer to DG Online.

Step-by-Step

Audio and video spots are shown on separate pages—to see audio spots that have been added to the cart, click View Audio Spots. To see video spots that have been added to the cart, click View Video Spots. If no audio or video spots have been added to the cart, no records will appear on the page. If a spot has been added to the cart, the Shopping Cart will look like the screen shot as shown in FIG. 201.

As with the Media function, you can download a video spot or view it in streaming video, download an audio spot or listen to it in streaming audio, and view any collateral files associated with the spot. If the spot should not be transferred to DG Systems, click Remove, and the spot will be removed from the Cart.

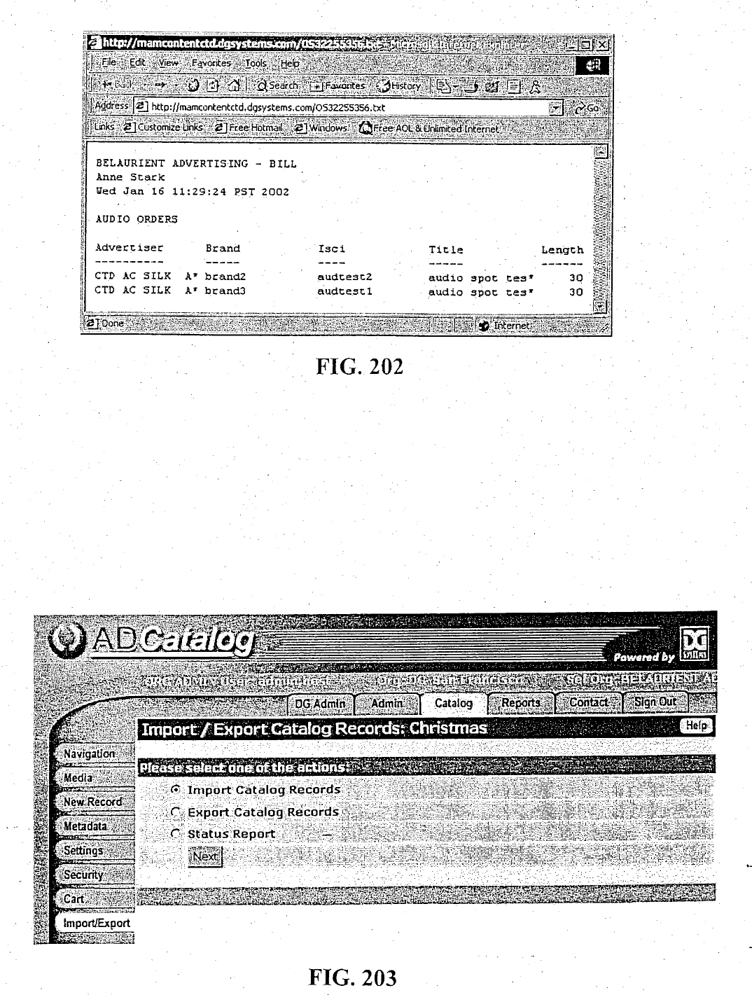

You can also print out an order summary for the spot. Click Print Order Summary—a text file will be opened in a new browser window, as shown in FIG. 202. The file will include your organization, yourself, the date and time (PST) the summary was generated, and Advertiser, Brand, ISCI, Title and Length information on each spot. Print or save this page for your records.

If you want to view all spots in your organization currently marked for distribution, click on the Reports tab, then the Spots for dist function. A list of all spots currently in the cart and marked for distribution will be shown.

Import/Export

Description

In the Import/Export function, as shown in FIG. 203, you can import catalog records to a different catalog, export catalog records as text files to your system, and generate a status report on all imports and exports.

Step-by-Step

Import a Catalog File

Click the radio button next to the Import Catalog Records field, then click Next.

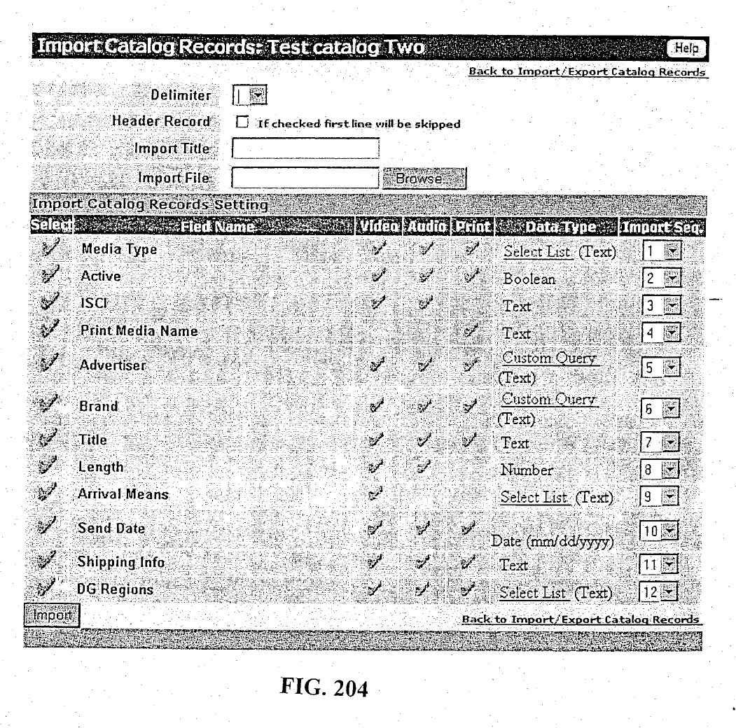

In the Import Catalog Record page, as shown in FIG. 204, enter the following information:

1) Delimiter—choose the delimiter used to separate fields in your user file: |, # or ˜.

2) Header Record—check this if the first line in your file is a head or file name. AdCatalog will then skip it.

3) Import Title—enter the title of the imported user file. This will appear in the Status Report.

4) Import File—enter the location of the imported user file, or click Browse to locate the import file on your system.

In the Import Catalog Records Setting table, the metadata fields are the Intrinsic fields listed in the sequence set in the metadata function. If the record you want to import has metadata fields in a different sequence than your catalog (e.g. the Media Type field is the second field instead of the first), reset the field sequence using the Import Seq. column.

Click Import. The request will be sent to DG Systems, and the status of the request can be viewed in the Status Report function. If the records are successfully imported, they will appear in the Media function.

Export a Catalog File

Click the radio button next to the Export Catalog Records field, then click Next.

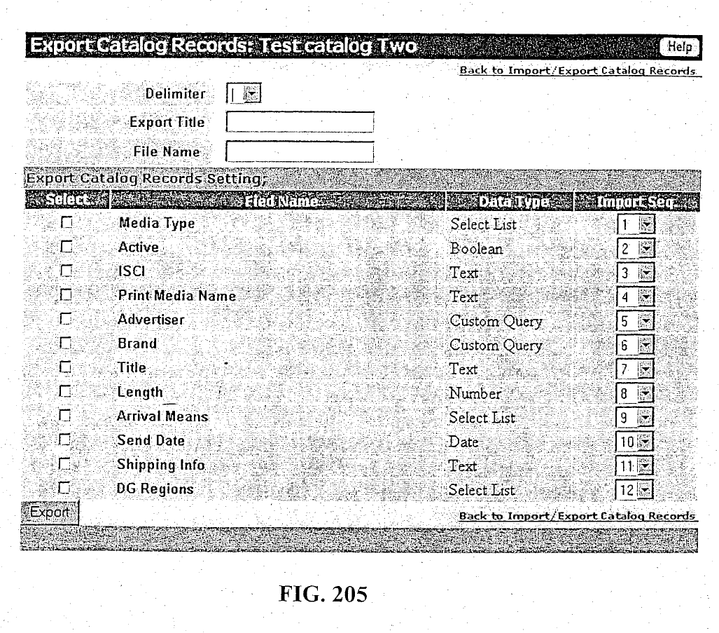

In the Export Catalog Record page, as shown in FIG. 205, enter the following information:

1) Delimiter—choose the delimiter used to separate fields in your user file: |, # or ˜.

2) Export Title—enter the title of the exported user file. This will appear in the Status Report.

3) Filename—enter a filename of the exported record.

In the Export Catalog Records Setting table, the metadata fields are the Intrinsic fields listed in the sequence set in the metadata function. Click the check box next to every field you want to include in the exported record. If you want to arrange the metadata fields in a different sequence (e.g. put the Media Type field as the second field instead of the first), reset the field sequence using the Import Seq. column.

Click Export. The request will be sent to DG Systems, and the status of the request can be viewed in the Status Report function.

View the Import/Export Status Report

Click the radio button next to the Status Report field, then click Next.

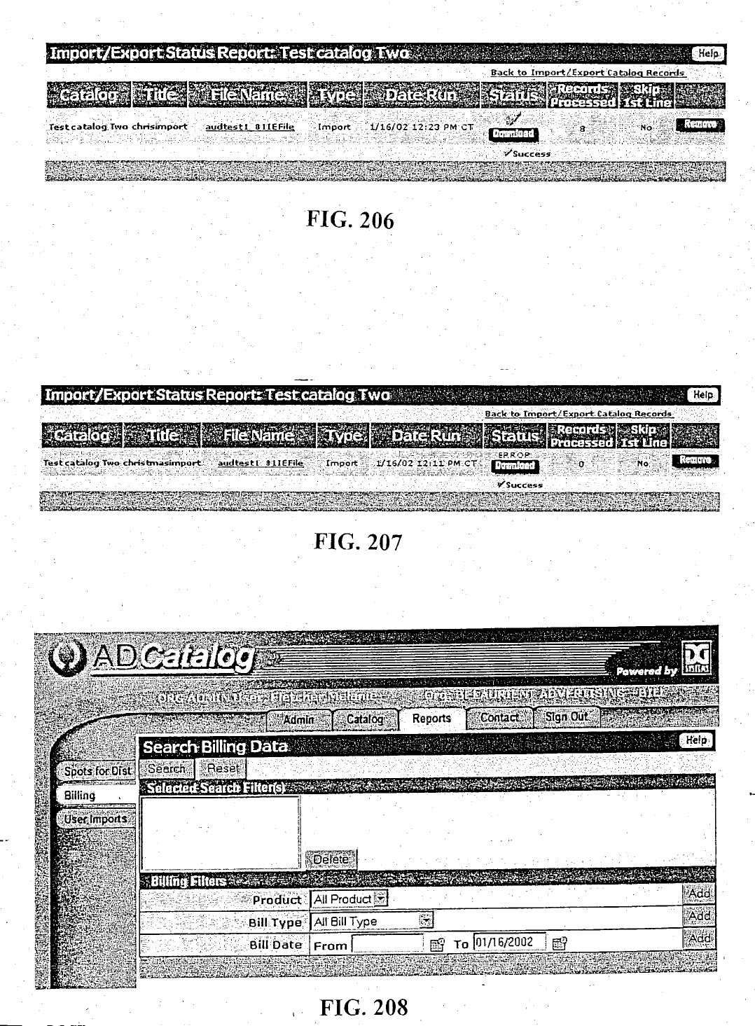

An Import/Export Status Report for the catalog will appear in table format, as shown in FIG. 206. The table will show the following information:

1) Catalog—the name of the catalog.

2) Title—the title of the record being imported or exported.

3) File Name—the filename of the record. Click on it to open the file in a new browser window.

4) Type—import or export.

5) Date Run—the time and date the import or export occurred.

6) Status—the status of the import/export. If the import/export was successful, the catalog file will be marked with a green check. Click the Download button to open the exported catalog file in a new browser window—save the file to your system for use in importing to another catalog. You can also download imported catalog files for review and editing. If the import/export was unsuccessful, the catalog file will be marked with an ERROR.

7) Records processed—the number of records imported or exported.

8) Skip 1^{st} Line—whether or not the first line of the record file was skipped.

If a file has not been successfully imported to a catalog, the Status Report will show this with an ERROR message in the Status field, as shown in FIG. 207. This 169. usually happens because the metadata fields do not follow the catalog's established sequence, or information in a field is missing or improperly formatted.

When this happens, click Download to open a browser window with an explanation of what lines and fields had problems (e.g. the Length field was empty). Using Notepad or another text editor, open the file on your computer (or if you don't have the file, clicking on the filename to open the file in another browser window, then save it to your system) and correct the problem, then try to import the file again.

At the end of each line is a Remove button—click this to remove a catalog file from the Status Report.

Reports

The Reports tab, as shown in FIG. 208, is where you can:

1) Search and create reports on various areas of billing information.

2) View a report on spots marked for distribution.

3) View an import user status report (user files can be imported in the Admin/User function).

Sports for Dist

Description

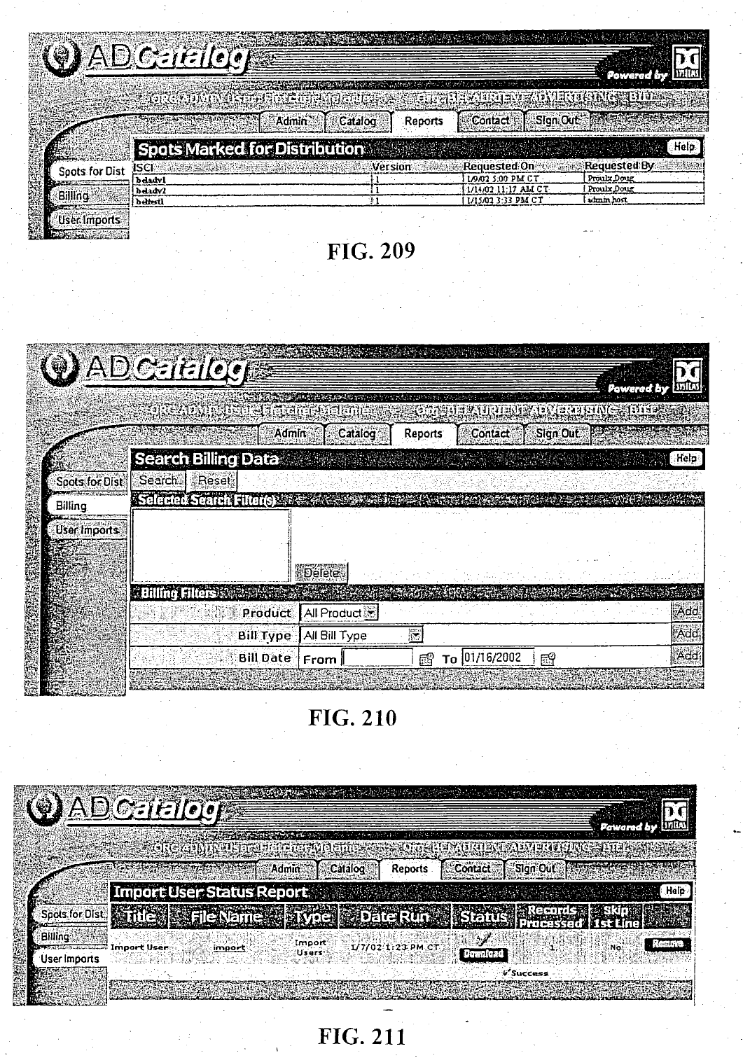

In the Spots for Distribution function, as shown in FIG. 209, you can view all spots in your organization currently marked for transfer to DG Online.

Step-by-Step

Review the following information:

1) ISCI—the ISCI code of the spot.

2) Version—the version of the spot.

3) Requested on—the date and time the spot was requested to be transferred to DG Online

4) Requested by—the user who requested the transfer of the spot to DG Online.

Billing

Description

In the Billing function, as shown in FIG. 210, you can generate a report on DG Systems billing data for your organization using product, bill type or bill date filters. You can use multiple search criteria in each filter (e.g. you can search for Spot Posting and Asset Download in the Bill Type).

Step-by-Step

1) Product—select All Products (both NetClear and AdCatalog), NetClear or AdCatalog. Click Add to add your choice to the Selected Search Filters field.

2) Bill Type—select a bill type

a. All bill types—all bill types used by DG Systems

b. Account activity—billable organization creation and modification.

c. Spot posting—media uploaded and matched for an order/record.

d. Spot encoding—video media match if ODP is not the means of arrival.

e. Asset Download—using a download button to download assets.

f. Spot Streaming—using a streaming button for any spot.

g. Online clearance—new online job submissions

h. Offline clearance—new offline job submissions.

i. Daily storage—daily storage rates for an organization's catalog media.

j. Web Customization—customized metadata types or other customization.

Click Add to add your choice(s) to the Selected Search Filter(s) field.

Bill Date—using the calendar buttons, select a date range to search. Click Add to add your choice(s) to the Selected Search Filter(s) field.

To clear all search criteria from the Selected Search Filter(s) field, click Reset. To remove search criteria from the filter, click on it in the Selected Search Filter9s) field and click Delete.

Once you have entered your chosen criteria, click Search. A Billing data search Results page will be generated in table form. The table contains a section called Search Filters, showing your selected search criteria, and Search Results, which lists the details of the search organized by Bill Type:

1) Spot Posting

a. Date—the date the spot was posted.

b. Org the organization that owns the spot.

c. Product—the product (AdCatalog or NetClear) used to process the spot.

d. Order ID—the AdCatalog Order ID number.

e. Cust. Ref No.—the Customer Reference Number

f. Media Type—the spot's media type (Audio, Video, Print)

g. ISCI/Name the ISCI code or Print File Name of the spot.

h. Version—the version number of the spot.

i. Advertiser—the advertiser represented by the spot.

j. Brand—the brand advertised in the spot.

k. Project/Catalog—the organization and catalog that contains the spot.

l. Requested—by user—the user who requested the spot.

m. Request—by org name—the organization that requested the spot.

2) Spot Encoding

a. Date—the date the spot was encoded.

b. Org—the organization that owns the record.

c. Product—the product (AdCatalog or NetClear) used to process the spot.

d. Order ID—the AdCatalog Order ID number.

e. Cust. Ref No.—the Customer Reference Number

f. Media Type—the spot's media type (Audio, Video, Print)

g. ISCI/Name—the ISCI code or Print File Name of the spot.

h. Version—the version number of the spot.

i. Advertiser—the advertiser represented by the spot.

j. Brand—the brand advertised in the spot.k.

k. Project/Catalog—the organization and catalog that contains the spot.

l. Requested—by user—the user who requested the spot.

m. Request—by org name—the organization that requested the spot.

3) Asset Download

a. Date—the date the spot was encoded.

b. Org—the organization that owns the record.

c. Product—the product (AdCatalog or NetClear) used to process the record.

d. Order ID—the AdCatalog Order ID number.

e. Cust. Ref No.—the Customer Reference Number

f. File Type—the file type (Audio, Video, Print, docunent)

g. File Name—the name of the file.

h. Version—the version number of the spot.

i. File Size—the size of the file in bytes.

j. Session ID—the session ID code.

k. Advertiser—the advertiser represented by the spot.

l. Brand—the brand advertised in the spot.

m. Project/Catalog—the organization and catalog that contains the spot.

n. Requested—by user—the user who requested the spot.

O. Request—by org name—the organization that requested the spot.

4) Spot Streaming

a. Date—the date the spot was encoded.

b. Org—the organization that owns the record.

c. Product—the product (AdCatalog or NetClear) used to process the record.

d. Order ID—the AdCatalog Order ID number.

e. Cust. Ref No.—the Customer Reference Number

f. File Type—the file type (Audio, Video, Print, document)

g. File Name—the name of the file.

h. Version—the version number of the spot.

i. File Size—the size of the file in bytes.

j. Session ID—the session ID code.

k. Advertiser—the advertiser represented by the spot.

l. Brand—the brand advertised in the spot.

m. Project/Catalog—the organization and catalog that contains the spot.

n. Requested—by user—the user who requested the spot.

0. Request—by org name—the organization that requested the spot.

5) Daily Storage

a. Date—the date of the storage of information.

b. Org—the organization that owns the spot.

c. Product—the product (AdCatalog or NetClear) used to process the spot.

d. Overlap Product ID—the ID number of the product.

e. Overlap Product Name—the name of the overlap product (AdCatalog or NetClear)

f. Overlap Storage (Mb)—disk space in megabytes used by the spot.

To modify your search, click Modify Search and add new search criteria.

User Imports

Description

The User Imports function, as shown in FIG. 211, is where the user can check the status of users imported into an organization (this is done in the User function of the Admin tab)

Step-by-Step

Status reports on imported users is presented in the following table:

1) Title—the title of the imported user's data file.

2) File name—the filename of the imported user's datafile. Click on it to open the file in a new browser window.

3) Type—the type of action—Import Users.

4) Date Run—the date and time of the request to import the user.

5) Status—the status of the imported user. If the import was successful, the user's data file, will be marked with a green check. Click the Download button to open a new browser window with a list of the added users that you can save to your computer or print.

6) Records processed—the number of records imported.

7) Skip 1^{st} Line—whether or not the first line of the record file was skipped.

If a file has not been successfully imported to an organization, the Status Report will show this with an ERROR message in the Status field. This usually happens because information in a field is missing or improperly formatted.

When this happens, click Down load to open a browser window with an explanation of what lines and fields had problems (e.g. the Name field was empty). Using Notepad or another text editor, open the file on your computer (or if you don't have the file, clicking on the filename to open the file in another browser window, then save it to your system) and correct the problem, then try to import the user again.

At the end of each line is a Remove button—click this to remove a user's data file from the Status Report.

Contact

Description

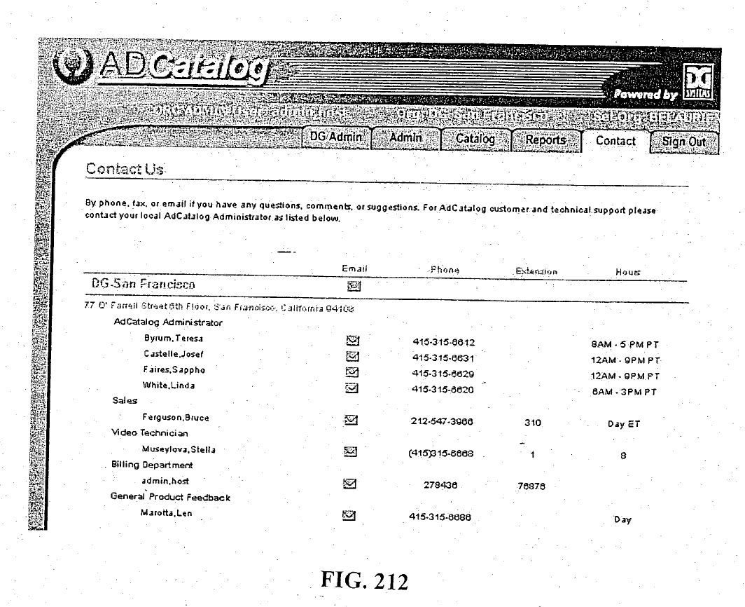

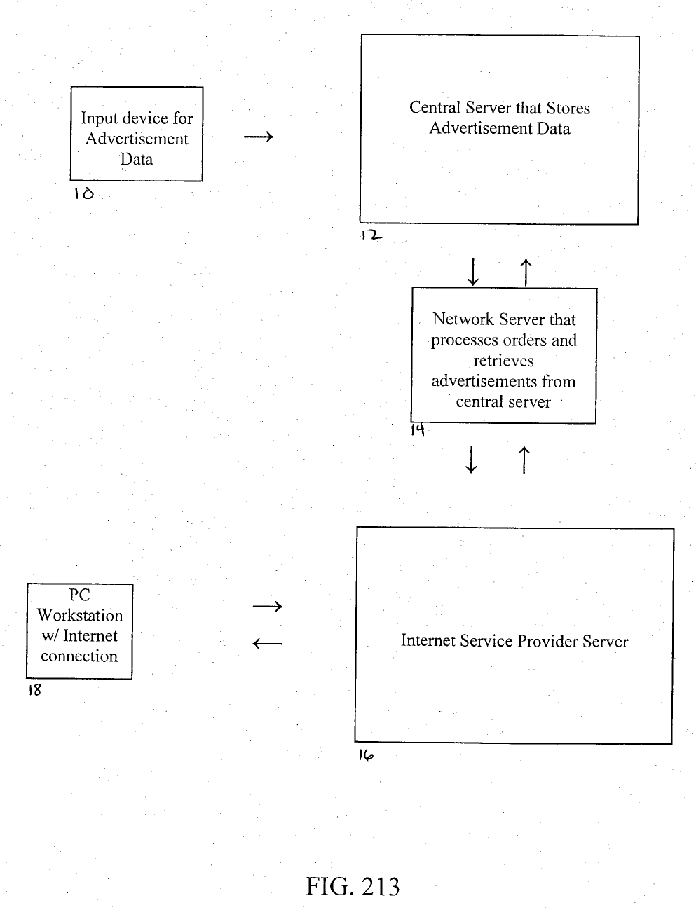

The Contact tab, as shown in FIG. 212, is where you can find DG Systems contact information for your organization. The tab lists the telephone, fax and email information for AdCatalog Administrators, Sales, Video Technician, Billing Department and General Product Feedback at DG Systems.

Step-by-Step

Information on AdCatalog contacts is presented in table format, and lists the position, name, phone number, extension and office hours of the contact. Positions include:

1) AdCatalog Administrators—the DG Systems administrators for AdCatalog.

2) Sales—the DG Systems salesperson for AdCatalog.

3) Video Technician—the DG Systems video technician for AdCatalog

4) Billing Department—the DG Systems billing department.

5) General Product Feedback—the DG Systems marketing specialist who collates feedback from customers for future versions of AdCatalog.

Click on the envelope icon to sent an email message to the person.

Sign Out

Click on the Sign Out tab to log out of AdCatalog. You will be returned to the Login page.

We claim:

1) A system for accessing digital media comprising:
a) a storage medium that is capable of storing digital media; and
b) a computer system that is capable of receiving digital media via an internet connection.

2) The system of claim 1, wherein the digital media is video media.

3) The system of claim 1, wherein the digital media is audio media.

4) The system of claim 1, wherein the digital media is print media.

5) A method for cataloging digital media, comprising:
a) uploading said media to a central server capable of storing digital media;
b) storing said media to said central server;
c) preparing said media for delivery via an internet connection.

6) The method of claim 5, wherein the digital media is video media.

7) The method of claim 5, wherein the digital media is audio media.

8) The method of claim 5, wherein the digital media is print media.

9) A method of instantly accessing an advertisement, comprising:
a) Uploading said advertisement to a central server;
b) Storing said advertisement on said central server; and
c) Downloading said advertisement from said central server to a computer system via an internet connection.

10) The method of claim 9, wherein the advertisement is digital video media.

11) The method of claim 9, wherein the advertisement is digital audio media.

12) The method of claim 9, wherein the advertisement is digital print media.
